(19) United States
(12) Patent Application Publication
(10) Pub. No.: US 2026/0097698 A1
(43) Pub. Date: Apr. 9, 2026

(54) Conveyance Seat

(71) Applicant: TS TECH CO., LTD., Asaka-shi, Saitama (JP)

(72) Inventors: Hajime YOSHIDA, Tochigi (JP); Katsuya KAWATA, Tochigi (JP); Hirofumi KAKEHATA, Tochigi (JP); Kayo SATO, Tochigi (JP); Shinya HATAMI, Tochigi (JP)

(21) Appl. No.: 19/112,748

(22) PCT Filed: Sep. 27, 2023
(86) PCT No.: PCT/JP2023/035305

§ 371 Date: Mar. 18, 2025

Related U.S. Application Data
(60) Provisional application No. 63/410,751, filed on Sep. 28, 2022.
(60) Provisional application No. 63/413,711, filed on Oct. 6, 2022.
(60) Provisional application No. 63/431,371, filed on Dec. 9, 2022.
(60) Provisional application No. 63/489,818, filed on Mar. 13, 2023.

(30) Foreign Application Priority Data
Mar. 16, 2023 (JP) 2023-042124
Mar. 16, 2023 (JP) 2023-042125
Mar. 16, 2023 (JP) 2023-042126
Sep. 4, 2023 (JP) 2023-143089

(51) Int. Cl. B60N 2/90; B60N 2/56

(52) U.S. Cl. CPC B60N 2/976; B60N 2/5621

(57) ABSTRACT

A conveyance seat having a vibrator disposed at an appropriate position is provided. A conveyance seat includes: a frame which forms a framework; a pressure receiving member that is provided in the frame and receives a load of an occupant; and a back pad which covers the pressure receiving member, wherein the back pad is provided with at least one vibrator which generates a vibration, and wherein the vibrator is disposed at a position in which at least a part of the vibrator does not overlap with the pressure receiving member, in a front view of the conveyance seat or in a top view of the conveyance seat.

### TECHNICAL FIELD

The present invention relates to a conveyance seat and particularly to a conveyance seat with a vibrator.

### BACKGROUND ART

Conventionally, a technology is known in which a vibrator is disposed on a seat back or a seat cushion of a vehicle seat (for example, see PATENT LITERATURE 1). By vibrating the vibrator based on a signal obtained from a sensor or the like, it is possible to notify the occupants of, for example, the approach of another vehicle, an obstacle, or the like.

### CITATION LIST

### Patent Literature

PATENT LITERATURE 1: International Publication No. 2019/044826

### SUMMARY OF INVENTION

### Technical Problem

However, in the past, there was no sufficient consideration for arranging the vibrator at an appropriate position, and there was a demand for arranging the vibrator at an optimal position for the seated person. For example, there was a demand for optimization based on the seat frame, the shape of the pad, and the positional relationship of the pressure receiving member.

Further, as another problem, there was a need for a way to more appropriately transmit the vibration from the vibrator to the seated person.

The present invention has been made in view of the above-described problems, and an object of the present invention is to provide a conveyance seat in which a vibrator is disposed at an appropriate position.

### Solution to Problem

According to the conveyance seat of the present invention, the above-described problems are solved by a conveyance seat including: a frame which forms a framework; a pressure receiving member that is provided in the frame and receives a load of an occupant; and a pad member that covers the pressure receiving member, in which the pad member is provided with at least one vibrator that generates a vibration, and in which the vibrator is disposed at a position in which at least a part of the vibrator does not overlap with the pressure receiving member in a front view of the conveyance seat or in a top view of the conveyance seat.

According to the conveyance seat of the present invention with the above-described configuration, since a part of the vibrator is disposed at a position that does not overlap with the pressure receiving member in the front view or in the top view, the vibrator does not become an obstacle when the occupant sinks into the pad member in a seated state of the occupant. Therefore, it is possible to provide the conveyance seat in which the vibrator is disposed at an appropriate position.

Further, in the above-described configuration, the pressure receiving member may be provided to be movable within a predetermined range of the frame, and the vibrator may be disposed outside the predetermined range.

Since the vibrator is disposed outside the movable range of the pressure receiving member, the vibrator does not interfere with the pressure receiving member and an increase in discomfort can be suppressed.

Further, in the above-described configuration, the pressure receiving member may be provided with an opening, and the vibrator may be disposed at a position that overlaps with the opening in the front view of the conveyance seat or in the top view of the conveyance seat.

Since the vibrator is disposed to overlap with the opening, it is possible to suppress the discomfort felt by the seated person.

Further, in the above-described configuration, the pad member may be provided with a through hole that absorbs the deformation of the pad member, and the vibrator may be disposed at a position that overlaps with the through hole in a seat width direction.

Since the vibrator is disposed at a position that overlaps with the through hole in the seat width direction, the deformation of the pad member due to the vibrator can be absorbed.

Further, in the above-described configuration, the pad member may be provided with a horizontal suspension groove which extends in the seat width direction, and the vibrator may be disposed below or in front of the horizontal suspension groove.

Since the vibrator is disposed below or in front of the horizontal suspension groove, it is possible to suppress the discomfort felt by the seated occupant (seated person) while suppressing the influence on the horizontal suspension groove.

Further, in the above-described configuration, the pad member may be provided with a vertical suspension groove which extends in an up to down direction of the seat or a front to rear direction of the seat, and the vibrator may be disposed inside the vertical suspension groove in the seat width direction.

Since the vibrator is disposed inside the vertical suspension groove, it is possible to suppress the discomfort felt by the seated person while suppressing the influence on the vertical suspension groove.

Further, in the above-described configuration, the pad member may be provided with a storage recess which stores the vibrator in a seating surface and a protrusion which is formed at a position corresponding to the storage recess in a surface on the opposite side to the seating surface.

Since the protrusion is formed on the surface on the opposite side to the seating surface, it is possible to easily perform positioning relative to the pressure receiving member while suppressing a decrease in rigidity of the pad member due to the storage recess.

Further, in the above-described configuration, the pad member may be provided with a plurality of the vibrators, and the pad member may be provided with a connection portion which connects the protrusion formed for each of the plurality of vibrators.

Since the connection portion is provided to connect the protrusions, it is possible to further suppress a decrease in rigidity of the pad member due to the storage recess.

Further, in the above-described configuration, the conveyance seat may further include a blower which blows air toward the occupant, and the vibrator may be disposed at a position that avoids an opening of the blower, a duct of the blower, or an attachment member of the blower.

Since the vibrator is disposed at a position that avoids the opening or the like of the blower, the influence on the air blown out from the blower can be suppressed.

Further, in the above-described configuration, the conveyance seat may include a seat back that supports the back of the occupant, a seat cushion that supports the buttocks of the occupant, a headrest that supports the head of the occupant, and a skin that covers the pad member, and the frame may include a seat back frame which forms a framework of the seat back and a seat cushion frame which forms a framework of the seat cushion.

### ADVANTAGEOUS EFFECTS OF INVENTION

According to the conveyance seat of the present invention with the above-described configuration, since a part of the vibrator is disposed at a position that does not overlap with the pressure receiving member in the front view or in the top view, the vibrator does not become an obstacle when the occupant sinks into the pad member in a seated state of the occupant. Therefore, it is possible to provide the conveyance seat in which the vibrator is disposed at an appropriate position.

Since the vibrator is disposed outside the movable range of the pressure receiving member, the vibrator does not interfere with the pressure receiving member and an increase in discomfort can be suppressed.

Since the vibrator is disposed to overlap with the opening, it is possible to suppress the discomfort felt by the seated person.

Further, since the vibrator is disposed at a position that overlaps with the through hole in the seat width direction, the deformation of the pad member due to the vibrator can be absorbed.

Further, since the vibrator is disposed below or in front of the horizontal suspension groove, it is possible to suppress the discomfort felt by the seated occupant (seated person) while suppressing the influence on the horizontal suspension groove.

Further, since the vibrator is disposed inside the vertical suspension groove, it is possible to suppress the discomfort felt by the seated person while suppressing the influence on the vertical suspension groove.

Further, since the protrusion is formed in the surface on the opposite side to the seating surface, it is possible to easily perform positioning relative to the pressure receiving member while suppressing a decrease in rigidity of the pad member due to the storage recess.

Further, since the connection portion is provided to connect the protrusions, it is possible to further suppress a decrease in rigidity of the pad member due to the storage recess.

Since the vibrator is disposed at a position that avoids the opening or the like of the blower, the influence on the air blown out from the blower can be suppressed.

### BRIEF DESCRIPTION OF DRAWINGS

FIG. 1 is a perspective view showing a conveyance seat according to a first embodiment of the present invention.

FIG. 2 is an exploded perspective view showing a frame and a pad of a conveyance seat.

FIG. 3 is a front view showing a seat back frame and a diagram showing the position of a vibrator.

FIG. 4 is a top view showing a seat cushion frame and a diagram showing the position of a vibrator.

FIG. 5 is a front view showing a conveyance Seat with a skin removed.

FIG. 6 is a top view showing a conveyance seat with a skin removed.

FIG. 7 is a diagram showing a back surface of a back pad.

FIG. 8 is a diagram showing a bottom surface of a cushion pad.

FIG. 9 is a cross-sectional view taken along line A-A of FIG. 5.

FIG. 10A is an enlarged view of part B of FIG. 9 and a diagram showing a vibrator storage state.

FIG. 10B is a diagram showing another example of a vibrator storage state.

FIG. 11 is a cross-sectional view of a conveyance seat having a protrusion on a back surface of a vibrator.

FIG. 12 is a rear view of a back pad member having a protrusion on a back surface.

FIG. 13A is a diagram showing another example of a vibrator storage state.

FIG. 13B is a diagram showing another example of a vibrator storage state.

FIG. 13C is a diagram showing another example of a vibrator storage state.

FIG. 14A is a diagram showing an example of an attachment position of a vibrator on a seat back.

FIG. 14B is a diagram showing an example of an attachment position of a vibrator on a seat back.

FIG. 15A is a diagram showing an example of an attachment position of a vibrator on a seat back.

FIG. 15B is a diagram showing an example of an attachment position of a vibrator on a seat back.

FIG. 16A is a diagram showing an example of an attachment position of a vibrator on a seat back having a blower.

FIG. 16B is a diagram showing an example of an attachment position of a vibrator on a seat back having a blower.

FIG. 17A is a diagram showing an example of an attachment position of a vibrator on a seat back.

FIG. 17B is a diagram showing an example of an attachment position of a vibrator on a seat back.

FIG. 18A is a diagram showing an example of an attachment position of a vibrator on a seat back having a blower.

FIG. 18B is a diagram showing an example of an attachment position of a vibrator on a seat back having a blower.

FIG. 19 is a diagram showing an example of an attachment position of a vibrator on a seat cushion.

FIG. 20A is a diagram showing an example of an attachment position of a vibrator on a seat cushion.

FIG. 20B is a diagram showing an example of an attachment position of a vibrator on a seat cushion.

FIG. 21A is a diagram showing an example of an attachment position of a vibrator on a seat cushion.

FIG. 21B is a diagram showing an example of an attachment position of a vibrator on a seat cushion.

FIG. 22A is a diagram showing an example of an attachment position of a vibrator on a seat cushion having a blower.

FIG. 22B is a diagram showing an example of an attachment position of a vibrator on a seat cushion having a blower.

FIG. 23A is a diagram showing an example of an attachment position of a vibrator on a seat cushion.

FIG. 23B is a diagram showing an example of an attachment position of a vibrator on a seat cushion.

FIG. 24 is a perspective view of a vehicle interior of a vehicle equipped with a vehicle seat.

FIG. 25 is a perspective view of a vehicle seat as viewed obliquely from the front.

FIG. 26 is an exploded perspective view of a pad material and a seat frame as viewed obliquely from the front.

FIG. 27 is a diagram showing the functional configuration of a vehicle seat.

FIG. 28 is a diagram showing the arrangement of an external sensor.

FIG. 29 is a diagram showing the flow of a stop notification process.

FIG. 30A is a diagram showing a vibration state when a preceding vehicle starts at a rotation position in which a vehicle seat faces forward.

FIG. 30B is a diagram showing a vibration state when a preceding vehicle starts at a rotation position in which a vehicle seat faces backward.

FIG. 31 is a diagram showing the flow of a traveling notification process.

FIG. 32A is a diagram showing a vibration state when an approaching object approaches from the right rear of a vehicle at a rotation position in which a vehicle seat faces forward.

FIG. 32B is a diagram showing a vibration state when an approaching object approaches from the right rear of a vehicle at a rotation position in which a vehicle seat faces backward.

FIG. 33 is a diagram showing the flow of a start notification process.

FIG. 34A is a diagram showing a vibration state when an obstacle is detected on the left front side of a vehicle at a rotation position in which a vehicle seat faces forward.

FIG. 34B is a diagram showing a vibration state when an obstacle is detected on the left front side of a vehicle at a rotation position in which a vehicle seat faces backward.

FIG. 35 is a diagram showing the flow of a reverse travel notification process.

FIG. 36A is a diagram showing a vibration state when an obstacle is detected behind a vehicle at a rotation position in which a vehicle seat faces forward.

FIG. 36B is a diagram showing a vibration state when an obstacle is detected behind a vehicle at a rotation position in which a vehicle seat faces backward.

FIG. 37 is a perspective view of a vehicle seat according to a second embodiment as viewed obliquely from the front.

FIG. 38 is a diagram showing the functional configuration of the vehicle seat according to the second embodiment.

FIG. 39 is a perspective view showing a conveyance seat according to a third embodiment of the present invention.

FIG. 40 is an exploded perspective view showing a frame and a pad member of the conveyance seat.

FIG. 41 is a front view showing a seat back frame and a diagram showing a position of a vibrator.

FIG. 42 is a top view showing a seat cushion frame and a diagram showing a position of a vibrator.

FIG. 43 is a front view of a conveyance seat with a skin removed.

FIG. 44 is a top view of a conveyance seat with a skin removed.

FIG. 45 is a diagram showing a back surface of a back pad member.

FIG. 46 is a diagram showing a bottom surface of a cushion pad member.

FIG. 47 is a cross-sectional view taken along line A-A of FIG. 43.

FIG. 48A is an enlarged view of part B of FIG. 47 and a diagram showing a vibrator storage state.

FIG. 48B is a diagram showing another example of a vibrator storage state.

FIG. 49A is a top view showing a seat cushion in which a sensor device is disposed.

FIG. 49B is a top view showing another example of a seat cushion in which a sensor device is disposed.

FIG. 50 is a top view of a seat cushion in which a heater device is disposed.

FIG. 51 is a cross-sectional view taken along line C-C of FIG. 50.

FIG. 52 is a top view of another example of a seat cushion in which a heater device is disposed.

FIG. 53 is a front view of a seat back in which a heater device is disposed.

FIG. 54 is a front view of another example of a seat back in which a heater device is disposed.

FIG. 55 is a top view of a seat cushion in which an air cell is provided.

FIG. 56 is a top view of another example of a seat cushion in which an air cell is provided.

FIG. 57A is a cross-sectional view taken along line D-D of FIG. 56.

FIG. 57B is a cross-sectional view taken along line E-E of FIG. 56 and a diagram showing an example in which a vibration member is disposed below an air cell.

FIG. 58 is a front view of a seat back in which an air cell is provided.

FIG. 59 is a front view of another example of a seat back in which an air cell is provided.

FIG. 60 is a top view of a seat back having a vibrator that overlaps with a suspension groove.

FIG. 61 is a cross-sectional view taken along line F-F of FIG. 60.

FIG. 62 is a top view of a seat cushion in which a movable device for a bank portion is provided.

FIG. 63 is a diagram schematically showing a configuration of a seat cushion having a movable front portion.

FIG. 64 is a front view of a seat back in which an airbag is provided.

FIG. 65 is a top view of a seat cushion in which an airbag is provided.

FIG. 66 is a top view of a seat cushion in which lighting is provided.

FIG. 67 is a top view of a seat cushion having pad members with different hardnesses.

FIG. 68A is a schematic view showing the positional relationship between a heater device and a vibrator.

FIG. 68B is a schematic view showing another example of the positional relationship between a heater device and a vibrator.

FIG. 69A is a schematic view showing the positional relationship between a sensor device and a vibrator.

FIG. 69B is a schematic view showing another example of the positional relationship between a sensor device and a vibrator.

FIG. 70 is a perspective view showing a conveyance seat according to a first example of a fourth embodiment.

FIG. 71 is an exploded perspective view showing a configuration of a conveyance seat with a skin removed.

FIG. 72 is a front view showing a seat back with a skin removed.

FIG. 73 is a top view showing a seat cushion with a skin removed.

FIG. 74 is a cross-sectional view showing a conventional vibrator fixing structure.

FIG. 75 is a cross-sectional view taken along line A-A of FIG. 72 or line B-B of FIG. 73 and a diagram showing the positional relationship between a heater and a vibrator.

FIG. 76 is a diagram showing another example of the positional relationship between a heater and a vibrator.

FIG. 77A is a diagram showing a vibrator disposed at an angle relative to a heater wire.

FIG. 77B is a diagram showing a vibrator disposed to overlap with a bent portion of a heater wire.

FIG. 78A is a diagram showing a back pad according to a second example and a diagram showing the position of a surface fastener that overlaps with a vibrator.

FIG. 78B is a diagram showing another example of a surface fastener that overlaps with a vibrator.

FIG. 78C is a diagram showing a surface fastener disposed at a position that does not overlap with a vibrator.

FIG. 79 is a cross-sectional view taken along line C-C of FIG. 78A and a diagram showing the positional relationship between a surface fastener and a vibrator.

FIG. 80 is a front view of a back pad showing a vibrator disposed in a suspension groove.

FIG. 81 is a cross-sectional view taken along line D-D of FIG. 80.

FIG. 82 is a cross-sectional view taken along line E-E of FIG. 80 and a diagram showing a skin suspension portion.

FIG. 83 is a front view showing another example of a vibrator disposed in a suspension groove.

FIG. 84 is a perspective view showing the internal configuration of a vibrator having a directivity adjustment portion.

FIG. 85 is a cross-sectional view showing another example a vibrator having a directivity adjustment portion.

### DESCRIPTION OF EMBODIMENTS

### First Embodiment

Hereinafter, the configuration of a conveyance seat according to a first embodiment (this embodiment) of the present invention will be described with reference to the drawings. However, the embodiment described below is an example for facilitating understanding of the present invention, and is not intended to limit the present invention. In other words, the present invention can be modified or improved without departing from the spirit of the invention, and it goes without saying that the present invention includes equivalents thereof.

Hereinafter, a vehicle seat will be taken as an example of a conveyance seat, and a configuration example thereof will be described. However, the present invention is not limited to vehicle seats installed in conveyances that have wheels and travel on land, such as automobiles and trains, but may also be seats installed in aircraft, ships, and other conveyances that move other than on land. The present invention may also be applied to ordinary chairs or sofas.

Further, in the following description, the “front to rear direction” refers to a front to rear direction of the conveyance seat and coincides with the travel direction when the vehicle is traveling. Further, the “seat width direction” refers to the width direction of the conveyance seat and coincides with a right to left direction as viewed from the occupant (seated person) seated on the conveyance seat. Further, the “up to down direction” refers to an up to down direction of the conveyance seat and coincides with the vertical direction when the vehicle travels on a horizontal plane.

Further, in the following description, when describing various directions with the word “seat” added, such as the “seat width direction”, the “up to down direction of the seat”, and the “front to rear direction of the seat”, this indicates the direction relative to the conveyance seat, and when describing various directions with the word “vehicle” added, such as the “inside of the vehicle” and the “outside of the vehicle”, this indicates the direction relative to the vehicle.

Further, the shape, position, and posture of each part of the conveyance seat described below will be described assuming that the conveyance seat is in a seated state, which will be described later, unless otherwise specified.

### Conveyance Seat S

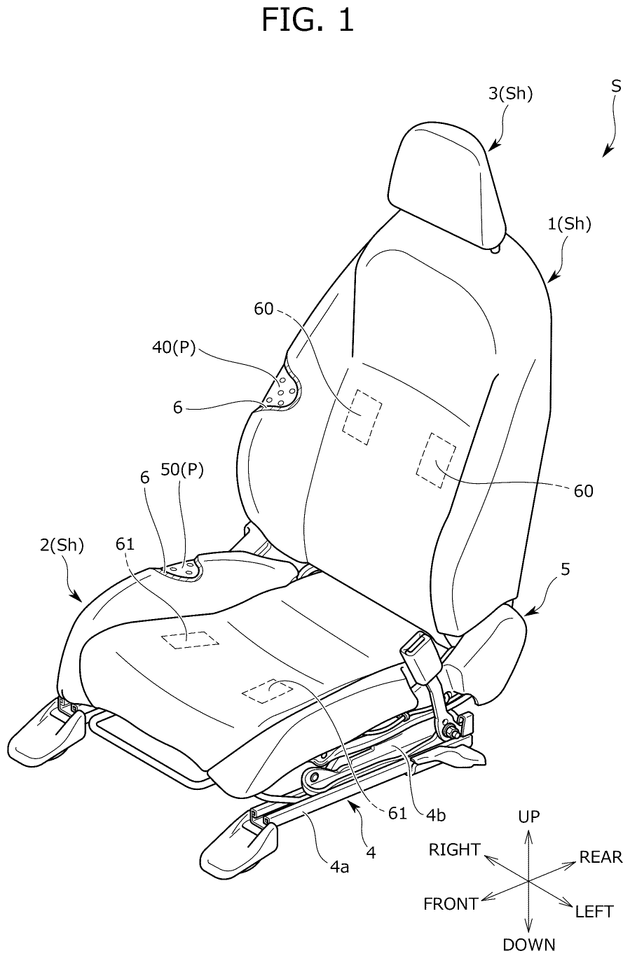

The basic configuration of a conveyance seat S according to this embodiment will be described with reference to FIG. 1. FIG. 1 is a perspective view of the conveyance seat S, and for convenience of illustration, a part of the conveyance seat S is shown in FIG. 1 with a skin 6 removed.

The conveyance seat S is a seat that is placed on the floor of the vehicle and on which the occupant (hereinafter, sometimes referred to as the seated person) of the vehicle is seated. In this embodiment, the conveyance seat S is used as a front seat corresponding to the front seat of the vehicle. However, the present invention is not limited thereto, and the conveyance seat S can also be used as a rear seat, and can also be used as a second-row middle seat or a third-row rear seat in a vehicle having three rows of seats in the front to rear direction.

As shown in FIG. 1, the conveyance seat S mainly includes a seat back 1 that serves as a backrest portion supporting the back of the seated person, a seat cushion 2 that serves as a seating portion supporting the buttocks of the seated person, and a headrest 3 that is disposed on the upper portion of the seat back 1 and supports the head of the seated person. Furthermore, the seat back 1, the seat cushion 2, and the headrest 3 may be collectively referred to as a seat body Sh.

The seat back 1 and the seat cushion 2 are connected to sandwich a reclining mechanism 5. The reclining mechanism 5 allows the seat back 1 to be rotatable relative to the seat cushion 2, and the tilt angle thereof is adjustable.

A headrest pillar 31 extends downward from the headrest 3 and is connected to the upper end of the seat back 1.

Further, a rail device 4 is installed below the conveyance seat S. The conveyance seat S is attached to the vehicle floor by the rail device 4 so that the seat body Sh is slidable in the front to rear direction. The rail device 4 includes a lower rail 4a which is fixed onto the vehicle floor and an upper rail 4b which is slidable relative to the lower rail 4a.

### Seat Frame F

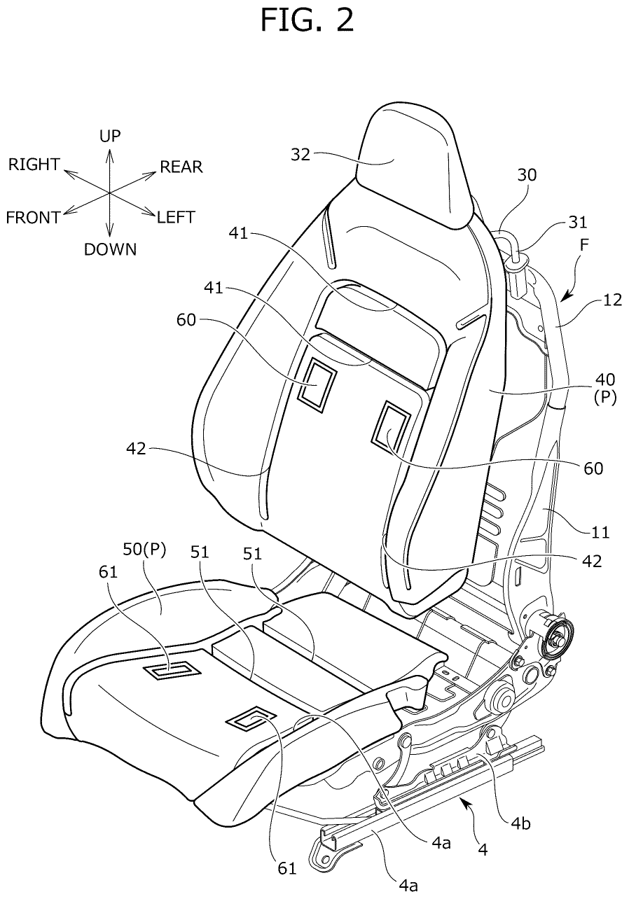

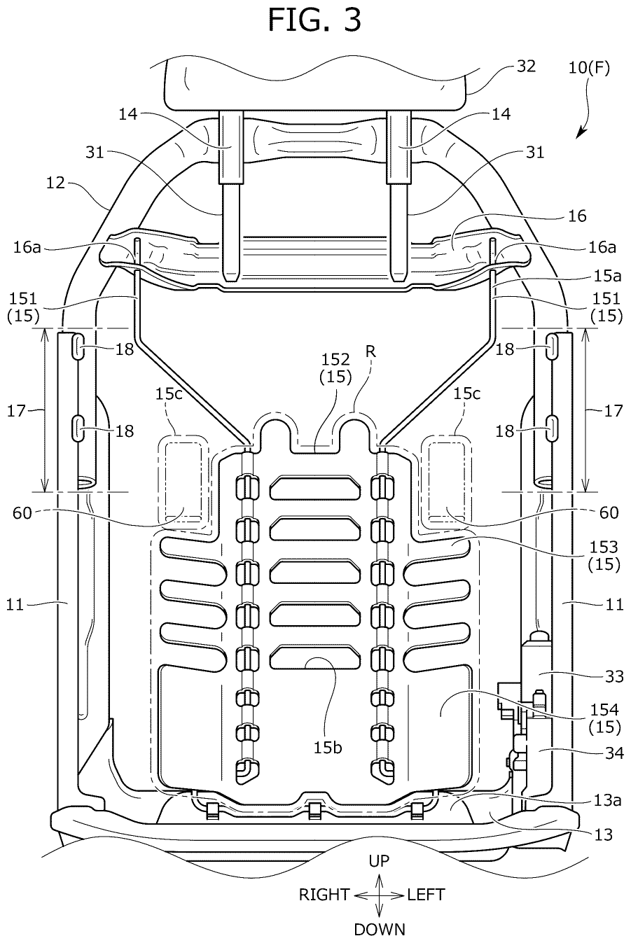

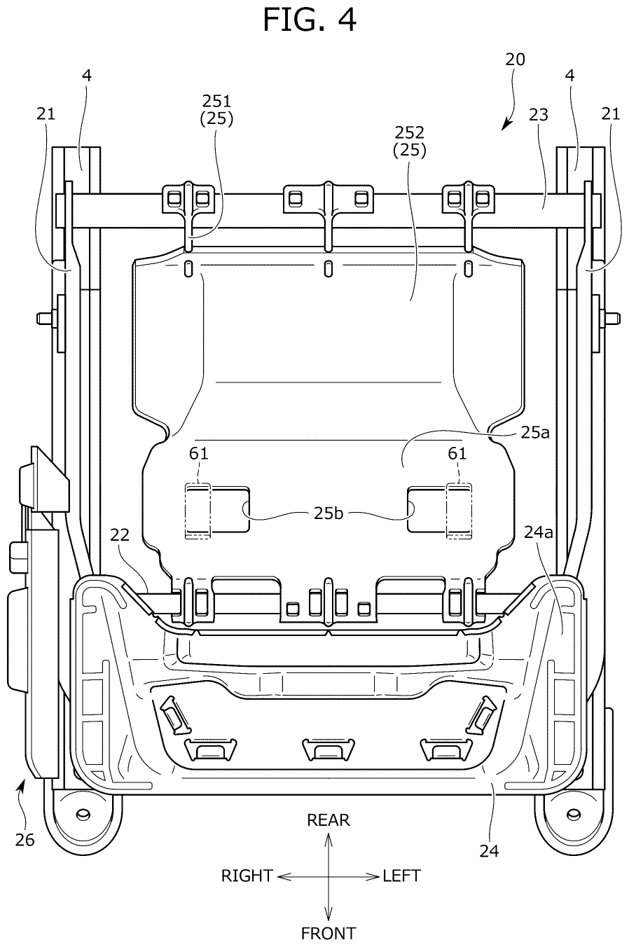

The basic configuration of a seat frame F that forms a framework of the conveyance seat S will be described with reference to FIG. 2. FIG. 2 is an exploded perspective view showing the seat frame F and a pad member P of the conveyance seat S. FIG. 3 is a front view showing a seat back frame 10, and FIG. 4 is a top view showing a seat cushion frame 20.

As shown in FIG. 2, the seat frame F is provided inside the conveyance seat S. The seat frame F includes the seat back frame 10 which forms a framework of the seat back 1, the seat cushion frame 20 which forms a framework of the seat cushion 2, and a headrest frame 30 which forms a framework of the headrest 3.

### Seat Back Frame 10

As shown in FIGS. 2 and 3, the seat back frame 10 is formed in a rectangular frame shape as a whole, and the seat back frame 10 includes a pair of back side frames 11 and 11 arranged on the right and left, an upper frame 12, and a lower frame 13.

As described above, the pair of back side frames 11 and 11 are arranged on the right and left sides of the seat back frame 10, and are basically members configured symmetrically on the right and left sides. The pair of back side frames 11 and 11 are provided to extend in the up to down direction of the seat. The pair of back side frames 11 and 11 are each formed so that the width in the front to rear direction of the seat increases from the upper side of the seat toward the lower side of the seat. The peripheral edge portion on the front side of the seat and the peripheral edge portion on the rear side of the seat are formed in a curved shape to protrude toward the front side of the seat.

The upper frame 12 is a member formed by bending a pipe into an inverted U-shape, and is disposed between the pair of back side frames 11 and 11 to connect the upper ends of the pair of back side frames 11 and 11. A connection frame 16 is provided at a portion of the upper frame 12 that connects the back side frames 11 and 11.

The upper frame 12 and the pair of back side frames 11 and 11 are connected by welding the overlapping portions (overlapping portions 17) of the upper frame 12 and the pair of back side frames 11 and 11. Hereinafter, the welded portion will be referred to as a welding portion 18.

The upper frame 12 is provided with a pair of headrest holders 14 into which headrest pillars 31 of the headrest 3 are inserted. The headrest holder 14 is formed as a high-hardness metal member to keep the holding strength of the headrest 3 and suppress rattling. Furthermore, the headrest holder 14 is not limited to being made of metal, but may be made of resin.

Further, an actuator 33 is attached to the lower end of the back side frame 11 disposed on the left side via an actuator attachment portion 34. The reclining mechanism 5 can be driven by using the actuator 33.

The seat back frame 10 is provided with a back pressure receiving member 15. The back pressure receiving member 15 is also called a lumbar and is a member that receives the load of the seated person. The pressure receiving member 15 is provided to be movable within a predetermined range of the seat back frame 10 when a load is applied from the seated person.

The back pressure receiving member 15 shown in FIG. 3 includes a wire member 151 and a plate-shaped member 152 that is formed in a plate shape to mainly receive a load of the seated person. The back pressure receiving member 15 is attached in such a manner that an upper end 15a is fixed to an upper attachment portion 16a of the connection frame 16 and a lower end is fixed to the lower frame 13.

The plate-shaped member 152 of the pressure receiving member 15 is elastically supported by the wire member 151 and is movable in the front to rear direction or the right to left direction, for example, within a movable range R shown in FIG. 3.

As shown in FIG. 3, a plurality of openings 15b which are long in the seat width direction are formed in the plate-shaped member 152. Further, a first side portion 153 and a second side portion 154 which extend outward in the seat width direction are provided on both side portions of the plate-shaped member 152. The first side portion 153 is located at the center of the side portion of the plate-shaped member 152 and is made of a plurality of ribs extending in the right to left direction (seat width direction). In other words, the first side portion 153 is formed in a comb shape by a plurality of ribs. The second side portion 154 is located on the lower side of the side portion of the plate-shaped member 152 and is provided to extend outward in the seat width direction.

### Seat Cushion Frame 20

As shown in FIGS. 2 and 4, the seat cushion frame 20 is formed in a rectangular frame shape in the top view of the conveyance seat S, and a pair of cushion side frames 21 and 21 are provided on the right and left sides. The pair of cushion side frames 21 and 21 are basically members that are configured symmetrically on the right and left sides, and are provided to extend in the front to rear direction of the seat.

Further, the seat cushion frame 20 includes a front connection frame 22 which connects the pair of cushion side frames 21 and 21 at the front side and a rear connection frame 23 which connects them at the rear side. The front connection frame 22 and the rear connection frame 23 are formed as round pipes. Further, a plate-shaped pan frame 24 is provided in front of the front connection frame 22.

Further, as shown in FIGS. 2 and 4, the seat cushion frame 20 is provided with a cushion pressure receiving member 25 that is disposed between the front connection frame 22 and the rear connection frame 23 to bridge them. The cushion pressure receiving member 25 can support the buttocks of the seated person from below.

The cushion pressure receiving member 25 shown in FIG. 4 includes a wire member 251 and a plate-shaped member 252. The wire member 251 includes a front end and a rear end each formed in a hook shape and elastically supports the plate-shaped member 252 of the cushion pressure receiving member 25 by being hooked onto the front connection frame 22 and the rear connection frame 23.

An inclined portion 25a which is inclined downward toward the rear side is formed on the plate-shaped member 252 of the cushion pressure receiving member 25. Further, as shown in FIG. 4, a plurality of openings 25b are formed in the plate-shaped member 252.

Further, a seat switch unit 26 is provided in the cushion side frame 21 disposed on the right side of the seat cushion frame 20. The seat switch unit 26 may be disposed on the left side. By pressing a button or the like on the seat switch unit 26, the occupant can drive the actuator 33 provided in the reclining mechanism and adjust the backward tilt angle of the seat back 1. Further, an actuator (not shown) provided on the rail device 4 can be driven to adjust the front-rear position of the seat body Sh.

### Headrest Frame 30

As described above, the headrest frame 30 is a member that forms a framework of the headrest 3. The headrest frame 30 is formed in an inverted U-shape in the front view, and can be attached to the upper end of the seat back 1 by inserting the headrest pillar 31 extending downward into the headrest holder 14.

### Pad Member P

The pad member P will be described with reference to FIGS. 2, 5, and 6. The pad member P includes a back pad 40 which is attached to the seat back frame 10, a cushion pad 50 which is attached to the seat cushion frame 20, and a headrest pad 32 which is attached to the headrest frame 30 and serves as a headrest pad member.

The back pad 40 is provided to cover the back pressure receiving member 15.

Further, the cushion pad 50 is provided to cover the cushion pressure receiving member 25.

Each of the back pad 40, the cushion pad 50, and the headrest pad 32 is covered with the skin 6.

The pad member P is a urethane base material formed by foam molding using, for example, a urethane foam material, and the skin 6 is made of, for example, cloth, synthetic leather, genuine leather, or the like.

### Back Pad 40

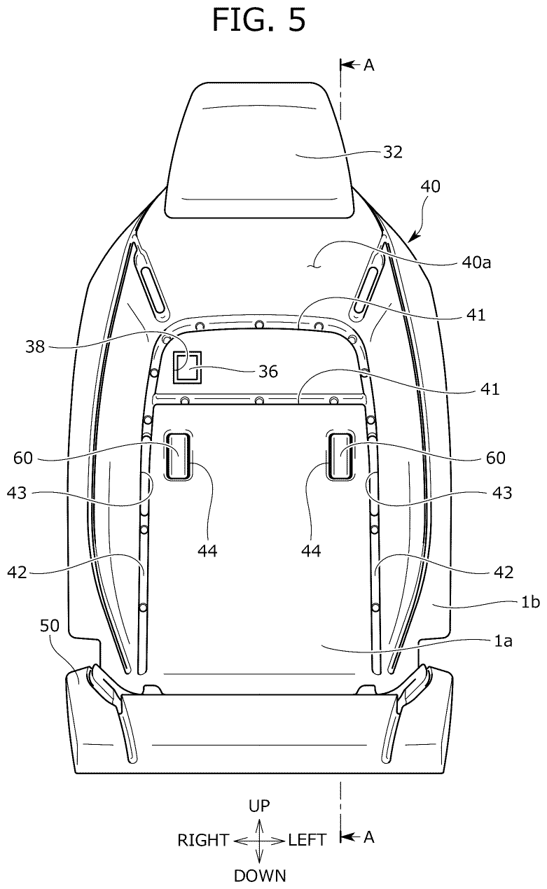

As shown in FIG. 5, the back pad 40 is provided with a first horizontal suspension groove 41 which extends in the seat width direction and a first vertical suspension groove 42 which extends in the up to down direction. The first horizontal suspension groove 41 corresponds to the horizontal suspension groove of the present invention, and the first vertical suspension groove 42 corresponds to the vertical suspension groove of the present invention.

The first horizontal suspension groove 41 connects the upper end of the first vertical suspension groove 42. The first vertical suspension groove 42 is disposed between a main body 1a and a bank portion 1b of the seat back 1.

### Pad Through Hole 43

A pad through hole 43 is formed in a part of the first vertical suspension groove 42 along the first vertical suspension groove 42. Since the pad through hole 43 is formed, the back pad 40 is easily deformed. Further, the pad through hole 43 can absorb the deformation of the back pad 40 due to a vibrator 60 to be described later.

Further, when a blower 35 that blows air is provided in the conveyance seat S, a duct through hole 38 which is inserted through a duct 36 may be formed in the back pad 40.

### Storage Recess 44

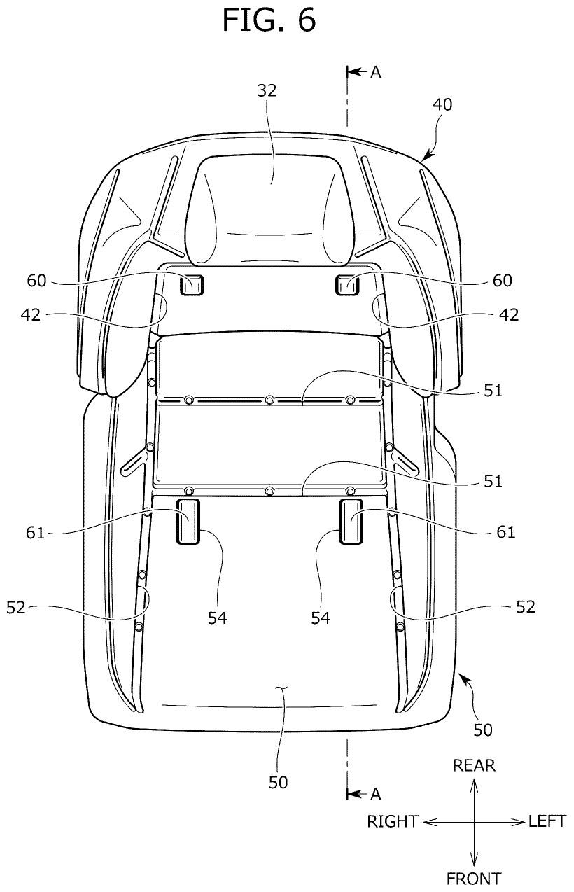

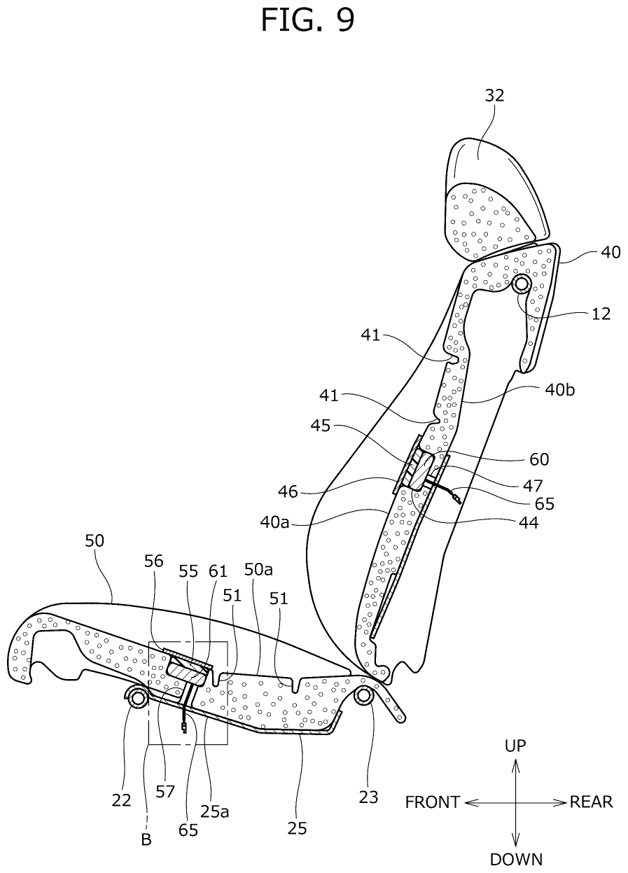

As shown in FIGS. 6 and 9, a storage recess 44 which stores the back side vibrator 60 is formed in a seating surface 40a of the back pad 40. The vibrator 60 can be attached by inserting the vibrator 60 into the storage recess 44.

After the vibrator 60 is inserted into the storage recess 44, a slab 45 is disposed on the vibrator 60 to close the storage recess 44. The slab 45 is fixed by a fixing tape 46.

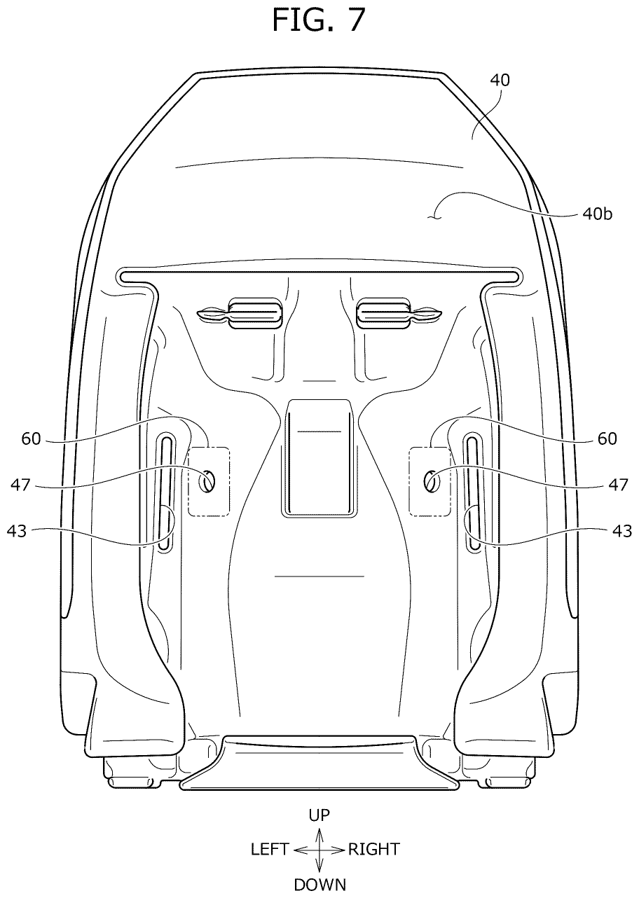

As shown in FIGS. 7 and 9, a harness hole 47 is formed in the bottom surface of the storage recess 44, and a harness 65 extending from the vibrator 60 is passed through the harness hole so that the harness 65 is pulled into a back surface 40b of the back pad 40.

### Vibrator 60

The vibrator 60 is a device that applies a vibration to the seated occupant. In this embodiment, two vibrators 60 are arranged on the back pad 40. Two vibrators 60 are also arranged on the cushion side (hereinafter, referred to as cushion side vibrators 61). The back side vibrator 60 and the cushion side vibrator 61 have the same mechanism.

An eccentric motor is used in the vibrator 60. The present invention is not limited to the eccentric motor, and a linear vibration actuator or a piezoelectric element may be used in the vibrator 60. The harness 65 extends from the vibrator 60 and is connected to an ECU installed in the vehicle. The ECU can control the strength and timing of the vibration of the vibrator 60.

### Cushion Pad 50

As shown in FIG. 6, the cushion pad 50 is provided with a second horizontal suspension groove 51 which extends in the seat width direction and a second vertical suspension groove 52 which extends in the front to rear direction. The second horizontal suspension groove 51 corresponds to the horizontal suspension groove of the present invention, and the second vertical suspension groove 52 corresponds to the vertical suspension groove of the present invention.

The second vertical suspension groove 52 is disposed between a main body 2a of the seat cushion 2 and bank portions 2b arranged on the right and left sides thereof. The second horizontal suspension groove is provided to connect two second vertical suspension grooves 52.

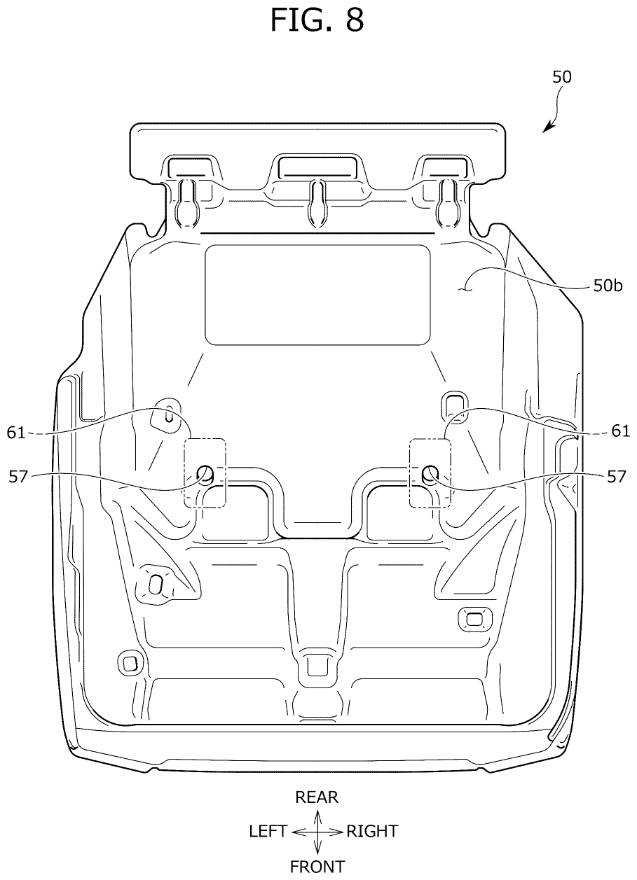

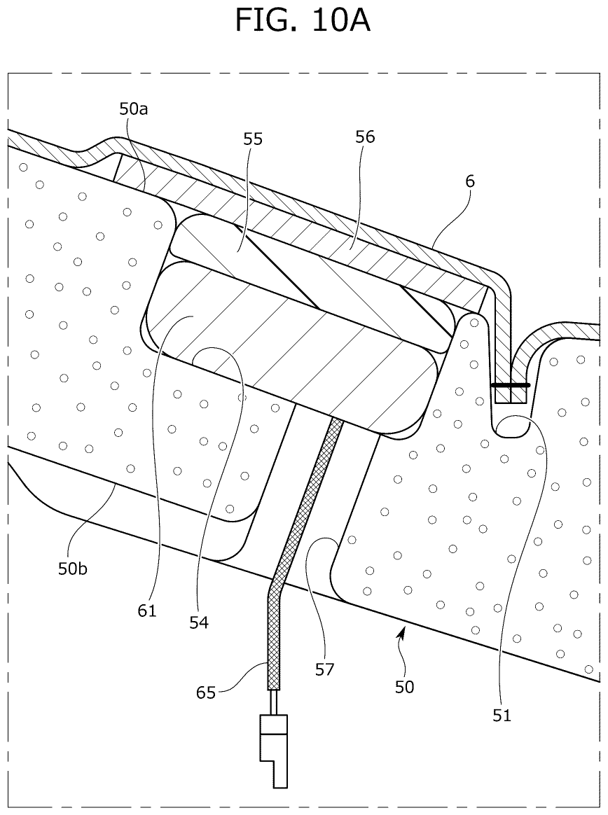

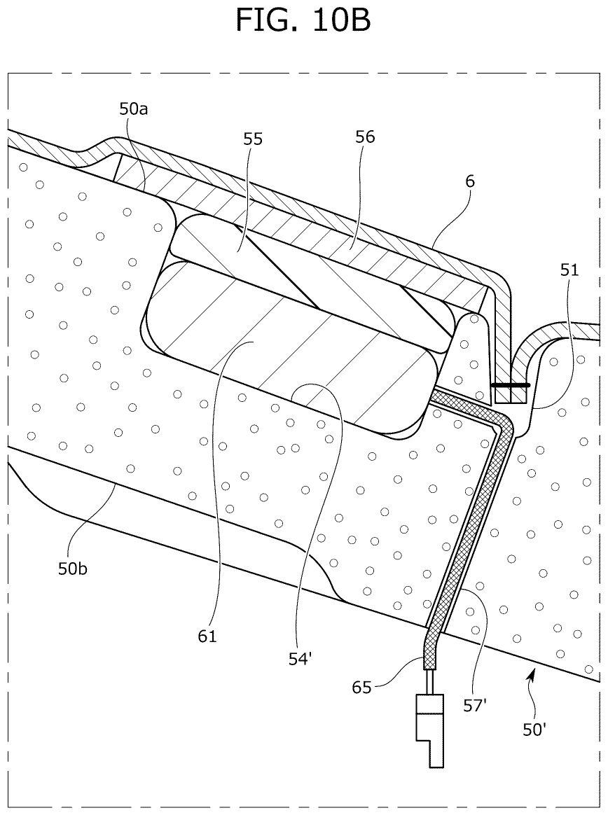

A storage recess 54 which stores the cushion side vibrator 61 is formed in a seating surface 50a of the cushion pad 50. The vibrator 61 can be attached by inserting the vibrator 61 into the storage recess 54. As shown in FIGS. 8 and 10A, a harness hole 57 is formed in the bottom surface of the storage recess 54, and the harness 65 extending from the vibrator 61 is inserted through the harness hole so that the harness 65 is pulled into a bottom surface 50b of the cushion pad 50.

After the vibrator 61 is inserted into the storage recess 54, a slab 55 is disposed on the vibrator 61 to close the storage recess 44. The slab 55 is fixed by a fixing tape 56. As shown in FIGS. 8 and 10A, a harness hole 57 is formed in the bottom surface of the storage recess 54, and the harness 65 extending from the vibrator 61 is inserted through the harness hole so that the harness 65 is pulled into the bottom surface 50b of the cushion pad 50.

Furthermore, in the cushion pad 50 shown in FIG. 10A, the harness hole 57 is formed in the bottom surface of the storage recess 54, but the position of the harness hole 57 is not limited thereto. As in a storage recess 54′ of a cushion pad 50′ shown in FIG. 10B, a harness hole 57′ may be formed in a side wall so that the harness hole 57′ is formed from the bottom portion of the second horizontal suspension groove 51 to the bottom surface 50b through the second horizontal suspension groove 51. Further, a suspension hole formed in the second horizontal suspension groove 51 may be used as the harness hole 57′.

### Positions of Vibrators 60 and 61

Hereinafter, the arrangement of the vibrator 60 of the back pad 40 and the vibrator 61 of the cushion pad 50 will be described with reference to the drawings.

Conventionally, the vibrator has been arranged on the seat back or the seat cushion of the vehicle seat in order to notify the occupant, but the appropriate arrangement position of the vibrator has not been sufficiently considered.

In the conveyance seat S of this embodiment, the back pad 40 is provided with two vibrators 60 that generate a vibration. As shown in FIG. 3, two vibrators 60 are arranged at positions in which at least a part of them do not overlap with the pressure receiving member 15 in the front view of the conveyance seat S.

Specifically, two vibrators 60 are arranged at positions on the sides of the plate-shaped member 152 of the pressure receiving member 15 and overlapping with the opening 15c located above the first side portion 153 in the front view.

With such an arrangement, for example, when the occupant sits down or when the vehicle crashes head-on, the occupant sinks into the cushion pad 50, but at that time, the vibrator 60 does not suppress the occupant from sinking. That is, when sinking, the occupant presses the vibrator 60 backward, but since the movement of the vibrator 60 is suppressed from being hindered by the pressure receiving member 15, the sinking of the occupant is not hindered. In this way, since the vibrator 60 is disposed in consideration of the position of the pressure receiving member 15, it is possible to provide the conveyance seat S in which the vibrator 60 is disposed at an appropriate position.

Further, as described above, the pressure receiving member 15 is provided to be movable in the movable range R (predetermined range) shown in FIG. 3, but the vibrator 60 is provided to be located outside the movable range R. Therefore, even when the pressure receiving member 15 moves, the vibrator 60 does not interfere with the pressure receiving member 15. With such an arrangement, it is possible to suppress an increase in the sense of discomfort caused by the movement of the pressure receiving member 15.

Further, as shown in FIG. 5, the vibrator 60 is disposed at a position that overlaps with the pad through hole 43 formed in the cushion pad 50 in the seat width direction. In other words, the vibrator 60 is disposed at a position substantially at the same height as the pad through hole 43 in the up to down direction of the seat. With such an arrangement, the pad through hole 43 can absorb the deformation of the back pad 40 due to the vibrator 60.

Further, as shown in FIG. 5, the vibrator 60 is disposed to be located below the first horizontal suspension groove 41 extending in the seat width direction. Further, the vibrator 60 is disposed on the inside in the seat width direction in relation to the first vertical suspension groove 42 extending in the up to down direction of the seat. In other words, the vibrator 60 is disposed to be sandwiched between two first vertical suspension grooves 42.

Since the vibrator 60 is disposed in this way, for example, it is possible to suppress the discomfort felt by the seated person while suppressing the influence on the first horizontal suspension groove 41 and the first vertical suspension groove 42.

Further, when the conveyance seat S is provided with the blower 35 and configured to blow air from the seat back 1, as shown in FIG. 5, the duct 36 may be disposed on the upper portion of the seat back 1. In such a case, the vibrator 60 may be disposed at a position that avoids the duct 36 provided in the cushion pad 50. Since the vibrator is disposed at a position that avoids the duct 36 extending from the blower 35, the influence on the air blown out from the blower 35 can be suppressed.

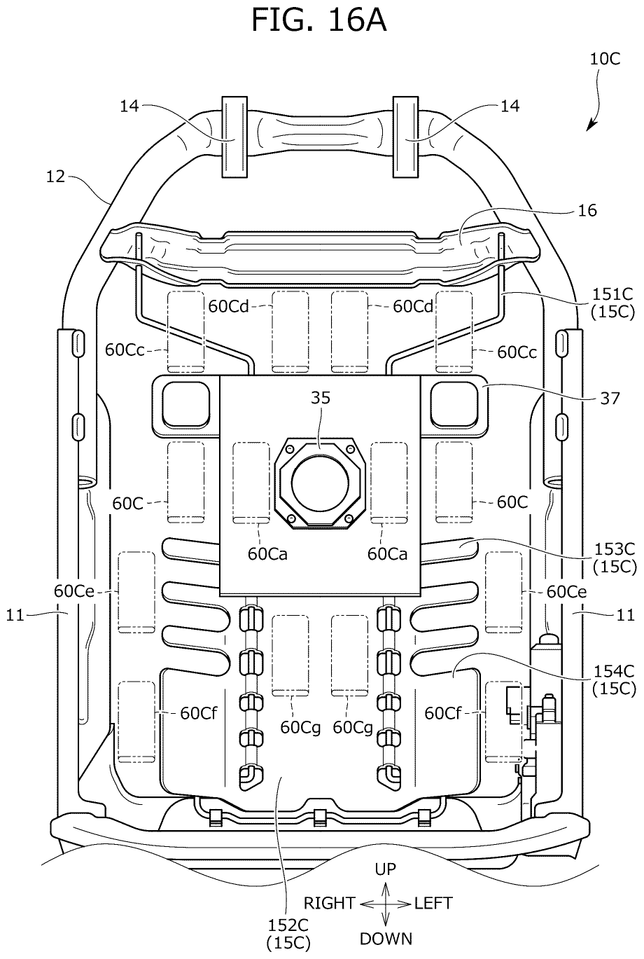

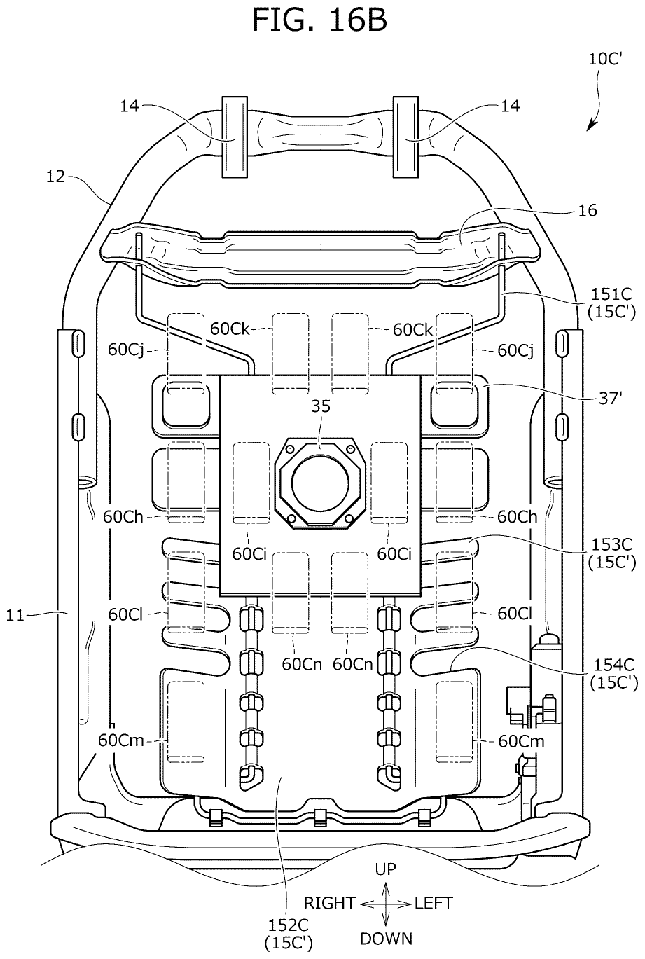

Furthermore, the vibrator 60 may be disposed at a position that avoids not only the duct 36 but also the opening of the blower 35 or a blower attachment portion 37 (see FIG. 16A) for attaching the blower 35.

### Protrusion 48

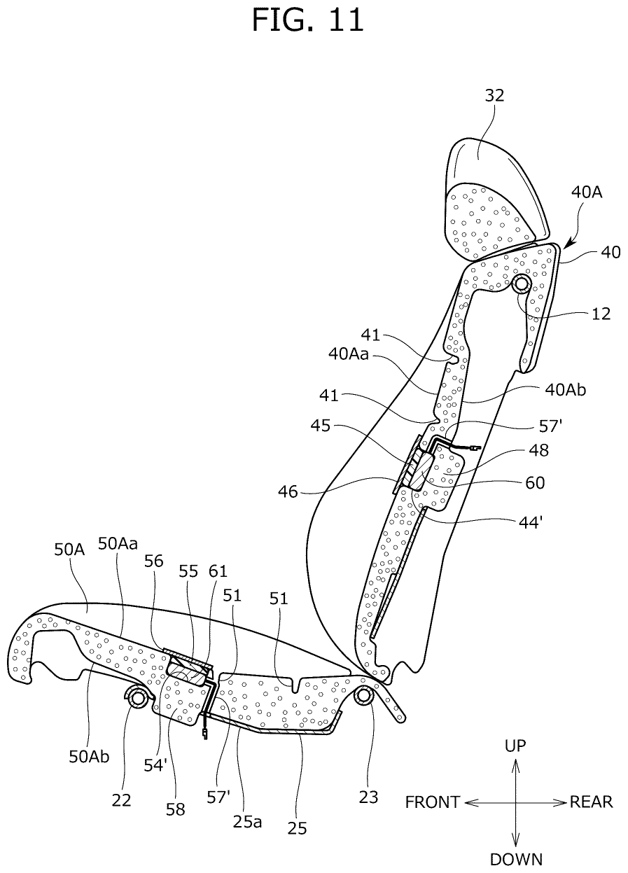

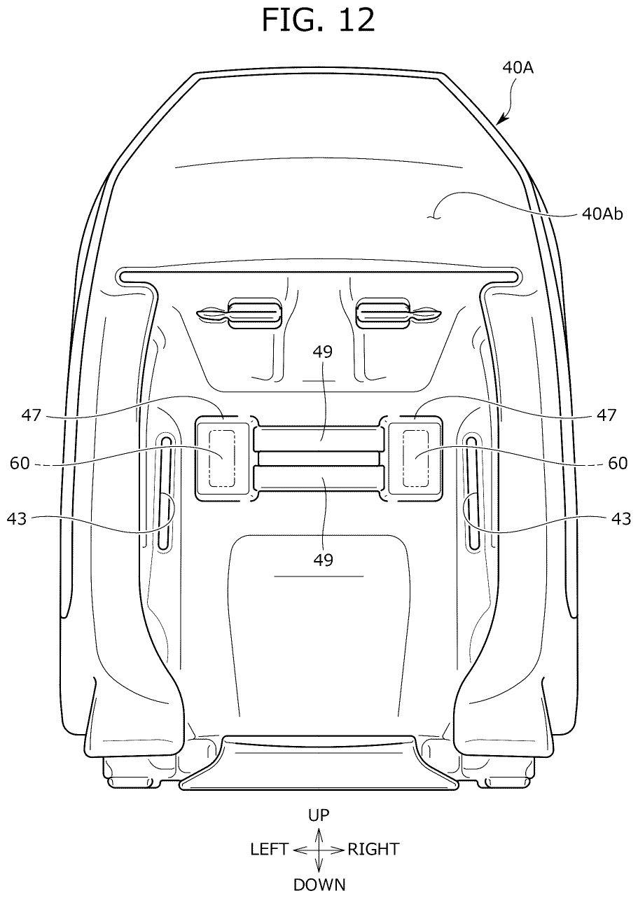

Further, as shown in FIGS. 11 and 12, a protrusion 48 may be formed at a position corresponding to a storage recess 44′ in a back surface 40Ab of a back pad 40A. Since it is possible to recognize the position of the vibrator 60 even from the back surface side while suppressing a decrease in rigidity due to the storage recess 44 by providing the protrusion 48, it is possible to easily position the pressure receiving member 15 during assembly.

Further, as shown in FIG. 12, a bead 49 (connection portion) may be provided to connect two protrusions 48 provided in the back surface 40Ab of the back pad 40A. Since the bead 49 is provided, it is possible to further suppress a decrease in rigidity due to the storage recess 44.

As shown in FIG. 11, a protrusion 58 may be formed at a position corresponding to the storage recess 54′ in a bottom surface 50Ab of a cushion pad 50A. Further, a bead (not shown) may be provided to connect the protrusion 58.

Next, the positional relationship between the seat back frame 10 and the vibrator 60 will be described with reference to FIG. 3. As described above, the pair of headrest holders 14 are provided in the upper portion of the upper frame 12 of the seat back frame 10, and hold the headrest pillar 31 to support the headrest 3. As shown in FIG. 3, the vibrator 60 provided in the seat back 1 may be disposed outside the pair of headrest pillars 31 in the seat width direction (right to left direction). With such an arrangement, it is possible to suppress the discomfort felt by the seated person.

Further, as described above, the upper ends of the back side frames 11 and 11 and the lower end of the upper frame 12 are connected by the welding at the overlapping portion 17. The vibrator 60 of the seat back 1 may be disposed at a position that overlaps with the overlapping portion 17 in the seat width direction. In other words, the vibrator 60 may be disposed at the substantially same height as the overlapping portion 17.

Further, the vibrator 60 may be disposed at a position that overlaps with the welding portion 18 of the overlapping portion 17 in the seat width direction.

Since the overlapping portion 17 and the welding portion 18 have high frame rigidity, the vibration of the vibrator 60 is easily transmitted to the seated person by disposing the vibrator 60 to overlap with the overlapping portion 17 or the welding portion 18 in the seat width direction.

Further, the upper end 15a of the pressure receiving member 15 is attached to the upper attachment portion 16a of the connection frame 16. The vibrator 60 may be disposed to be located on the inside of the seat width direction in relation to the upper attachment portion 16a. In other words, the vibrator 60 may be disposed to be sandwiched between two upper attachment portions 16a in the seat width direction. With such an arrangement, for example, the influence on the pressure receiving member 15 can be suppressed.

Further, the vibrator 60 may be disposed inside the outer end of the first side portion 153 (hereinafter, the outer end of the pressure receiving member 15) extending outward from the plate-shaped member 152 of the pressure receiving member 15 in the seat width direction.

Since the vibrator 60 is disposed inside the outer end the pressure receiving member 15, for example, the influence on the pressure receiving member 15 can be suppressed.

Further, as described above, the actuator 33 is attached to the lower end of the back side frame 11 of the seat back frame 10 via the actuator attachment portion 34. The vibrator 60 of the seat back 1 may be disposed above the actuator attachment portion 34.

With such an arrangement, for example, the influence of the vibration of the actuator 33 can be suppressed.

Further, the vibrator 60 may be disposed within the width of a front surface portion 13a of the lower frame 13 in the right to left direction. In other words, the vibrator 60 may be disposed inside the right and left ends of the front surface portion 13a of the lower frame 13 in the seat width direction. Since the vibrator 60 is disposed in this way, the influence on the pressure receiving member 15 can be suppressed.

Further, the vibrator 60 may be disposed below the upper frame 12. Since the vibrator is disposed below the upper frame, it is possible to suppress the discomfort felt by the seated person.

Next, the arrangement of the vibrator 61 disposed on the cushion pad 50 will be described with reference to FIGS. 4 and 6.

In the conveyance seat S of this embodiment, two vibrators 61 that generate a vibration are provided in the cushion pad 50. As shown in FIG. 4, two vibrators 61 are arranged at positions in which at least a part of them do not overlap with the pressure receiving member 25 in the top view of the conveyance seat S. That is, the vibrator 61 is disposed to overlap with the opening 25b formed in the pressure receiving member 25 in the top view.

With such an arrangement, for example, when the occupant is seated, the sinking of the occupant is not hindered. That is, since the opening 25b is located below the vibrator 61, the vibrator 61 is pressed and moved when the occupant sinks down, but the movement is suppressed from being hindered by the pressure receiving member 25. Since the vibrator 61 is disposed in this way, it is possible to provide the conveyance seat S in which the vibrator 61 is disposed at an appropriate position.

Further, as shown in FIG. 6, the vibrator 61 is disposed to be located in front of the second horizontal suspension groove 51 extending in the seat width direction. Further, the vibrator 61 is disposed on the inside in the seat width direction in relation to the second vertical suspension groove 52 extending in the front to rear direction of the seat. In other words, the vibrator 61 is disposed to be sandwiched between two second vertical suspension grooves 52.

Since the vibrator 61 is disposed in this way, for example, it is possible to suppress the discomfort felt by the seated person while suppressing the influence on the second horizontal suspension groove 51 and the second vertical suspension groove 52.

Further, when the pad through hole extending in the front to rear direction, not formed in the cushion pad 50 of this embodiment, is formed, the vibrator 61 may be disposed at a position that overlaps with the pad through hole in the seat width direction. The pad through hole can absorb the deformation of the cushion pad 50 due to the vibrator 61.

Further, as shown in FIG. 4, the vibrator 61 may be disposed behind the pan frame 24 of the seat cushion frame 20. Further, it is more preferable that the vibrator 61 is disposed behind the fixing portion 24a fixing the pan frame 24 to the cushion side frame 21. Further, it is preferable that the vibrator is disposed behind the front connection frame 22.

In this way, since the vibrator 61 is disposed on the cushion pad 50, for example, it is possible to suppress the discomfort felt by the seated person.

Further, as described above, the seat switch unit 26 is provided in the cushion side frame 21 disposed on the right side of the seat cushion frame 20.

The vibrator 61 is disposed at a position that overlaps with the seat switch unit 26 in the seat width direction. In other words, the vibrator 61 may be disposed at the substantially same position as the seat switch unit 26 in the front to rear direction of the seat.

Since the seat switch unit 26 is provided to increase the frame rigidity, the vibration due to the vibrator 61 is easily transmitted to the seated person.

Further, the pressure receiving member 25 includes the inclined portion 25a that is inclined downward toward the rear as shown in FIG. 9. The vibrator 61 may be disposed to overlap with the inclined portion of the pressure receiving member 25 in the top view. That is, the vibrator 61 may be disposed above the inclined portion 25a. Since the vibrator 61 is disposed in this way, for example, it is possible to suppress the discomfort felt by the seated person.

### Another Example of Method of Fixing Vibrator

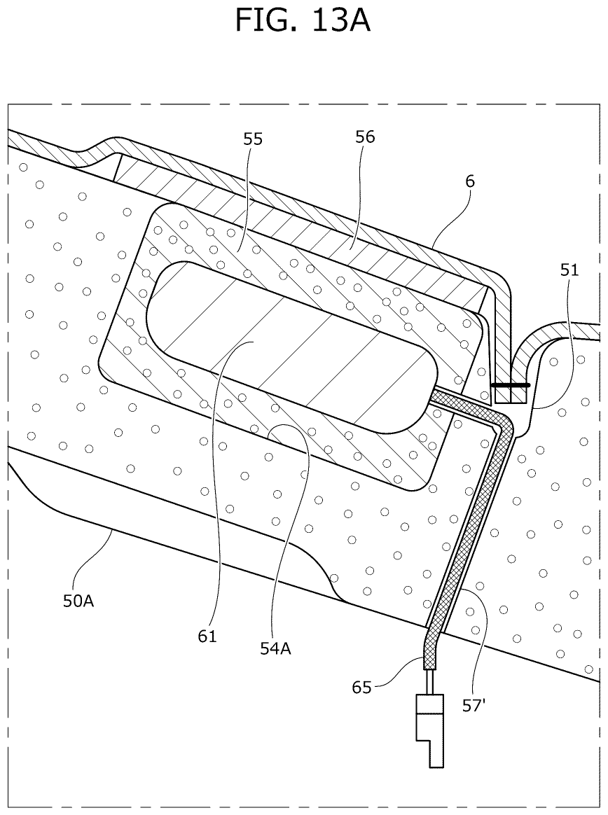

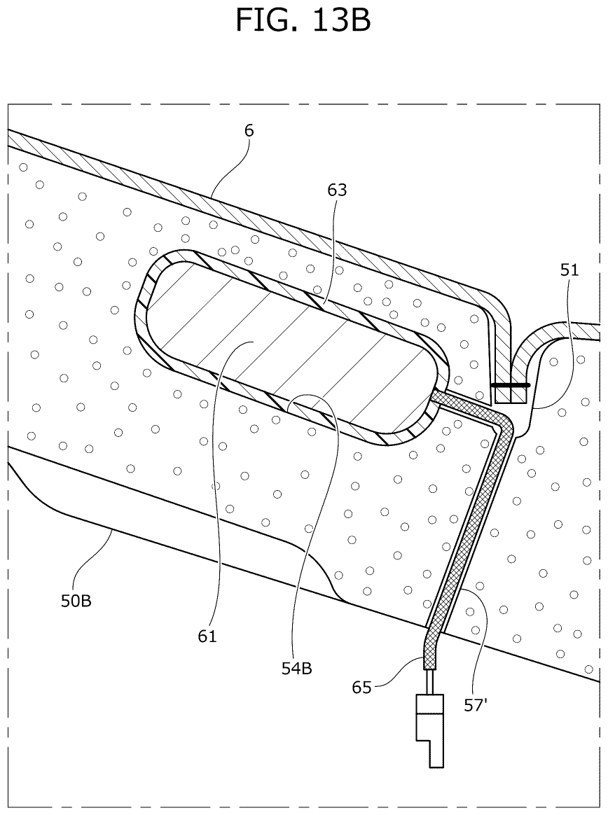

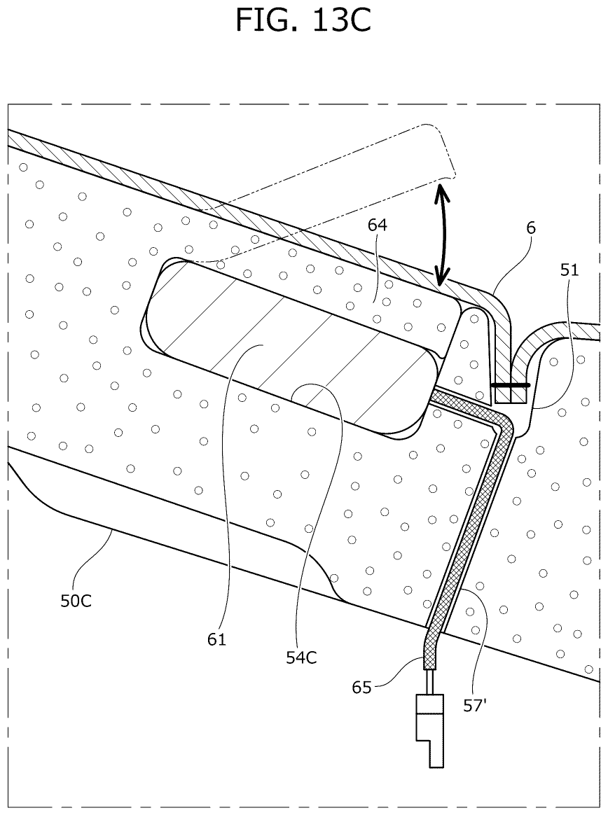

In a method of fixing the vibrator 61 shown in FIG. 10A, the storage recess 54 is formed in the seating surface 50a of the cushion pad 50, the vibrator 61 is inserted into the storage recess, and the vibrator 61 is fixed by covering the vibrator with the slab 55. However, the method of fixing the vibrator 61 is not limited thereto. Hereinafter, another example of a method of fixing the vibrators 60 and 61 will be described with reference to FIGS. 13A to 13C.

As shown in FIG. 13A, the vibrator 61 surrounded by the slab 55 may be stored in a storage recess 54A of the cushion pad 50A and fixed using the fixing tape 56.

Further, as shown in FIG. 13B, the vibrator 61 covered with a waterproof cover 63 may be integrally molded with a cushion pad 50B to fix the vibrator 61.

Further, as shown in FIG. 13C, a cushion pad 50C and an openable/closable lid 64 may be integrally molded, and the vibrator 61 may be stored and fixed in a storage recess 54C. Further, the cushion pad 50C may be formed so that the lid 64 has a higher hardness than the other portions.

### Process to Appropriately Apply Vibration

It is required that the vibration from the vibrator be appropriately applied to the seated person (for example, seated occupant). By applying a vibration appropriately, it is possible to improve the seated occupant's awareness of the vibration.

The vibration timing and the operation amount of the vibrators 60 and 61 of this embodiment are controlled by an ECU installed in the vehicle. Further, the functional components (other functional components) other than the vibrator 60 are also controlled by the ECU. Hereinafter, such a system will be referred to as a vibration system.

In order to appropriately apply a vibration, for example, when the vibrator 60 needs to be operated and/or when the vibrator 60 is operating, the vibration system may include a restriction means for restricting the operation of the other functional components.

The other functional components are devices present around the seated person, particularly devices provided in the seat, such as an air conditioner like the blower 35 provided in the conveyance seat S, a sound generating device such as a speaker, and a massage device. The other functional components may be a seat shape changing device that changes the shape of the conveyance seat S, a seat position changing device that changes the position of the conveyance seat S, or a window opening and closing device that opens and closes windows such as vehicle windows.

By restricting the operation of the other functional components, it is possible to allow the seated person to properly recognize the vibration caused by the vibrators 60 and 61.

Furthermore, restricting the operation of the other functional components may mean, for example, prohibiting the operation of the other functional components, or reducing the operation speed, operation amount or number of operating components of the other functional components compared to when the vibrators 60 and 61 are not operating.

Furthermore, after the operation of the vibrators 60 and 61 has ended, the operation of the other functional components may be restricted for a predetermined time. That is, even after the operation of the vibrators 60 and 61 has ended, the state in which the operation of the other functional components is restricted continues for a predetermined time (for example, a short time such as 5 seconds or 10 seconds).

It is possible to suppress the operation of the other functional components from being repeatedly switched between restricted and activated states and to reduce the discomfort felt by the seated person.

Further, the vibration system may include an operation amount changing means for increasing the operation amount of the vibrators 60 and 61 when the other functional components are operating compared to when the other functional components are not operating. That is, when the other functional components are operating, the vibration of the vibrators 60 and 61 is increased or the vibration time is increased, thereby increasing the vibration amount transmitted to the seated person.

In this way, the vibration caused by the vibrators 60 and 61 can be properly recognized by the seated person.

When the operation amount of the vibrators 60 and 61 is increased, the vibrators 60 and 61 may continue to operate for a predetermined time (for example, a short time such as 5 seconds or 10 seconds) even after the operation of the other functional components has ended. By continuing the operation, repeated changes in the operating state of the vibrators 60 and 61 can be suppressed, and it is possible to suppress the discomfort felt by the seated person.

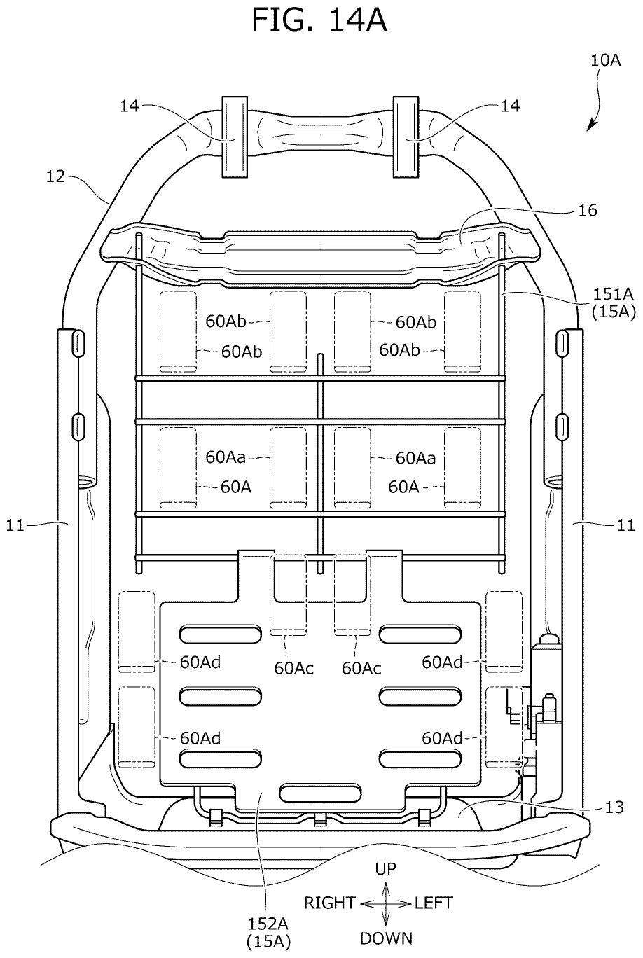

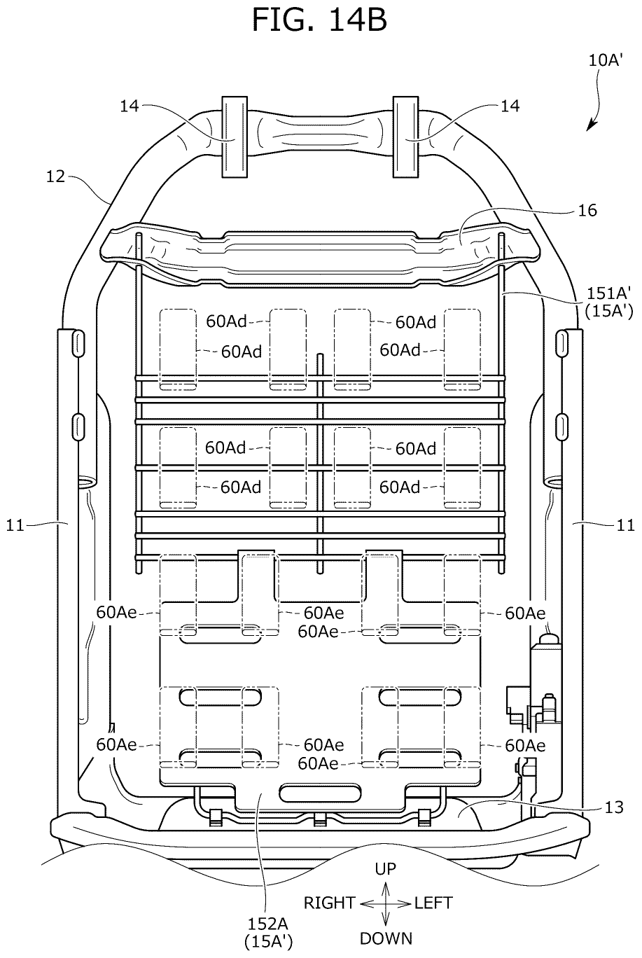

Next, other examples will be described with reference to FIGS. 14A to 23B. Furthermore, in each figure, possible positions for disposing the vibrator 60 are shown by dotted lines. The number of vibrators 60 to be arranged is not limited to two, and may be one or three or more.

FIGS. 14A to 18B are diagrams showing the positional relationship between the vibrator 60 disposed on the back pad 40 and the seat back frames 10A to 10E′.

Furthermore, seat back frames 10A to 10E′ shown in FIGS. 14A to 18B have different configurations of the pressure receiving members 15A to, and since the configurations of the back side frame 11, the upper frame 12, and the lower frame 13 are the same as those of the seat back frame 10 shown in FIG. 3, the same signs are used and detailed descriptions are omitted.

A pressure receiving member 15A shown in FIG. 14A includes a wire member 151A and a plate-shaped member 152A, and both the wire member 151A and the plate-shaped member 152A receive the load of the occupant.

As in vibrators 60A to 60Ab shown in FIG. 14A, the vibrator 60 may be disposed at a position that overlaps with the opening of the wire member 151A in the front view. Further, the vibrator 60 may be disposed at the connection part between the wire member 151A and the plate-shaped member 152A as in a vibrator 60Ac shown in FIG. 14A. As in a vibrator 60Ad shown in FIG. 14A, the vibrator 60 may be disposed at a position that overlaps with the opening between the plate-shaped member 152A and the back side frame 11 in the front view.

With such an arrangement, when the occupant sinks into the pad member, the vibrator 60 does not become an obstacle.

A pressure receiving member 15A′ of a seat back frame 10A′ shown in FIG. 14B includes a wire member 151A′ and a plate-shaped member 152A, and both the wire member 151A′ and the plate-shaped member 152A receive the load of the occupant. The number of wires constituting the wire member 151A′ shown in FIG. 14B increases compared to the wire member 151A shown in FIG. 14A.

As in a vibrator 60Ad shown in FIG. 14B, the vibrator 60 may be disposed at a position that overlaps with the wire member 151A′ in the front view.

Further, as in a vibrator 60Ae shown in FIG. 14B, the vibrator may be disposed at a position that overlaps with the plate-shaped member 152A in the front view.

In this way, since the vibrator 60 is disposed at a position that overlaps with the pressure receiving member 15A′ in the front view, the vibrator 60 can be properly supported.

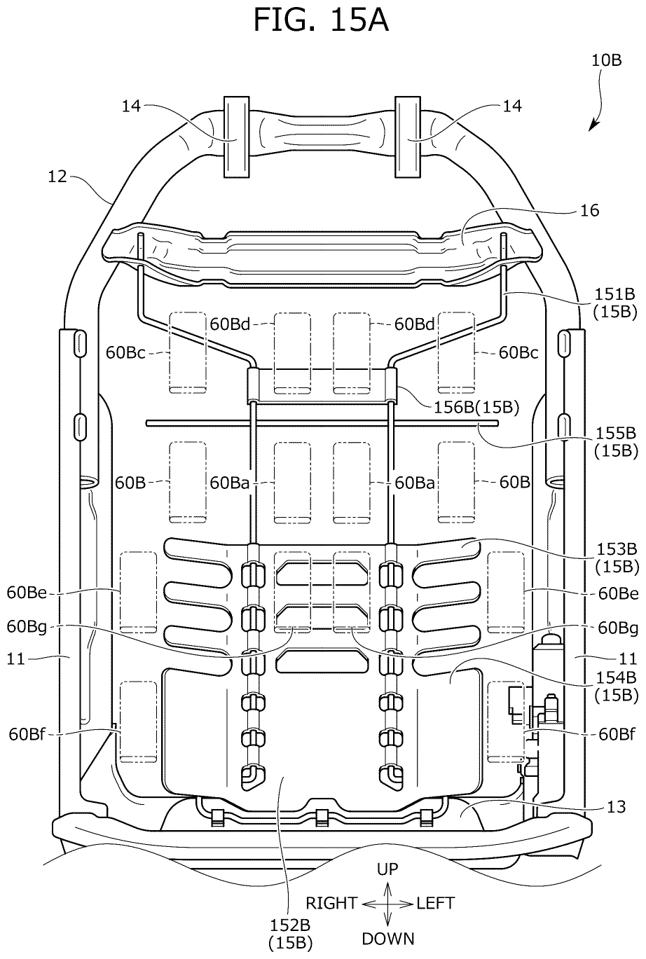

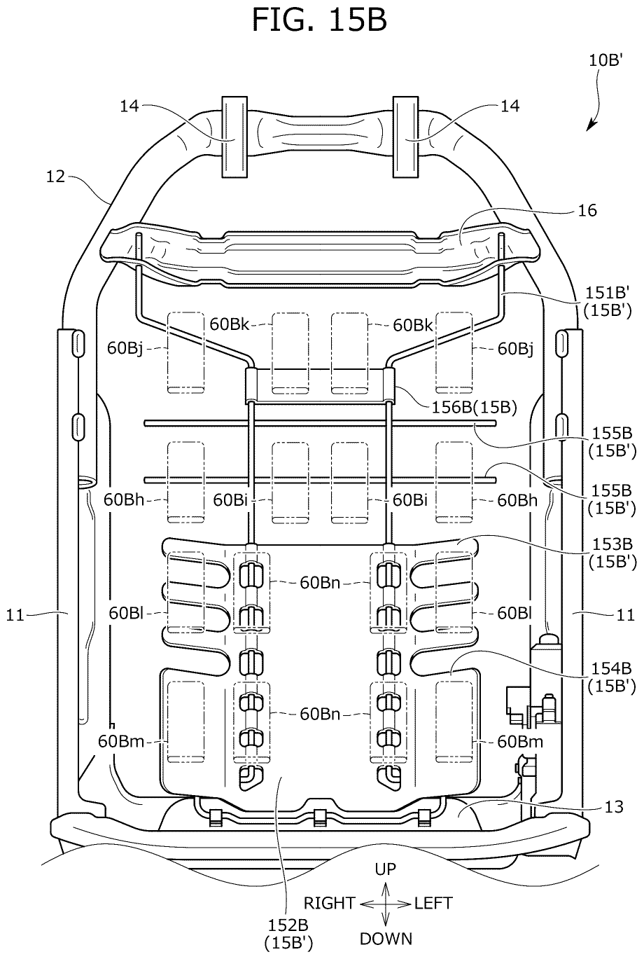

A pressure receiving member 15B shown in FIG. 15A includes a wire member 151B and a plate-shaped member 152B. Compared to the pressure receiving member 15 shown in FIG. 3, the length of the plate-shaped member 152B in the vertical direction is shorter, and the wire member 151B supporting the plate-shaped member 152B is longer by that amount. The vertically extending wire members 151B are connected by a wire connection member. Further, the wire member 151B is provided with a wire assist member 155B that extends in the Seat width direction.

As in vibrators 60B and 60Ba shown in FIG. 15A, the vibrator 60 may be disposed in the opening of the wire member 151B in the front view. Further, as in a vibrator 60Bc, the vibrator may be disposed to overlap with the wire member 151B in the front view. Further, as in a vibrator 60Bd, the vibrator may be disposed to partially overlap with the wire connection member.

Further, as in a vibrator 60Be, the vibrator 60 may be disposed outside a first side portion 153B of the plate-shaped member 152. As in a vibrator 60Bf, the vibrator 60 may be disposed outside a second side portion 154B.

Further, as in a vibrator 60g, the vibrator 60 may be disposed to partially overlap with the opening formed in the plate-shaped member 152.

A pressure receiving member 15B′ shown in FIG. 15B is different from the pressure receiving member 15B shown FIG. 15A in that one wire assist member 155B extending in the seat width direction is further provided.

As in vibrators 60Bh and 60Bi shown in FIG. 15B, the vibrator 60 is disposed to overlap with the wire assist member 155B in the front view.

Further, as in a vibrator 60Bj, the vibrator 60 may be disposed to overlap with the wire member 151B in the front view. As in a vibrator 60Bk, the vibrator 60 may be disposed to partially overlap with the wire connection member 156B.

Further, as in a vibrator 60B1, the vibrator 60 may be disposed to overlap with the first side portion 153B of the plate-shaped member 152B in the front view. As in a vibrator 60Bm, the vibrator 60 may be disposed to overlap with the second side portion 154B in the front view. Further, as in a vibrator 60Bn, the vibrator 60 may be disposed to overlap with the plate-shaped member 152B in the front view. At this time, the vibrator may overlap with the wire member 151 in the front view.

In this way, since the vibrator 60 is disposed at a position that overlaps with the pressure receiving member 15B′ in the front view, the vibrator 60 can be properly supported.

A pressure receiving member 15C shown in FIG. 16A includes a wire member 151C and a plate-shaped member 152C. The pressure receiving member is different from the pressure receiving member 15 shown in FIG. 3 in that the blower 35 is further provided. The blower 35 is attached to the wire member 151C via the blower attachment portion 37.

As in a vibrator 60C shown in FIG. 16A, the vibrator 60 may be disposed at a position that does not overlap with the pressure receiving member 15C and the blower 35 in the front view. Further, as in a vibrator 60Cc, the vibrator may be disposed at a position that avoids the blower attachment portion 37 and partially overlaps with the wire member 151C in the front view.

Further, as in a vibrator 60Cd, the vibrator may be disposed to avoid the blower attachment portion 37.

Further, the vibrator 60 may be disposed outside a first side portion 153C of the plate-shaped member 152C as in a vibrator 60Ce or may be disposed outside a second side portion 154C as in a vibrator 60Bf.

With such an arrangement, when the occupant sinks into the back pad 40, the vibrator 60 does not become an obstacle.

A pressure receiving member 15C′ shown in FIG. 16B is different from the pressure receiving member 15C shown in FIG. 16A in that an attachment piece 37a is provided in a blower attachment portion 37′.

As in a vibrator 60h shown in FIG. 16B, the vibrator 60 may be disposed at a position that overlaps with the attachment piece 37a of the blower 35 in the front view.

Further, as in a vibrator 60Ci, the vibrator may be disposed at a position that overlaps with the blower attachment portion 37. Further, as in a vibrator 60Cj, the vibrator may be disposed to overlap with the wire member 151C and the blower attachment portion 37. As in a vibrator 60Ck, the vibrator may be disposed to partially overlap with the blower attachment portion 37. Further, the vibrator may be disposed to overlap with the first side portion 153C of the plate-shaped member 152C as in a vibrator 60Cl or may be disposed to overlap with the second side portion 154C as in a vibrator 60Cm. Further, in the front view, the vibrator may be disposed to overlap with both the plate-shaped member 152C and the blower attachment portion 37.

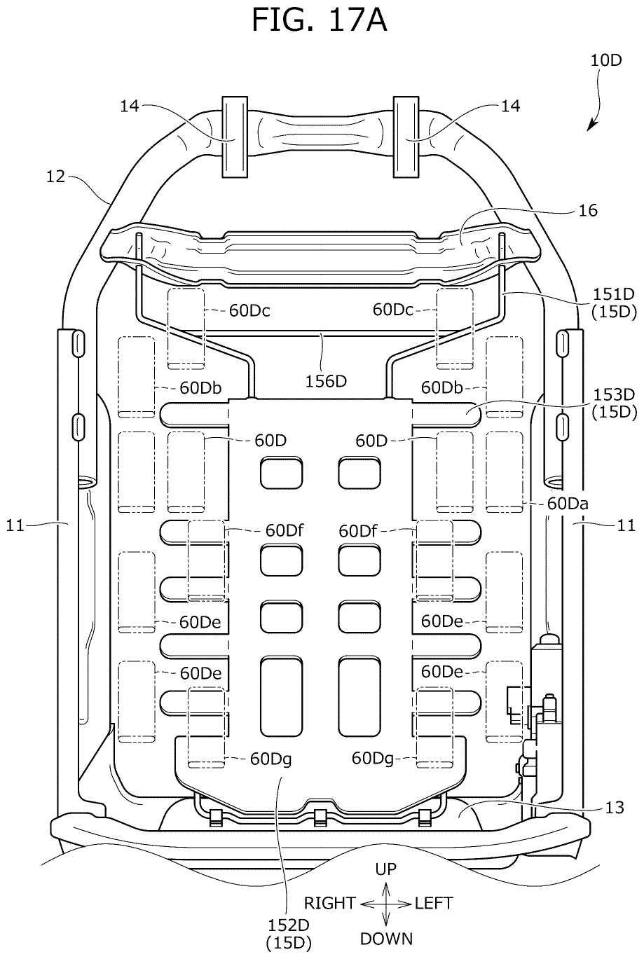

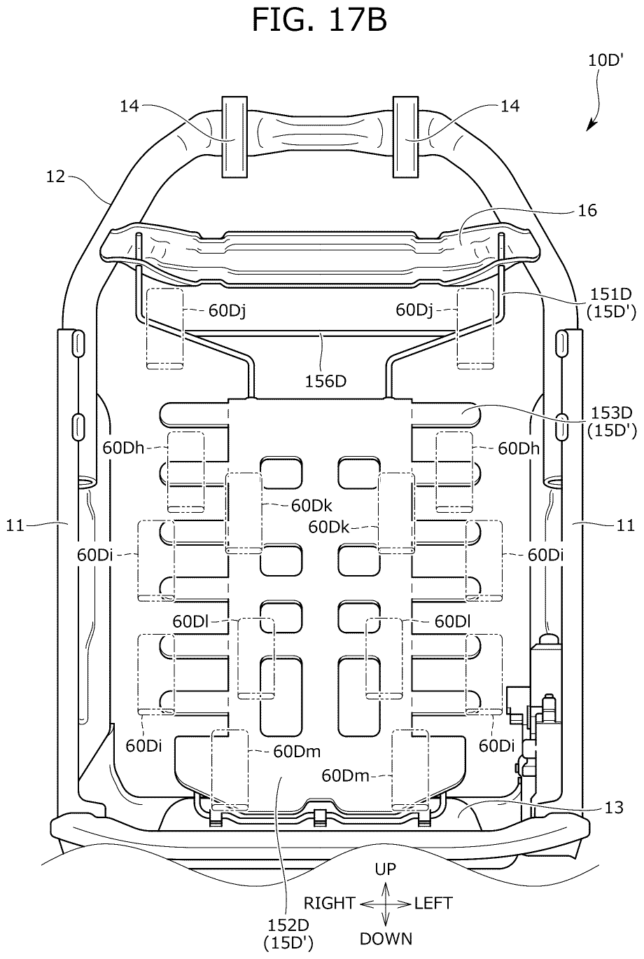

A pressure receiving member 15D shown in FIG. 17A includes a wire member 151D and a plate-shaped member 152D. The wire member 151D is connected to the wire connection member 155D. The pressure receiving member has a configuration in which the plate-shaped member 152 is longer in the vertical direction than that of the pressure receiving member 15 shown in FIG. 3 to receive a load from the occupant over a wider range.

As in a vibrator 60D shown in FIG. 17A, the vibrator 60 may be disposed at a position that does not overlap with the pressure receiving member 15D in the front view. Further, as in vibrators 60Da, 60db, and 60De, the vibrator may be disposed outside the side portion of the pressure receiving member 15D. As in a vibrator 60Dc, the vibrator 60 may be disposed to partially overlap with the connection part between the wire member 151D and the wire connection member 156D in the front view.

Further, as in vibrators 60Df and 60Dg, the vibrator may be disposed to overlap with a plurality of ribs provided on the side portion of the plate-shaped member 152D in the front view.

With such an arrangement, when the occupant sinks into the back pad 40, the vibrator 60 does not become an obstacle.

A pressure receiving member 15D′ shown in FIG. 17B is different from the pressure receiving member 15D shown in FIG. 17A in that the number of ribs (first side portions 153D′) increases.

The vibrator 60 may be disposed to overlap with the first side portion 153D′ as in a vibrator 60Dh shown in FIG. 17B. Further, as in a vibrator 60Di shown in FIG. 17B, the vibrator 60 may be disposed to partially overlap with the front end of the first side portion 153D′.

Further, as in a vibrator 60Dj shown in FIG. 17B, the vibrator 60 may be disposed to overlap with the wire member 151D in the front view. Further, as in vibrators 60Dk, 60Dl, and 60Dm shown in FIG. 17B, the vibrator 60 may be disposed to overlap with the plate-shaped member 152D.

In this way, since the vibrator 60 is disposed at a position that overlaps with the pressure receiving member 15D′ in the front view, the vibrator 60 can be properly supported.

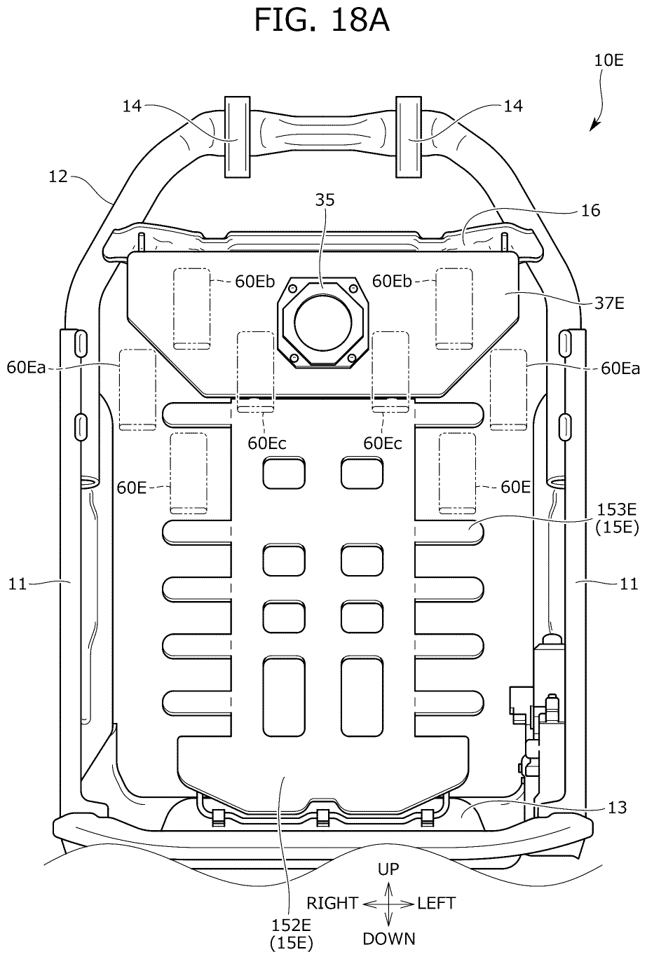

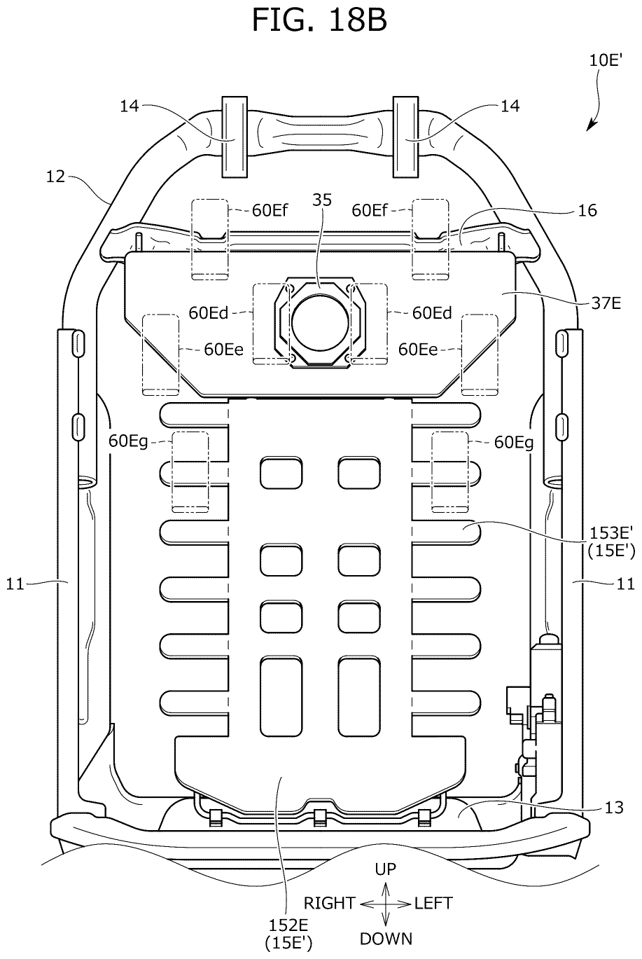

A pressure receiving member 15E shown in FIG. 18A includes a blower attachment portion 37E to which the blower 35 is attached and a plate-shaped member 152E.

As in vibrators 60E and 60Ea shown in FIG. 18A, the vibrator 60 may be disposed at a position that does not overlap with the pressure receiving member 15E in the front view. Further, as in vibrators 60Eb and 60Ec, the vibrator 60 may be disposed at a position that does not overlap with the blower 35 in the front view, that is, a position that avoids the blower 35.

A pressure receiving member 15E′ shown in FIG. 18B is different from the pressure receiving member 15E shown in FIG. 18A in that the number of ribs increases.

As in a vibrator 60Ed shown in FIG. 18B, the vibrator 60 may be disposed at a position that overlaps with the blower 35 in the front view.

Further, as in vibrators 60Ee and 60Ef shown in FIG. 18B, the vibrator 60 may be disposed at a position that partially overlaps with the blower attachment portion 37E.

Further, as in a vibrator 60Eg shown in FIG. 18B, the vibrator 60 may be disposed to overlap with the first side portion 153E′ in the front view.

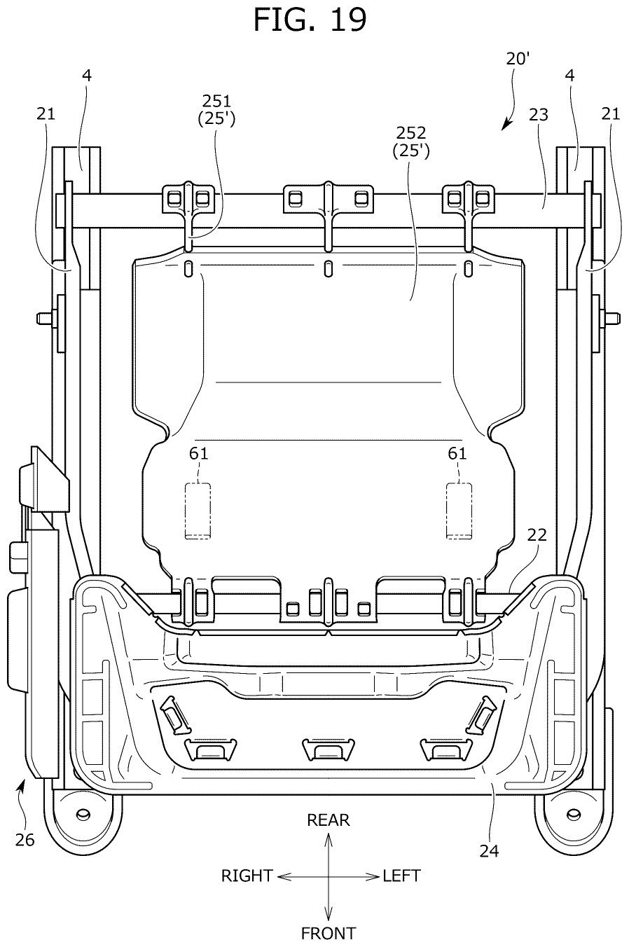

Next, the position of the vibrator 61 disposed on the cushion pad 50 will be described. £ FIGS. 19 to 23B are diagrams showing the positional relationship between the vibrator 61 disposed on the cushion pad 50 and seat cushion frames 20′ to 20D′.

Furthermore, the seat cushion frame shown in FIGS. 19 to 23B have a different configuration of the pressure receiving member 25, but since the configurations of the cushion side frames 21 and 21, the front connection frame 22, the rear connection frame 23, the pan frame 24, and the rail device 4 are the same as those of the seat cushion frame 20 shown in FIG. 4, the same signs are used and detailed descriptions are omitted.

A pressure receiving member 25′ shown in FIG. 19 is made of a plate-shaped member as in the pressure receiving member 25 shown in FIG. 4, but has a difference in that the opening 25b is not formed.

As shown in FIG. 19, the vibrator 61 disposed on the cushion pad 50 may be disposed to overlap with the pressure receiving member 25′. With such an arrangement, the vibrator 61 can be properly supported.

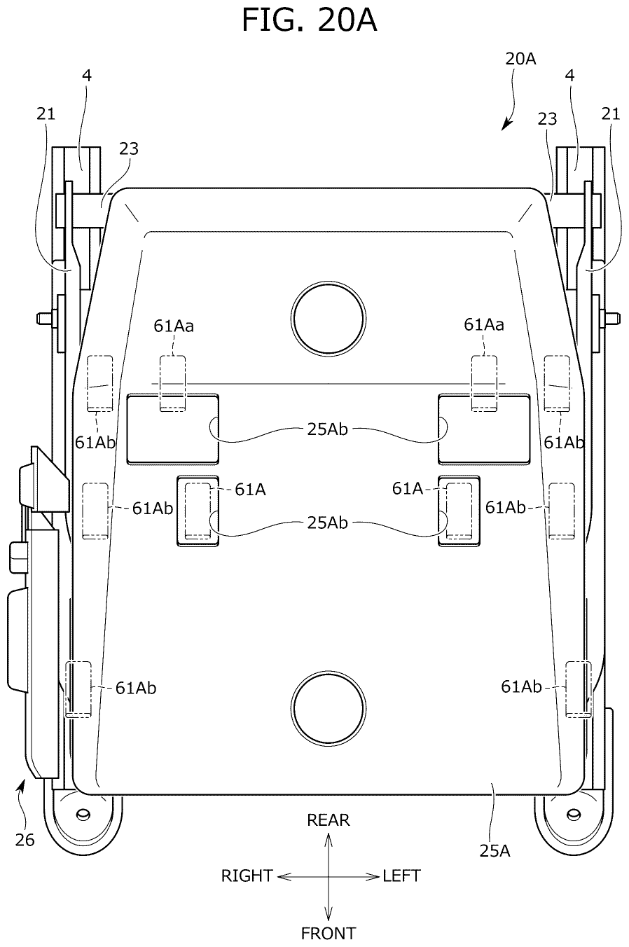

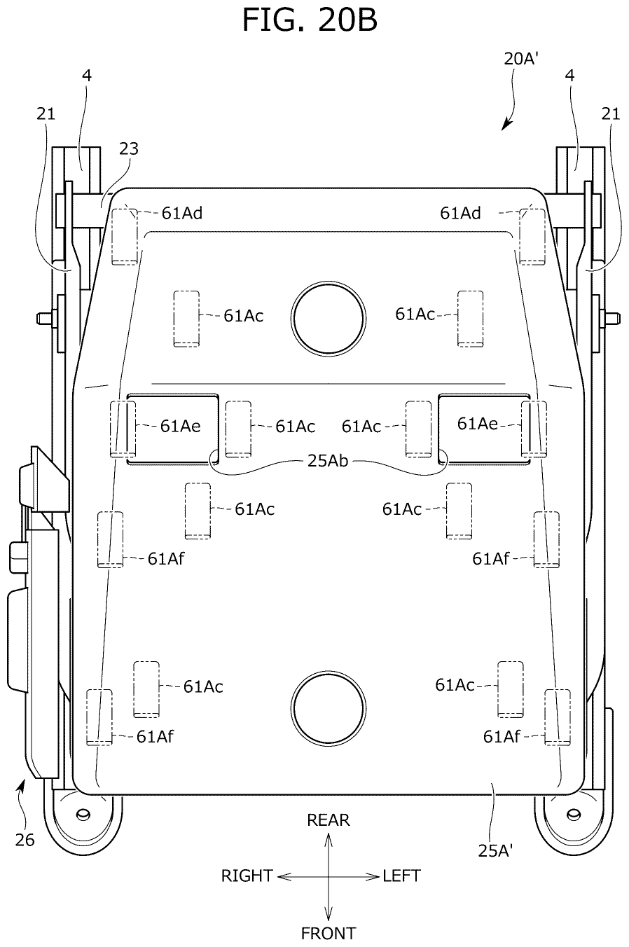

A pressure receiving member 25A shown in FIG. 20A is different from the pressure receiving member 25 shown in FIG. 4 in that the pan frame 24 is omitted and the pressure receiving member is made of a single plate-shaped member.

As in a vibrator 61A shown in FIG. 20A, the vibrator 61 may be disposed at a position that does not overlap with the pressure receiving member 25A in the top view. In other words, the vibrator 61 may be disposed at a position that overlaps with an opening 25Ab.

Further, as in a vibrator 61Aa shown in FIG. 20A, the vibrator 61 may be disposed to partially overlap with the opening 25Ab.

As in a vibrator 61Ab shown in FIG. 20A, the vibrator 61 may be disposed to overlap with the side portion of the pressure receiving member 25A.

With such an arrangement, for example, when the occupant sinks into the cushion pad 50, the vibrator 61 does not become an obstacle.

A pressure receiving member 25A′ shown in FIG. 20B is made of a single pan frame, and is different from the pressure receiving member 25 shown in FIG. 20A in that the opening 25Ab is partially blocked.

As in a vibrator 61Ac shown in FIG. 20B, the vibrator 61 may be disposed at a position that overlaps with the pressure receiving member 25A′ in the top view. In other words, the vibrator 61 may be disposed at a position that overlaps with the opening 25Ab.

Further, as in vibrators 61Ad, 61e, and 61F shown in FIG. 20B, the vibrator 61 may be disposed to partially overlap with a boundary part (bent portion) between the side portion and the main body of the pressure receiving member 25A′. Since the vibrator is disposed to overlap with the high-hardness portion in the top view, the vibrator 61 can be properly supported.

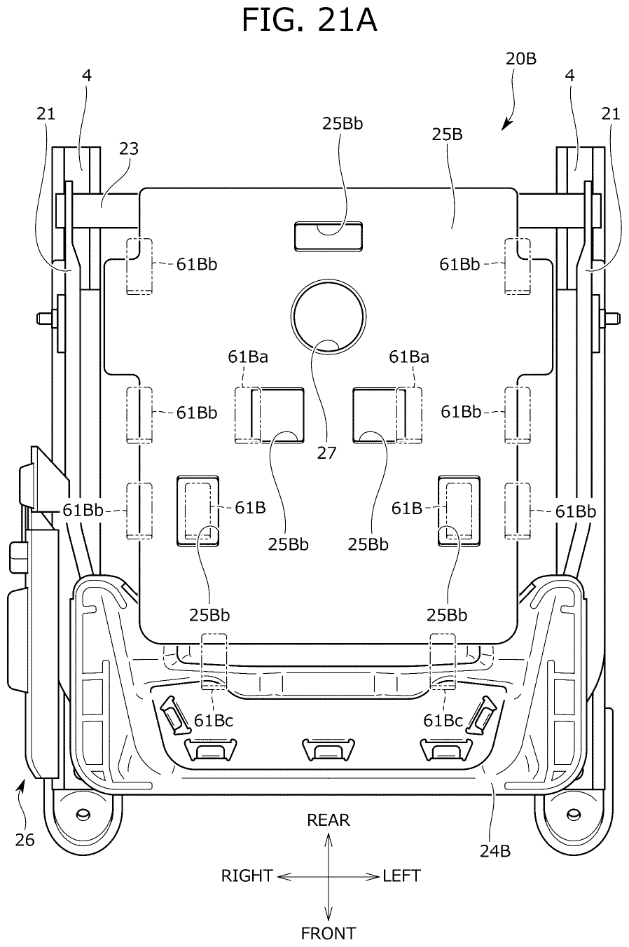

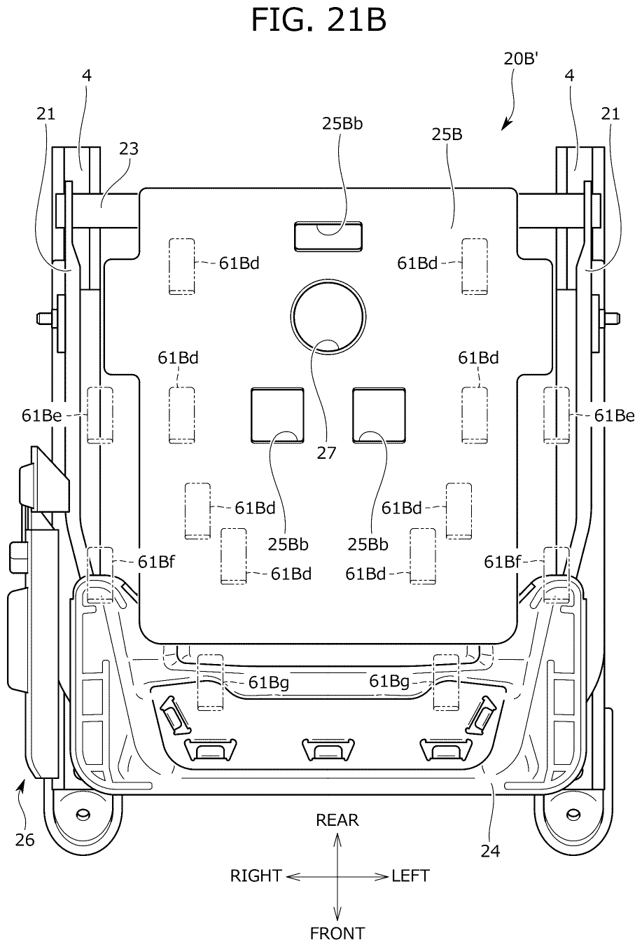

A pressure receiving member 25B shown in FIG. 21A is different from the pressure receiving member 25 shown in FIG. 4 in that the wire member is omitted and the pressure receiving member is made of a single plate-shaped member.

As in a vibrator 61B shown in FIG. 21A, the vibrator 61 may be disposed at a position that does not overlap with the pressure receiving member 25B in the top view. In other words, the vibrator 61 may be disposed at a position that overlaps with an opening 25Bb.

The vibrator 61 may be disposed at a position that partially overlaps with the opening 25Bb as in a vibrator 61Ba shown in FIG. 21A. Further, as in vibrators 61Bb and 61Bc, the vibrator may be disposed to partially overlap with the peripheral end of the pressure receiving member 25B.

With such an arrangement, for example, when the occupant sinks into the pad member, the vibrator 61 does not become an obstacle.

A pressure receiving member 25B′ shown in FIG. 21B has a difference in that the opening 25Bb is partially blocked.

As in a vibrator 61Bd shown in FIG. 21B, the vibrator 61 may be disposed at a position that overlaps with the pressure receiving member 25B′ in the top view.

Further, as in a vibrator 61Be shown in FIG. 21B, the vibrator 61 may be disposed at a position that overlaps with the cushion side frame 21 in the top view. Further, as in a vibrator 61Bf shown in FIG. 21B, the vibrator may be disposed at a position that overlaps with the connection part between the pan frame 24 and the cushion side frame 21 in the top view.

Further, as in a vibrator 61Bg shown in FIG. 21B, the vibrator may be disposed at a position that overlaps with the pan frame 24 in the top view.

Since the vibrator is disposed to overlap with the high-hardness portion in the top view, the vibrator 61 can be properly supported.

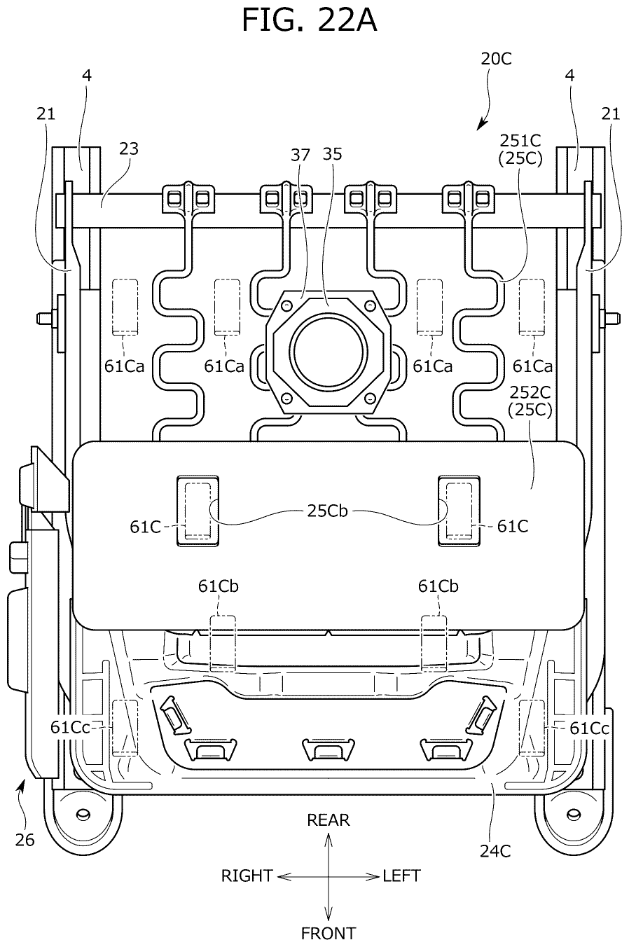

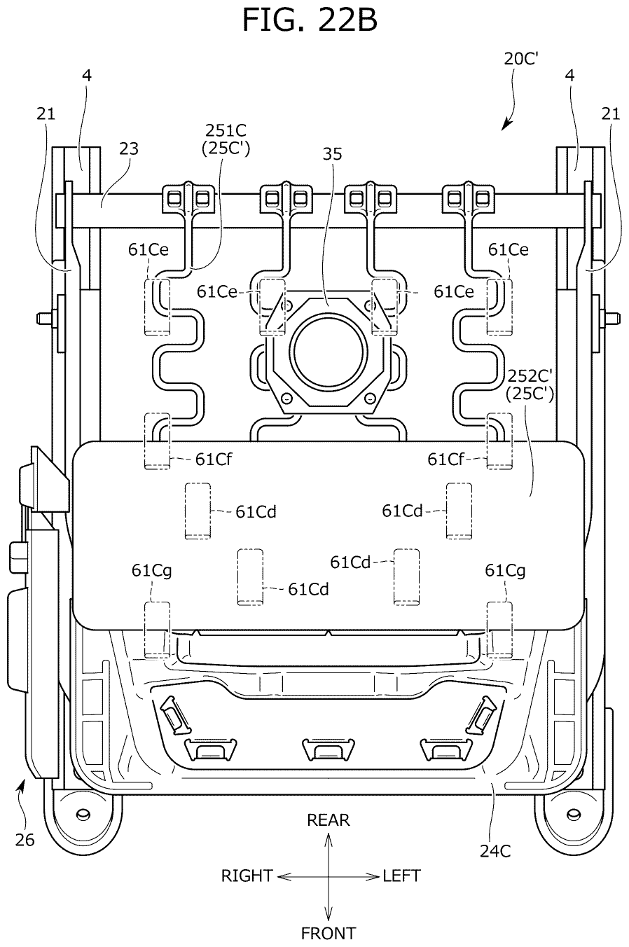

A pressure receiving member 25C shown in FIG. 22A includes a plate-shaped member 25Ca, an S-spring 25Cc which supports the plate-shaped member 25Ca, the blower 35, and the blower attachment portion 37 which attaches the blower 35 to the S-spring 25Cc.

As in vibrators 61C, 61Ca, and 61Cc shown in FIG. 22A, the vibrator 61 may be disposed at a position that does not overlap with the pressure receiving member 25C in the top view. In other words, the vibrator 61 may be disposed at a position that overlaps with an opening 25Cb or an opening between the adjacent S-springs 25Cc.

Further, as in a vibrator 61Ca shown in FIG. 22A, the vibrator 61 may be disposed at a position that avoids the positions of the blower 35 and the blower attachment portion 37.

Further, as in a vibrator 61Cb shown in FIG. 22A, the vibrator 61 may be disposed not to partially overlap with the plate-shaped member 25Ca.

With such an arrangement, for example, when the occupant sinks into the cushion pad 50, the vibrator 61 does not become an obstacle.

A pressure receiving member 25C′ shown in FIG. 22B is different from the pressure receiving member 25C shown in FIG. 22A in that the opening 25Cb is blocked.

As in a vibrator 61Cd shown in FIG. 22B, the vibrator 61 may be disposed at a position that overlaps with the plate-shaped member 252C′ of the pressure receiving member 25C′ in the top view.

Further, as in a vibrator 61Ce shown in FIG. 22B, the vibrator 61 may be disposed to overlap with the S-spring 251C′, the blower 35, or the blower attachment portion 37 in the top view.

Further, as in a vibrator 61Cf, the vibrator may be disposed to overlap with both the plate-shaped portion and the S-spring 251C.

Further, as in a vibrator 61Cg, the vibrator may be disposed to partially overlap with the plate-shaped member 252C′.

Since the vibrator is disposed to overlap with the high-hardness portion in the top view, the vibrator 61 can be properly supported.

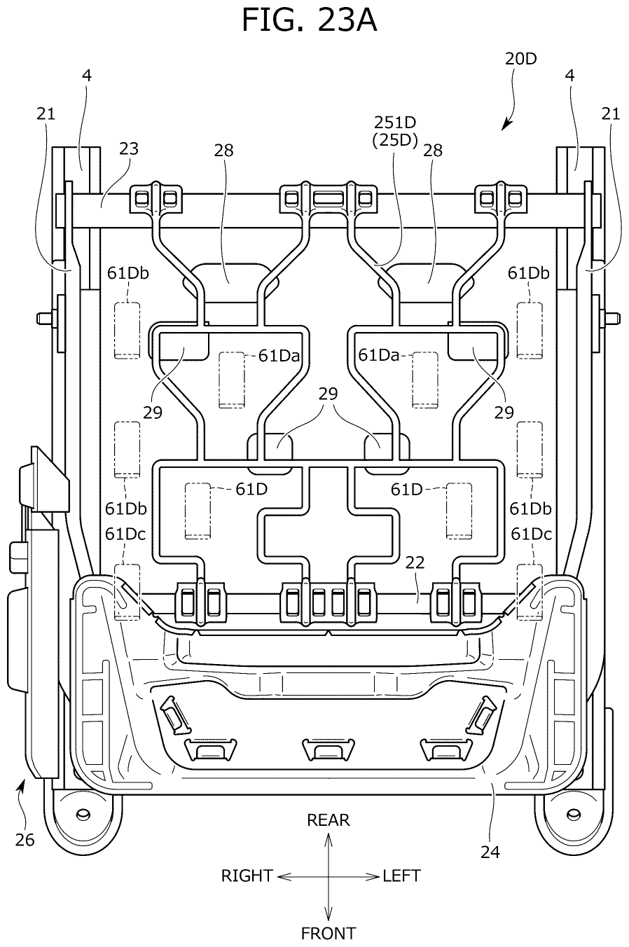

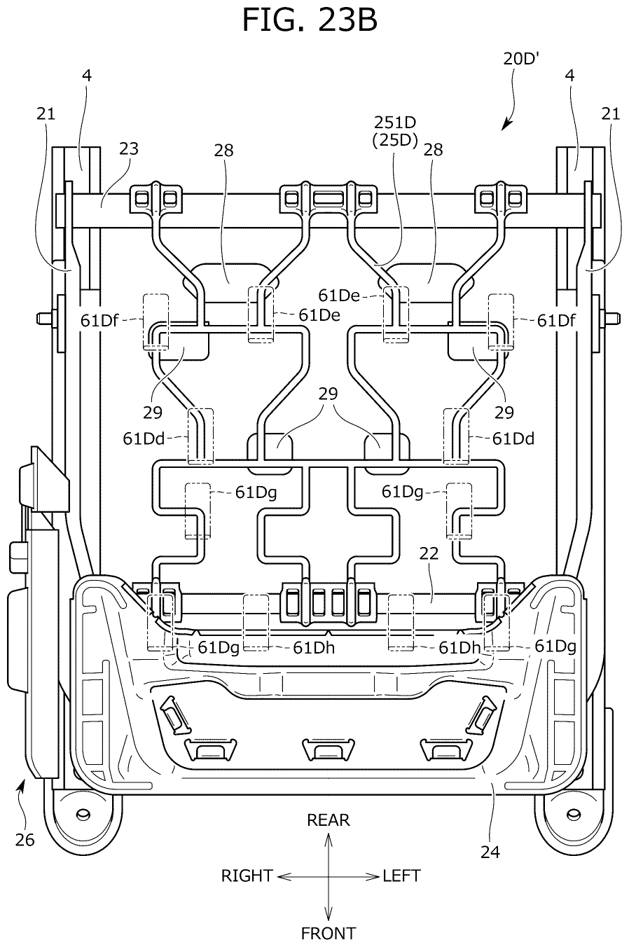

A pressure receiving member 25D shown in FIG. 23A includes a wire member 251D, a wire connection member 28 that connects the wire member 251D, and a wire reinforcement member 29 that reinforces the wire.

As in vibrators 61D, 61Da, and 61Db shown in FIG. 23A, the vibrator 61 may be disposed at a position that does not overlap with the pressure receiving member 25D made of a wire member in the top view.

Further, as in a vibrator 61Dc, the vibrator may be disposed to partially overlap with the pan frame 24.

With such an arrangement, for example, when the occupant sinks into the cushion pad 50, the vibrator 61 does not become an obstacle.

Further, as in vibrators 61Dd, 61De, 61Dd, and 61Dg shown in FIG. 23B, the vibrator may be disposed at a position that overlaps with the pressure receiving member 25D made of a wire member in the top view.

Further, as in vibrators 61De and 61Df, the vibrator may be disposed to overlap with the wire connection member 28 and the wire reinforcement member 29. As in a vibrator 61Dh, the vibrator may be disposed to partially overlap with the pan frame 24 and the front connection frame 22 in the top view.

Since the vibrator is disposed to overlap with the high-hardness portion in the top view, the vibrator 61 can be properly supported.

As described above, the conveyance seat S according to this embodiment has been described with reference to the drawings. Furthermore, in this embodiment, the present invention is applied to the conveyance seat S installed in the vehicle, but the seat provided with the vibrators 60 and 61 is not limited to the conveyance seat S. The present invention can be applied to any ordinary chair or sofa as long as it has a seating surface. Further, the arrangement of the vibrator 60 applied to the above-described seat back 1 may be applied to the vibrator 61 of the seat cushion 2, and the arrangement of the vibrator 61 applied to the seat cushion 2 may be applied to the vibrator 60 of the seat back 1.

### Second Embodiment

Hereinafter, a second embodiment of the present invention will be described.

### Technical Field and Background Art

The present invention relates to a conveyance seat and particularly to a conveyance seat with a vibrator.

Conventionally, obstacle approach warning systems have been developed that notify a seated person when an obstacle or another vehicle approaches the vehicle. For example, external sensors arranged on the front, rear, right, and left sides of the vehicle to monitor the presence of approaching objects in the outer periphery of the vehicle, and when an approaching object is detected, a warning signal consisting of sound or light is output. In this way, the safety of the seated person is improved by providing a warning to the seated person of the approach of an obstacle or the like and allowing the seated person to avoid danger.

Further, International Publication No. 2019/044826 discloses a vibration control device that uses a vibration unit built in a vehicle seat (driver's seat) as a notification means. Specifically, a vibration control means is disclosed that can notify the approach and the approaching direction of an obstacle by vibrating the vibration unit disposed in the approaching direction of the obstacle.

By adopting the vibration unit as the notification means as in the technology described in PATENT LITERATURE 1, it is possible to notify the driver of the presence of an approaching object even in situations where it is difficult for the driver to visually or audibly recognize the object, for example, when it is difficult for the driver to direct their gaze toward the notification means.

### SUMMARY OF INVENTION

### Technical Problem

According to the technology described in International Publication No. 2019/044826, the effectiveness of the vibration unit as a means for notifying the seated person of the approach and the approaching direction of an obstacle without relying on the visual or auditory senses of the seated person can be recognized. However, in a seat having a movable mechanism that can change the position or posture, it is not possible to notify the approaching direction of an obstacle according to the position or posture. Therefore, for example, when the seat is rotated backward relative to the travel direction of the vehicle, a problem arises in that the direction in which an obstacle is approaching cannot be correctly notified.

The present invention has been made in view of the above-described problems, and an object of the present invention is to provide a conveyance seat which includes a movable mechanism capable of changing the position or posture of a seat body and a vibrator serving as a notification means and which provides appropriate notification according to the position and posture of the seat body.

### Solution to Problem

According to the conveyance seat of the present invention, the above-described problems are solved by a conveyance seat including: a seat body which is installed in a conveyance, a movable mechanism which changes the position and posture of the seat body, a plurality of vibrators which are provided in the seat body, and a control device which controls the driving of the plurality of vibrators, in which the plurality of vibrators are built in the seat body at different positions in the front to rear direction of the seat and the seat width direction, and in which the control device controls the driving of the vibrator by selecting a vibration notification pattern of vibrating at least one of the plurality of vibrators in a predetermined order and a predetermined vibration parameter based on the position and posture of the seat body to notify an occupant.

According to the above-described configuration, the control device controls the vibrator by selecting one vibration notification pattern from the plurality of vibration notification patterns based on the position and posture of the seat body. Therefore, the conveyance seat can provide appropriate notification according to the position and posture thereof.

Further, the movable mechanism may include a rotation mechanism that changes the rotation position of the seat body around a vertical rotation axis, and the control device may select the vibration notification pattern based on the rotation position of the seat body.

According to the above-described configuration, the conveyance seat can provide appropriate notification according to the rotation position.

Further, the rotation mechanism may change the seat body between a first rotation position that faces a front side of the conveyance and a second rotation position that faces a rear side of the conveyance, the control device may select a first vibration notification pattern when the seat body is located at the first rotation position and may select a second vibration notification pattern when the seat body is located at the second rotation position, and the second vibration notification pattern may be a vibration notification pattern of vibrating the vibrator located on the opposite side around the rotation axis relative to the vibrator that is vibrated when the first vibration notification pattern is selected.

According to the above-described configuration, when the seat body is in a rotation position that faces the rear side of the conveyance, the control device selects the vibration notification pattern of vibrating the vibrator located on the opposite side around the rotation axis relative to the vibration pattern selected when the seat body is in a rotation position that faces the front side of the conveyance. Therefore, the conveyance seat can provide appropriate notification at the rotation position that faces the rear side of the conveyance.

Further, the rotation mechanism may change the seat body between the first rotation position that faces the front side of the conveyance and a third rotation position that faces a direction rotated by 90° in one rotation direction from the front side of the conveyance, the control device may select a first vibration notification pattern when the seat body is located at the first rotation position and select a third vibration notification pattern when the seat body is located at the third rotation position, and the third vibration notification pattern may be a vibration notification pattern of vibrating the vibrator located on the side rotated by 90° around the rotation axis in the other rotation direction relative to the vibrator vibrated when the first vibration notification pattern is selected.

According to the above-described configuration, when the seat body is in a rotation position that is rotated by 90° in one rotation direction from the front side of the conveyance, the control device selects the vibration notification pattern of vibrating the vibrator located on the side rotated by 90° in the other rotation direction around the rotation axis relative to the vibration pattern selected when the seat body is in a rotation position that faces the front side of the conveyance. Therefore, the conveyance seat can provide appropriate notification at the rotation position that faces the side of the conveyance.

Further, the movable mechanism may include a slide mechanism which changes the position of the seat body in the front to rear direction along a slide rail extending in the front to rear direction, and the control device may select the vibration notification pattern based on the position of the seat body in the front to rear direction.

According to the above-described configuration, the conveyance seat can provide appropriate notification according to the position in the front to rear direction.

Further, the seat body may have a seat cushion and a seat back, the movable mechanism may include a reclining mechanism that changes the posture of the seat body between an upright posture in which the seat back stands up relative to the seat cushion and a tilted posture in which the seat back is tilted backward at a predetermined tilt angle relative to the seat cushion, and the control device may select the vibration notification pattern based on the tilt angle.

According to the above-described configuration, since the control device selects the vibration notification pattern based on the tilt angle of the seat back relative to the seat cushion, the conveyance seat can provide appropriate notification according to the posture.

Further, the seat body may have right and left armrests, the vibrator may have an arm vibrator provided in each of the right and left armrests, and the control device may select the vibration notification pattern of vibrating at least one of the right and left arm vibrators in a predetermined order and a predetermined vibration parameter based on the position and posture of the seat body.

According to the above-described configuration, the conveyance seat may provide appropriate notification according to the position and posture of the conveyance seat by vibrating the arm vibrator provided in the armrest.

Further, the seat body may have an ottoman, the vibrator may have a plurality of leg vibrators provided in the ottoman, and the control device may select the vibration notification pattern of vibrating at least one of the plurality of leg vibrators in a predetermined order and a predetermined vibration parameter based on the position and posture of the seat body.

According to the above-described configuration, the conveyance seat can provide appropriate notification according to the position and posture of the conveyance seat by vibrating the leg vibrator provided in the ottoman.

Further, the seat body may have a headrest, the headrest may have a plurality of audio output devices built therein, and the control device may output an audio signal from the audio output device located in the same direction as the one vibrator when viewed from the seated person based on the position and posture of the seat body. According to the above-described configuration, the conveyance seat can provide appropriate notification according to the position and posture of the conveyance seat by vibrating a head vibrator provided in the headrest.

Further, the seat body may have a seat frame which forms a framework of the seat body, a pad material which is placed on the seat frame, and a skin material which covers the pad material.

According to the above-described configuration, it is possible to provide the conveyance seat that provides appropriate notification according to the position and posture.

### Advantageous Effects of Invention

According to the conveyance seat of the present invention, it is possible to provide appropriate notification according to the position and posture thereof.

Further, it is possible to provide appropriate notification according to the rotation position of the conveyance seat.

Further, the conveyance seat can provide appropriate notification at the rotation position that faces the rear side of the conveyance.

Further, the conveyance seat can provide appropriate notification at the rotation position that faces the side of the conveyance.

Further, the conveyance seat can provide appropriate notification according to the position in the front to rear direction.

Further, the conveyance seat can provide appropriate notification according to the posture.

### Description of Embodiments

Hereinafter, the configuration of a conveyance seat of a first example according to the second embodiment of the present invention will be described with reference to the drawings. However, the embodiments described below are intended to facilitate understanding of the present invention and are not intended to limit the present invention. In other words, the present invention can be modified or improved without departing from the spirit of the invention, and it goes without saying that the present invention includes equivalents thereof.

Further, in the following description, the contents regarding the materials, shapes, and sizes of the seat components are merely examples and do not limit the present invention.

Hereinafter, a vehicle seat S20 installed in a vehicle V20 will be taken as an example of a conveyance seat, and a configuration example thereof will be described. However, the present invention is not limited to seats installed in conveyances that have wheels and travel on land, such as automobiles and trains, but may also be seats installed in aircraft, ships, and other conveyances that move other than on land.

Further, in the following description, the “front to rear direction of the seat” refers to the front to rear direction of the vehicle seat S20 and coincides with the front to rear direction as viewed from the seated person seated on the vehicle seat S20. The “front to rear direction of the vehicle” coincides with the travel direction when the vehicle is traveling. Further, the “seat width direction” refers to the width direction of the vehicle seat S20 and coincides with the right to left direction as viewed from the seated person seated on the vehicle seat S20. Further, the “up to down direction” refers to the up to down direction of the vehicle seat S20 and coincides with the vertical direction when the vehicle V20 is traveling on a horizontal plane. In addition, when simply referring to the “outside”, the outside refers to the side closer to the outside in the direction from the center of the vehicle seat S20 alone to the outside, and when referring to the “inside”, the inside refers to the side closer to the center in the direction from the outside to the center of the vehicle seat S20 alone.

### Overview of Vehicle Seat S20

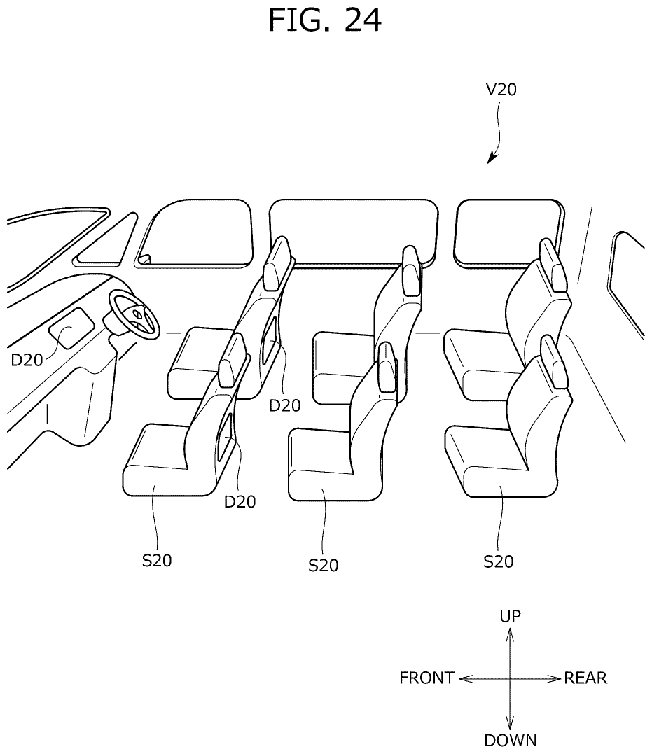

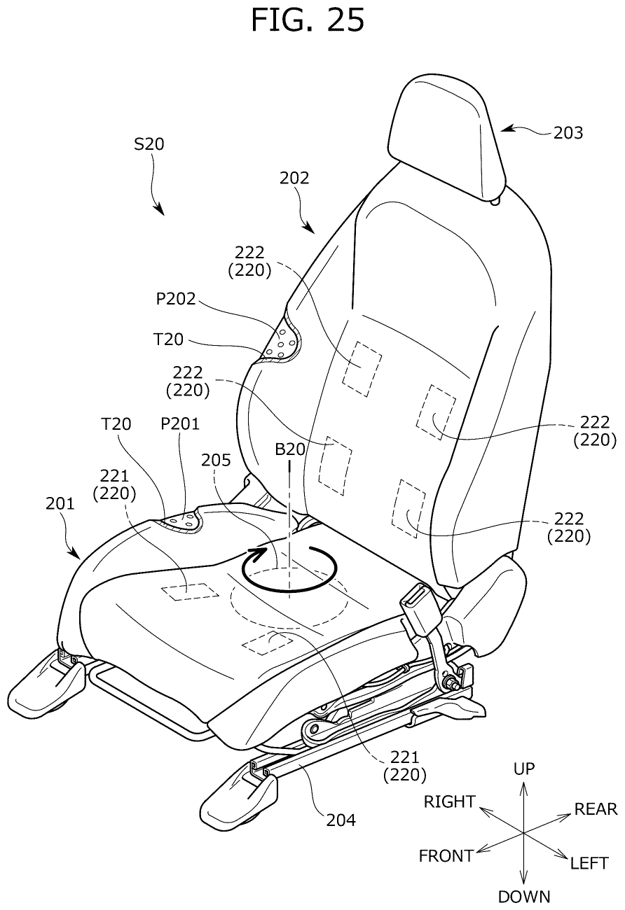

FIG. 24 shows the interior of the vehicle V20 equipped with the vehicle seat S20 according to the present invention. As shown in FIG. 24, the vehicle V20 is provided with three rows of vehicle seats S20 in the front to rear direction of the vehicle. A vibrator 220 which serves as a notification means is built in each vehicle seat S20 (see FIG. 25). Further, the vehicle seat S20 includes a movable mechanism and can change the position and posture thereof in the vehicle interior. The vehicle seat S20 of the present invention is used to provide appropriate notification for the occupant seated on the vehicle seat S20 by selecting the vibration pattern of the vibrator 220 based on the position and posture of the vehicle seat S20.

In FIG. 24, the vehicle interior of the vehicle V20 is equipped with a first-row front seat, a second-row middle seat, and a third-row rear seat, but the present invention is not limited thereto. The vehicle interior of the vehicle V20 may be equipped with only front and rear seats.

The vehicle V20 has a manual driving mode and an automatic driving mode. The manual driving mode refers to a control state in which the vehicle V20 is controlled based on the driving operation by the driver. On the other hand, the automatic driving mode refers to a control state in which the situation of the vehicle V20 is determined based on signals output by various sensors, and the vehicle V20 is controlled to drive automatically according to the determination results. In the following description, it is assumed that no driving operation by the driver is required in the automatic driving mode. Accordingly, in the automatic driving mode, the vehicle V20 can travel with the front seats facing backward or the side of the vehicle V20.

A touch panel display device D20 is provided in front of the occupant seated on the vehicle seat S20. The display device D20 is configured to be capable of selecting and playing various types of video information, and the occupant can spend the travel time comfortably by operating the display device D20 to display a preferred video on the display device D20.

In FIG. 24, the display device D20 is fixed to the vehicle V20 or the vehicle seat S20, but the present invention is not limited thereto. The display device D20 may be a tablet terminal that can be used in a state removed from the vehicle V20 or the vehicle seat S20.

FIG. 25 is a perspective view of the vehicle seat S20 as viewed obliquely from the front. In FIG. 25, for convenience of illustration, a part of the vehicle seat S20 is shown with a skin material T20 removed.

In this embodiment, the vehicle seat S20 will be described as a front seat installed in the first row of the vehicle V20. However, the present invention is not limited thereto, and the vehicle seat S20 can also be used as a second-row middle seat or a third-row rear seat.

As shown in FIG. 25, the vehicle seat S20 includes a seat cushion 201, a seat back 202, and a headrest 203. Further, the vehicle seat S20 includes a movable mechanism capable of changing the position and posture of the seat body (the seat cushion 201, the seat back 202, and the headrest 203). The movable mechanism includes a rail device 204 which supports the seat body to be movable in the front to rear direction of the vehicle V20, a rotation device 205 which is capable of rotating the vehicle seat S20 around a rotation axis B20 extending in the vertical direction, and a reclining device 206 (see FIG. 25) which rotatably connects the seat back 202. The rail device 204, the rotation device 205, and the reclining device 206 respectively correspond to the slide mechanism, the rotation mechanism, and the reclining mechanism.

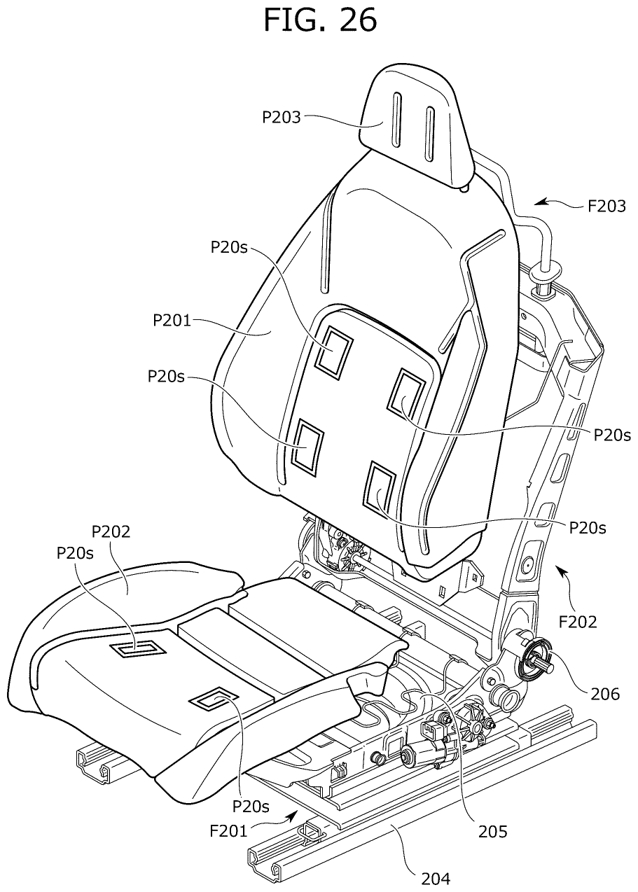

The seat cushion 201 serves as a seating portion that supports the buttocks of the seated person. The seat cushion 201 has a configuration in which a pad material P201 is placed on a seat cushion frame F201 (see FIG. 26) forming a framework of the seat cushion 201 and the pad material P201 is covered with the skin material T20.

The seat cushion 201 includes a plurality of seat cushion vibrators 221 (vibrators 220) that are used as a notification means for the seated person. More specifically, the seat cushion vibrator 221 is embedded in the recess formed in the pad material P201 and is covered with a slab P20s.

The seat cushion vibrator 221 is disposed in front of the vehicle seat S20. More specifically, the seat cushion vibrator 221 is disposed to be located on the front side of the seat in relation to the rotation axis B20 of the rotation device 205 to be described later. Further, the seat cushion vibrator 221 is disposed to be located on the front side of the seat in relation to the body axis of the seated person seated on the vehicle seat S20. The seat cushion vibrator 221 will be described later.

The seat back 202 serves as a backrest portion that supports the back of the seated person. The seat back 202 has a configuration in which a pad material P202 is placed on a seat back frame F202 (see FIG. 26) which forms a framework of the seat back 202 and the pad material P202 is covered with the skin material T20.

A plurality of seat back vibrators 222 (vibrators 220) which are used as a notification means for the seated person are built in the seat back 202. More specifically, the seat back vibrator 222 is embedded in the recess formed in the pad material P202 and is covered with the slab P20s.

The seat back vibrator 222 is disposed behind the vehicle seat S20. More specifically, the seat back vibrator 222 is disposed on the rear side of the seat in relation to the rotation axis B20 of the rotation device 205 to be described later. Further, the seat back vibrator 222 is disposed on the rear side of the seat in relation to the body axis of the seated person seated on the vehicle seat S20. The seat back vibrator 222 will be described later.

The headrest 203 is attached to the upper portion of the seat back 202 to support the head of the seated person. Inside the headrest 203, a pad material P203 is placed on a headrest frame F203 which forms a framework of the headrest 203 and is fixed to the seat back frame F202 and is thinly covered with the skin material T20.

The rail device 204 is installed below the vehicle seat S20. In other words, the vehicle seat S20 is attached to the floor of the vehicle interior to be displaceable in the front to rear direction via the rail device 204.

The rail device 204 has a known structure (a structure of a general slide rail mechanism). Specifically, the rail device 204 includes a lower rail which is fixed to the floor and extends forward and backward in the vehicle V20, an upper rail which is slidable relative to the lower rail, and a motor which is a drive source. The rail device 204 corresponds to the movable mechanism capable of changing the position of the vehicle seat S20 in the front to rear direction of the vehicle V20.

The rotation device 205 is supported above the rail device 204. In other words, the vehicle seat S20 is attached to the floor of the vehicle interior to be rotatable around the rotation axis B20 extending in the vertical direction (up to down direction) via the rotation device 205.

The rotation device 205 has a known structure. Specifically, the rotation device 205 includes a base member that is fixed to the rail device 204 and a rotation member that is supported by the base member via a plurality of bearings and is rotatable around the rotation axis B20 extending in the up to down direction. The rotation member is fixed to the seat cushion frame F201. The rotation device 205 corresponds to the movable mechanism capable of changing the rotation position of the vehicle seat S20.

The reclining device 206 rotatably connects the seat back 202 to the seat cushion 201. More specifically, the reclining device 206 can change the posture of the seat body between an upright posture in which the seat back 202 stands up relative to the seat cushion 201 and a tilted posture in which the seat back 202 is tilted backward at a predetermined angle relative to the seat cushion 201. Further, the reclining device 206 can lock the seat back 202 to be inclined by a predetermined angle relative to the seat cushion 201. Then, the reclining device 206 can tilt the seat back 202 forward or backward by releasing the lock. The reclining device 206 corresponds to the movable mechanism capable of changing the posture of the seat body.

### Functional Configuration of Vehicle Seat S20

Next, the functional configuration of the vehicle seat S20 will be described.

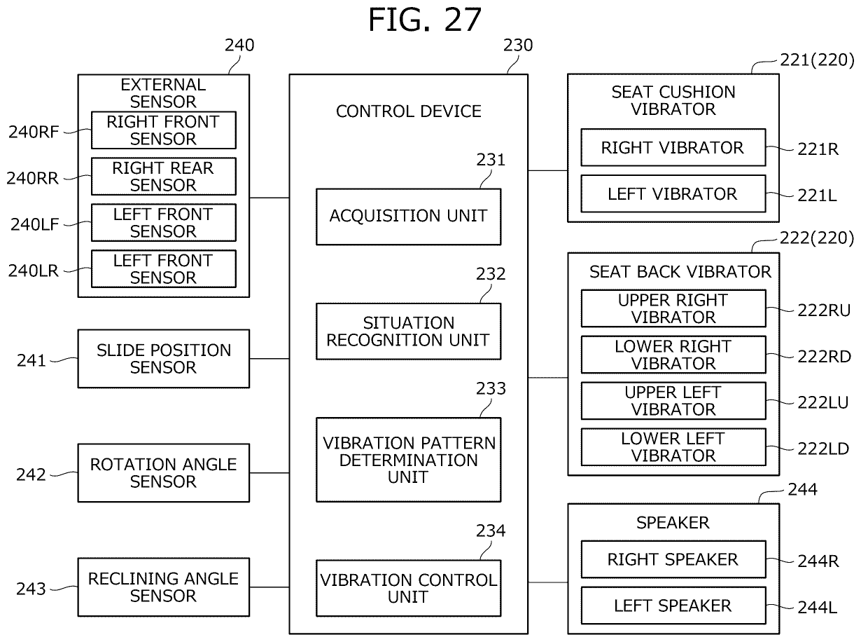

FIG. 27 shows the functional configurations of the vehicle seat S20, an external sensor 240 connected to a control device 230 of the vehicle seat S20, a slide position sensor 241, a rotation angle sensor 242, a reclining angle sensor 243, the vibrator 220, and a speaker 244. The control device 230 is built in the vehicle seat S20 and controls the entire vehicle seat S20.

The external sensor 240 is a sensor that detects the external situation, which is information about the surroundings of the vehicle V20. Specifically, the external sensor 240 may be configured by a lidar that measures the scattered light relative to the omnidirectional illumination light of the vehicle V20 to measure the distance of surrounding obstacles from the vehicle V20. Further, the external sensor 240 may be configured with a radar that detects other vehicles and obstacles around the vehicle V20 by emitting electromagnetic waves and detecting reflected waves. The external sensor 240 may further be configured as an optical sensor that captures images of the surroundings of the vehicle V20.

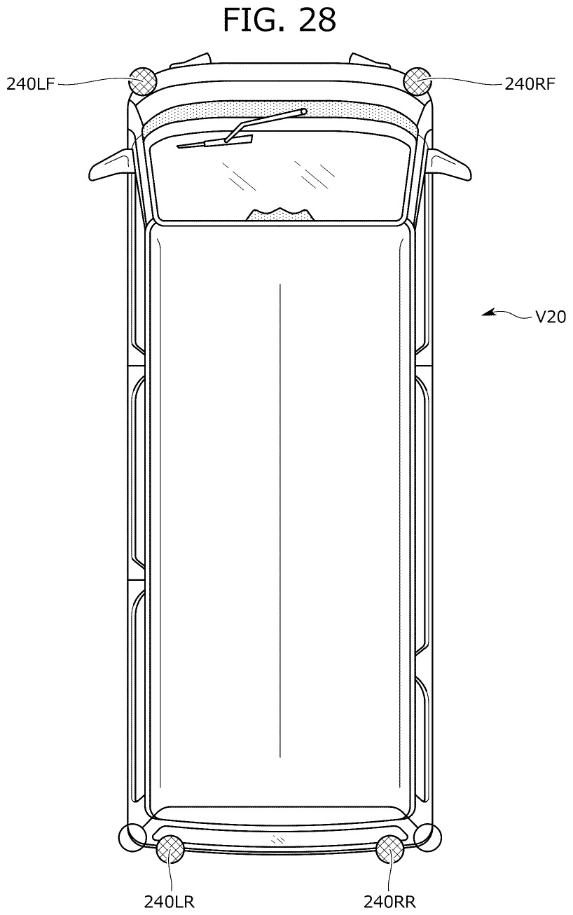

FIG. 28 schematically shows the attachment position of the external sensor 240 with respect to the vehicle V20. As shown in FIGS. 27 and 28, the external sensor 240 includes a right front sensor 240RF, a right rear sensor 240RR, a left front sensor 240LF, and a left rear sensor 240LR. However, the number and arrangement of sensors are not limited to the number and arrangement shown in FIG. 28. For example, sensors may be additionally arranged at the positions shown by white circles in FIG. 28.

The right front sensor 240RF is disposed on the right front of the vehicle V20 and detects the situation in front of and to the right of the vehicle V20.

The right rear sensor 240RR is disposed on the right rear of the vehicle V20 and detects the situation behind and to the right of the vehicle V20.

The left front sensor 240LF is disposed on the left front of the vehicle V20 and detects the situation in front and to the left of the vehicle V20.

The left rear sensor 240LR is disposed on the left rear of the vehicle V20 and detects the situation behind and to the left of the vehicle V20.

The slide position sensor 241 is a sensor that detects the position of the vehicle seat S20 in the front to rear direction of the vehicle V20. The slide position sensor 241 is an encoder provided on an output shaft of a motor that is the drive source of the rail device 204, but the present invention is not limited thereto. The slide position sensor 241 can be a radar-type position detection means that transmits and receives microwaves or a position detection means that obtains the position of the vehicle seat S20 by performing image recognition processing on an image captured by an in-vehicle camera.

The rotation angle sensor 242 is a sensor that detects the rotation position of the vehicle seat S20 around the rotation axis B20 extending in the vertical direction. The rotation angle sensor 242 is a limit switch whose contacts are connected when the vehicle seat S20 is rotated by a certain angle or more, but the present invention is not limited thereto. The rotation angle sensor 242 may be an optical sensor consisting of a light-emitting diode and a photodiode, or a position detection means using an in-vehicle camera.

The reclining angle sensor 243 is a sensor that detects the posture of the vehicle seat S20. More specifically, the reclining angle sensor 243 acquires the tilt angle of the seat back 202 relative to the seat cushion 201. The reclining angle sensor 243 is an encoder that is provided in the output shaft of the motor of the reclining device 206, but the present invention is not limited thereto. The reclining angle sensor 243 may be a posture detection means that detects the posture of the vehicle seat S20 by using an image captured by an in-vehicle camera.

The vibrator 220 is an eccentric motor including a motor and an eccentric weight fixed to the output shaft of the motor, but the present invention is not limited thereto. The vibrator 220 may be a linear resonant actuator mainly composed of a magnet and a winding. The vibrator 220 functions as a notification means by stimulating the seated person through a vibration. The vibration pattern of the vibrator 220 will be described later.

The vibrator 220 includes the seat cushion vibrator 221 built in the seat cushion 201 and the seat back vibrator 222 built in the seat back 202, but the present invention is not limited thereto. The vibrator 220 may be built in the headrest 203.

The seat cushion vibrators 221 are arranged at intervals in the seat width direction. Specifically, the seat cushion vibrator 221 includes a right vibrator 221R which is disposed on the right side of the seat and a left vibrator 221L which is disposed on the left side of the seat.

The seat back vibrators 222 are arranged at intervals in the front to rear direction of the seat and the seat width direction. Specifically, the seat back vibrator 222 includes an upper right vibrator 222RU which is disposed at the upper right of the seat, a lower right vibrator 222RD which is disposed at the lower right of the seat, an upper left vibrator 222LU which is disposed at the upper left of the seat, and a lower left vibrator 222LD which is disposed at the lower left of the seat.

The speaker 244 is provided in the headrest 203. In other words, the headrest 203 includes a plurality of speakers 244 having a right speaker 244R disposed on the right side of the seat and a left speaker 244L disposed on the left side of the seat. The speaker 244 can emit warning sounds and voice messages in addition to music. The speaker 244 corresponds to the audio output device.

The control device 230 is an ECU (Electronic Control Unit) installed in the vehicle seat S20. The control device 230 includes a processor that executes a program, a non-volatile storage medium, and a volatile storage medium. Then, the processor executes the programs stored in the non-volatile storage medium to function as an acquisition unit 231, a situation recognition unit 232, a vibration pattern determination unit 233, and a vibration control unit 234.

The acquisition unit 231 includes a communication interface and acquires an external signal output by the external sensor 240 and signals related to the position and posture of the vehicle seat S20 output by the slide position sensor 241, the rotation angle sensor 242, and the reclining angle sensor 243. Further, the acquisition unit 231 can acquire information (such as the traveling speed) related to the traveling state of the vehicle V20 via the communication interface.

The situation recognition unit 232 detects obstacles around the vehicle V20 based on an external signal output by the external sensor 240. Further, the situation recognition unit 232 determines the type of the detected obstacle (for example, a pedestrian or another vehicle) based on the characteristics of the obstacle. Next, the situation recognition unit 232 calculates the probability of collision between the detected object and the vehicle V20. The collision probability is calculated by taking into account the approach speed of the object to the vehicle V20. The situation recognition unit 232 may determine the type of collision (front collision, rear collision, side collision) between the vehicle V20 and an object, and calculate the collision probability in the case of a specific collision (for example, a side collision). The situation recognition unit 232 determines the presence of an approaching object by comparing the calculated collision probability with a predetermined threshold value, and outputs the determination result and the approaching direction of an approaching object to the vibration pattern determination unit 233 as a situation recognition result.

Further, the situation recognition unit 232 calculates the starting probability that another vehicle (preceding vehicle) detected in a position ahead of the vehicle V20 has started moving while the vehicle V20 is stopped. The calculation of the starting probability is performed by taking into consideration the traveling speed of the vehicle V20 and the separation speed of the preceding vehicle. The situation recognition unit 232 determines the fact that the preceding vehicle has started moving by comparing the calculated starting probability with a predetermined threshold value, and outputs the determination result to the vibration pattern determination unit 233 as a situation recognition result.

The vibration pattern determination unit 233 determines the vibration pattern of the vibrator 220 based on the situation recognition result of the situation recognition unit 232 and the position and posture of the vehicle seat S20. More specifically, the vibration pattern determination unit 233 determines a vibration pattern by selecting one vibration pattern from a plurality of vibration patterns prepared in advance when it is necessary to notify the seated person by the vibrator 220. The vibration pattern corresponds to the vibration notification pattern.

The vibration pattern is information that specifies the vibration order and vibration parameters of at least one of the vibrators 220 built in the seat cushion 201 and the seat back 202. Here, the vibration parameters include information regarding the vibration strength (vibration frequency) and vibration time of the vibrator 220. Further, the vibration parameters may include information regarding the vibration period and vibration rhythm when the vibrator 220 is repeatedly vibrated. The vibration patterns are stored in a vibration pattern table stored in the non-volatile memory of the control device 230.

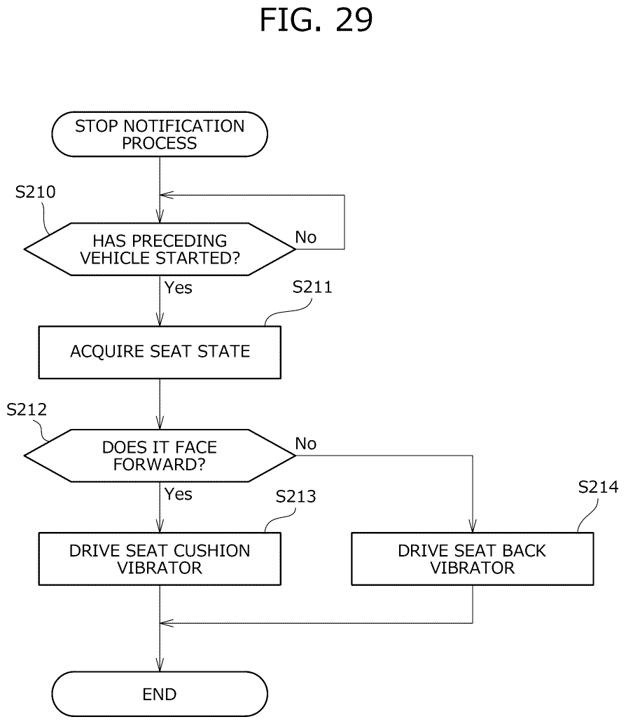

A method of selecting the vibration pattern by the vibration pattern determination unit 233 will be described below with reference to FIGS. 29 to 36.

The vibration control unit 234 controls the vibration of the vibrator 220 based on the vibration pattern determined by the vibration pattern determination unit 233. In other words, the vibration control unit 234 controls at least one vibrator 220 of the plurality of seat back vibrators 222 and the plurality of seat cushion vibrators 221 to be vibrated based on the determined vibration pattern.

### Flow of Vibration Notification Process

Next, the flow of the vibration notification process performed by the control device 230 will be described. The vibration notification process is performed to alert the occupant depending on the traveling state of the vehicle V20 and the external situation. Specifically, the control device 230 can perform a stop notification process, a traveling notification process, a start notification process, and a reverse travel notification process according to the travel state of the vehicle V20.

First, the stop notification process which is performed by the control device 230 during the stop of the vehicle V20 will be described. FIG. 29 shows the flow of the stop notification process performed by the control device 230. First, the control device 230 determines whether or not another vehicle (preceding vehicle) detected ahead of the vehicle V20 has started moving (step S210). More specifically, the control device 230 determines whether or not the preceding vehicle has started moving based on the situation recognition result output by the situation recognition unit 232.

If it is not determined that the preceding vehicle has started moving (step S210: No), the control device 230 waits.

On the other hand, if it is determined that the preceding vehicle has started moving (step S210: Yes), the control device 230 acquires a signal related to the state of the vehicle seat S20 (step S211). More specifically, the control device 230 acquires signals related to the position and posture of the vehicle seat S20 from the slide position sensor 241, the rotation angle sensor 242, and the reclining angle sensor 243.

Next, the control device 230 determines whether or not the vehicle seat S20 is in a rotation position that faces forward (step S212). Specifically, the control device 230 determines whether or not the vehicle seat S20 is in a rotation position that faces the front side of the vehicle V20 by comparing the rotation angle signal output by the rotation angle sensor 242 with a predetermined value.

If it is determined that the vehicle seat S20 is in a rotation position that faces forward (step S212: Yes), the control device 230 controls the seat cushion vibrator 221 to be vibrated (step S213). Specifically, when the control device 230 selects a vibration pattern of vibrating the seat cushion vibrator 221, the seat cushion vibrator 221 is vibrated.

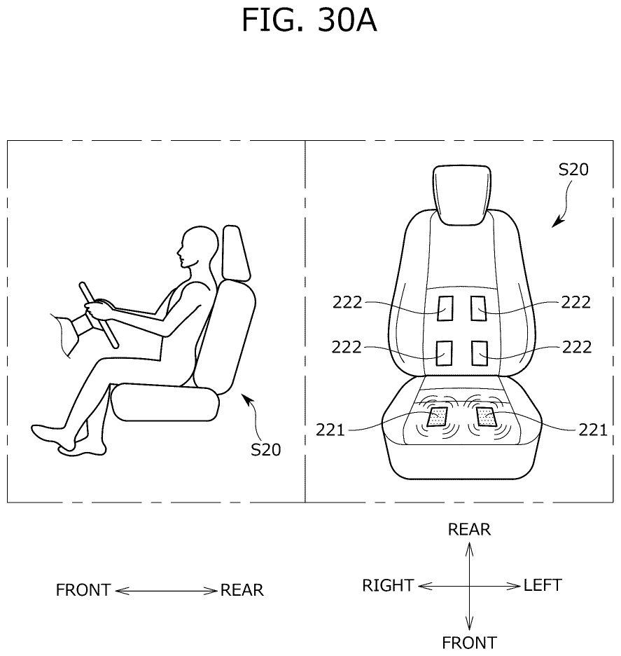

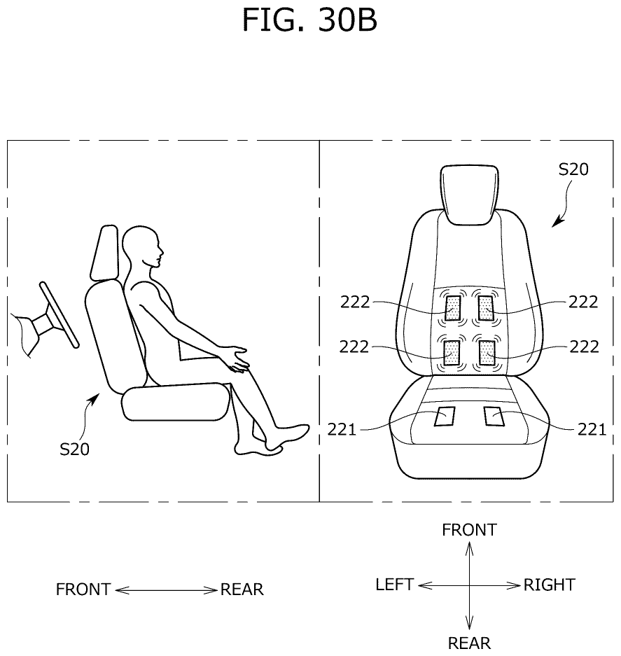

FIG. 30A shows a state in which the control device 230 performs the stop notification process to vibrate the seat cushion vibrator 221. As shown in FIG. 30A, when the vehicle seat S20 is in a rotation position that faces the front side of the vehicle V20, the control device 230 vibrates the seat cushion vibrator 221 to notify the seated person that the preceding vehicle has started moving. In other words, the control device 230 vibrates the vibrator 220 disposed on the front side of the seat in relation to the rotation axis B20 of the rotation device 205 of the vehicle seat S20. Here, the seat cushion vibrator 221 is vibrated on the front side of the seat in relation to the body axis of the seated person. Accordingly, the seated person's attention can be directed toward the front side of the seat, and the seated person can be encouraged to start the vehicle V20 by following the preceding vehicle.

On the other hand, if it is not determined that the vehicle seat S20 is in a rotation position that faces forward (step S212: No), the control device 230 controls the seat back vibrator 222 to be vibrated (step S214). Specifically, when the control device 230 selects a vibration pattern of vibrating the seat back vibrator 222, the seat back vibrator 222 is vibrated. In other words, when the vehicle seat S20 is in a rotation position that faces the rear side of the vehicle V20, the control device 230 selects a vibration pattern of vibrating the vibrator 220 located on the opposite side around the rotation axis B20 of the rotation device 205 relative to the vibrator 220 vibrated at the rotation position that faces forward. Here, the “vibrator 220 located on the opposite side around the rotation axis B20” is not limited to the vibrator 220 located exactly on the opposite side around the rotation axis B20 of the rotation device 205, but includes the vibrator 220 located on the opposite direction around the rotation axis B20 of the rotation device 205. The rotation position in which the vehicle seat S20 faces the front side of the vehicle V20 corresponds to the first rotation position, and the rotation position in which the vehicle seat S20 faces the rear side of the vehicle V20 corresponds to the second rotation position. Further, the vibration pattern selected at the rotation position in which the vehicle seat S20 faces the front side of the vehicle V20 corresponds to the first vibration notification pattern, and the vibration pattern selected at the rotation position in which the vehicle seat S20 faces the rear side of the vehicle V20 corresponds to the second vibration notification pattern.

FIG. 30B shows the vehicle seat S20 in a state where the control device 230 performs the stop notification process to vibrate the seat back vibrator 222. As shown in FIG. 30B, when the vehicle seat S20 is in a rotation position that faces the rear side of the vehicle V20, the control device 230 vibrates the seat back vibrator 222 to notify the seated person that the preceding vehicle has started moving. In other words, the control device 230 vibrates the vibrator 220 disposed on the rear side of the seat in relation to the rotation axis B20 of the rotation device 205 of the vehicle seat S20. Here, the seat back vibrator 222 is vibrated at a position on the rear side of the seat in relation to the body axis of the seated person. Accordingly, the seated person's attention can be directed toward the rear side of the seat, and the seated person can be notified that the vehicle V20 will soon start moving toward the rear side of the seat by following the preceding vehicle.

When the vibration control of the vibrator 220 in step S213 and step S214 ends, the control device 230 ends the stop notification process. Furthermore, the control device 230 may measure the time that the vehicle V20 is stopped after the preceding vehicle transmits its signal, and vibrate the seat cushion vibrator 221 or the seat back vibrator 222 if the vehicle V20 remains stopped for a predetermined period of time or longer.

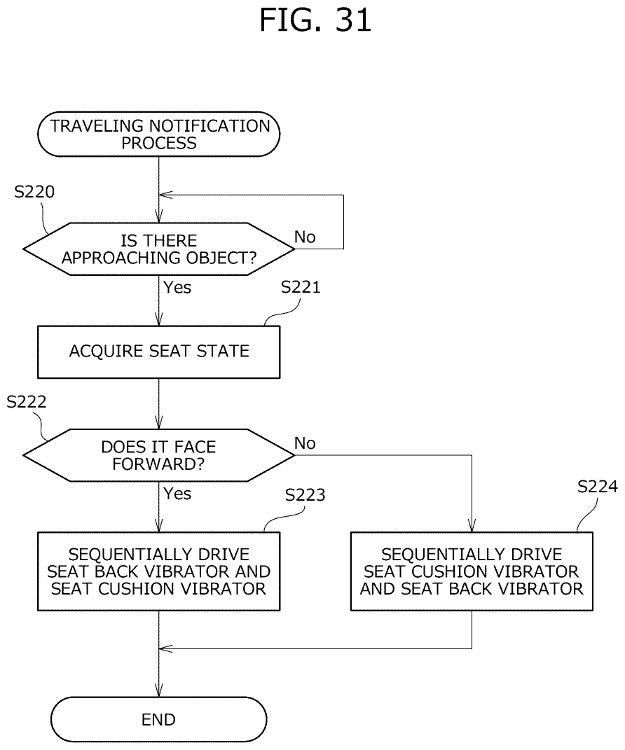

Next, the traveling notification process which is performed by the control device 230 during the traveling of the vehicle V20 will be described. FIG. 31 shows the flow of the traveling notification process performed by the control device 230. As shown in FIG. 31, the control device 230 first determines the presence and approaching direction of an approaching object (for example, another vehicle approaching from behind in the lane to which the vehicle V20 is changing lanes) (step S220). More specifically, the control device 230 determines the presence or absence and the approaching direction of an approaching object based on the situation recognition result output by the situation recognition unit 232.

If it is not determined that there is an approaching object (step S220: No), the control device 230 waits.

On the other hand, if it is determined that there is an approaching object (step S220: Yes), the control device 230 acquires information regarding the state of the vehicle seat S20 (step S221). More specifically, the control device 230 acquires signals related to the position and posture of the vehicle seat S20 from the slide position sensor 241, the rotation angle sensor 242, and the reclining angle sensor 243. Furthermore, in the following description, it is assumed that the approaching direction of an approaching object is to the right rear of the vehicle V20.

Next, the control device 230 determines whether or not the vehicle seat S20 is in a rotation position that faces forward (step S222). Specifically, the control device 230 determines whether or not the vehicle seat S20 faces the front side of the vehicle V20 by comparing the rotation angle signal output by the rotation angle sensor 242 with a predetermined value.

If it is determined that the vehicle seat S20 is in a rotation position that faces forward (step S222: Yes), the control device 230 controls the seat back vibrator 222 and the seat cushion vibrator 221 to be vibrated in this order (step S223). Specifically, the control device 230 selects a vibration pattern of vibrating the seat back vibrator 222 and the seat cushion vibrator 221 in this order. Accordingly, the seat back vibrator 222 and the seat cushion vibrator 221 are vibrated in this order.

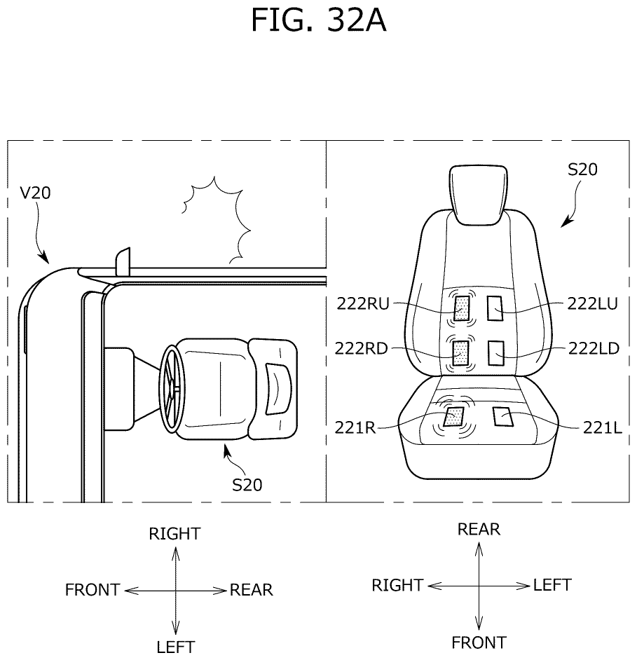

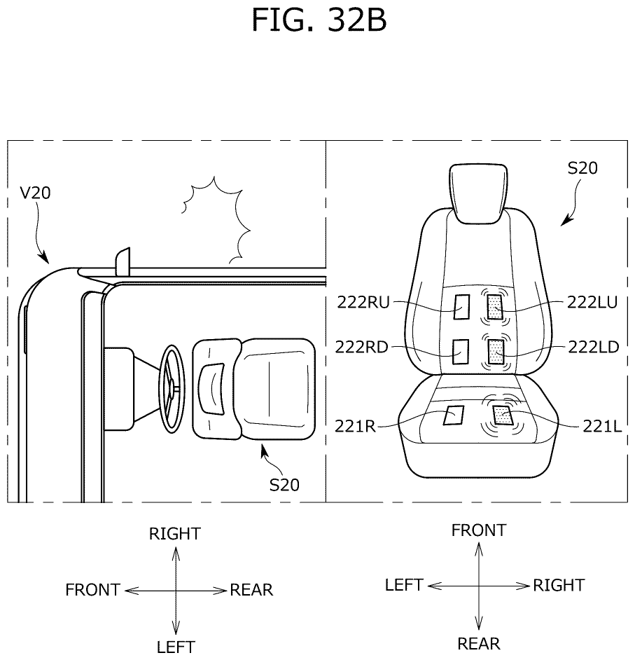

FIG. 32A shows a state in which the control device 230 performs the traveling notification process to vibrate the seat back vibrator 222 and the seat cushion vibrator 221 in this order. More specifically, this shows a state in which the vehicle V20 detects another vehicle (approaching object) approaching from the right rear when changing the driving lane to the right of the lane currently being driven. As shown in FIG. 32A, when the vehicle seat S20 is in a rotation position that faces the front side of the vehicle V20, the control device 230 first vibrates the upper right vibrator 222RU of the seat back vibrator 222 located on the rearmost side of the seat. Next, the control device 230 vibrates the lower right vibrator 222RD. Finally, the control device 230 vibrates the right vibrator 221R of the seat cushion vibrator 221 located on the front side 44 the seat to notify that another vehicle is approaching from the right rear of a vehicle V20. In other words, the control device 230 vibrates the vibrator 220 so that the vibration position is displaced in the front to rear direction of the seat from the vibrator 220 located to the right rear of the rotation axis B20 of the vehicle seat S20 to the vibrator 220 located to the right front. Accordingly, the seated person's attention can be gradually directed from the right rear of the seat to the right front of the seat, and the seated person can be alerted to another vehicle approaching from the right rear of the vehicle V20.

On the other hand, if it is not determined that the vehicle seat S20 is in a rotation position that faces forward (step S222: No), the control device 230 controls the seat cushion vibrator 221 and the seat back vibrator 222 to be vibrated in this order (step S224). Specifically, the control device 230 selects a vibration pattern of vibrating the seat cushion vibrator 221 and the seat back vibrator 222 in this order. Accordingly, the seat cushion vibrator 221 and the seat back vibrator 222 are vibrated in this order.

FIG. 32B shows a state in which the control device 230 performs the traveling notification process to vibrate the seat cushion vibrator 221 and the seat back vibrator 222 in this order. As shown in FIG. 32B, when the vehicle seat S20 is in a rotation position that faces the rear side of the vehicle V20, the control device 230 first vibrates the left vibrator 221L of the seat cushion vibrator 221 located on the frontmost side of the seat. Next, the control device 230 vibrates the lower left vibrator 222LD of the seat back vibrator 222. Finally, the control device 230 vibrates the upper left vibrator 222LU in this order to notify the seated person that another vehicle is approaching from the right rear of the vehicle V20. In other words, the control device 230 vibrates the vibrator 220 so that the vibration position is displaced in the front to rear direction of the seat from the vibrator 220 located at the right rear of the vehicle V20 relative to the rotation axis B20 of the vehicle seat S20 to the vibrator 220 located at the right front of the vehicle V20. Accordingly, the seated person's attention can be gradually directed from the front left of the seat to the rear left of the seat, and the seated person can be alerted to another vehicle approaching from the right rear of the vehicle V20.

When the driving control of the vibrator 220 in step S223 and step S224 ends, the control device 230 ends the traveling notification process.

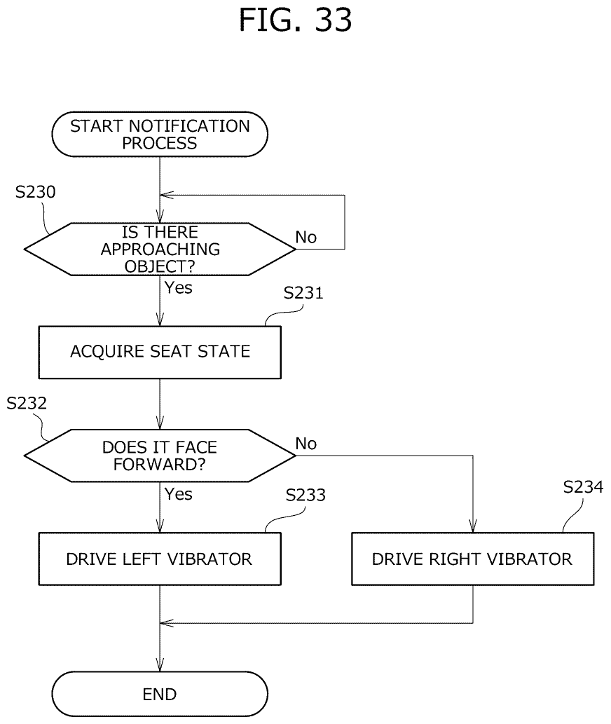

Next, the start notification process which is performed by the control device 230 when the start of the vehicle V20 starts will be described. FIG. 33 shows the flow of the start notification process performed by the control device 230. First, the control device 230 determines the presence and approaching direction of an approaching object (for example, another vehicle approaching from the left side of the vehicle V20 that has started moving) (step S230). More specifically, the control device 230 determines the presence or absence and the approaching direction of an approaching object based on the situation recognition result output by the situation recognition unit 232.

If it is not determined that there is an approaching object (step S230: No), the control device 230 waits.

On the other hand, if it is determined that there is an approaching object (step S230: Yes), the control device 230 acquires information regarding the state of the vehicle seat S20 (step S231). More specifically, the control device 230 acquires signals related to the position and posture of the vehicle seat S20 from the slide position sensor 241, the rotation angle sensor 242, and the reclining angle sensor 243. Furthermore, in the following description, it is assumed that the approaching direction of an approaching object is the left side of the vehicle V20.

Next, the control device 230 determines whether or not the vehicle seat S20 is in a rotation position that faces forward (step S232). Specifically, the control device 230 determines whether or not the vehicle seat S20 faces the front side of the vehicle V20 by comparing the rotation angle signal output by the rotation angle sensor 242 with a predetermined value.

If it is determined that the vehicle seat S20 is in a rotation position that faces forward (step S232: Yes), the control device 230 controls the vibrator 220 located on the left side of the vehicle seat S20 to be vibrated (step S233). Specifically, the control device 230 selects a vibration pattern of vibrating the left vibrator 221L of the seat cushion vibrator 221 and the upper left vibrator 222LU and the lower left vibrator 222LD of the seat back vibrator 222. Accordingly, the vibrator 220 located on the left side of the vehicle seat S20 is vibrated.

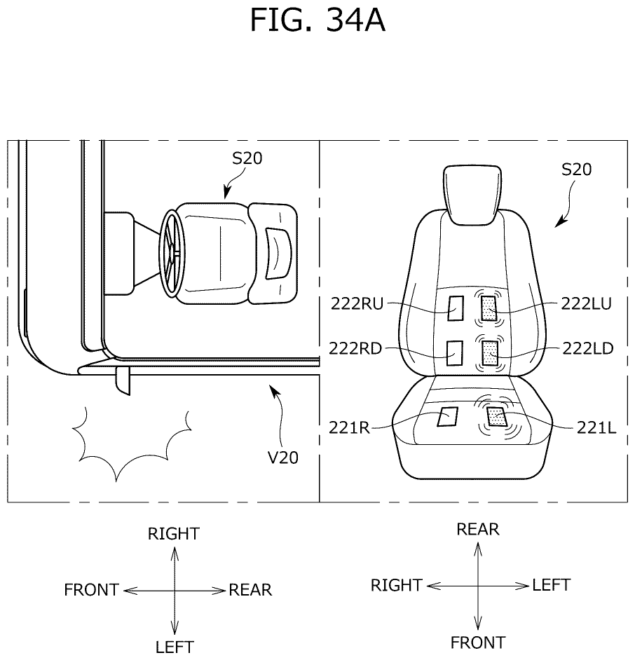

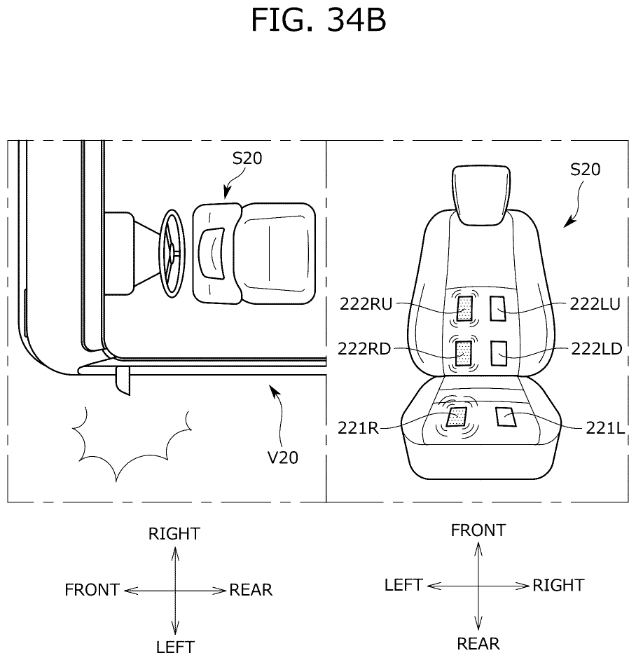

FIG. 34A shows a state in which the control device 230 performs the start notification process to vibrate the left vibrator 221L built in the seat cushion 201 and the upper left vibrator 222LU and the lower left vibrator 222LD built in the seat back 202. As shown in FIG. 34A, when the vehicle seat S20 is in a rotation position that faces the front side of the vehicle V20, the control device 230 vibrates the vibrator 220 located on the left side of the vehicle seat S20 to notify the seated person that another vehicle is approaching from the left side of the vehicle V20 when the vehicle starts moving. In other words, the control device 230 vibrates the vibrator 220 located on the left side of the seat in relation to the rotation axis B20 of the rotation device 205 of the vehicle seat S20. Accordingly, the seated person's attention can be directed toward the left side of the seat, and the seated person can be alerted to another vehicle approaching from the left side.

On the other hand, if it is not determined that the vehicle seat S20 is in a rotation position that faces forward (step S232: No), the control device 230 controls the vibrator 220 located on the right side of the vehicle seat S20 to be vibrated (step S234). Specifically, the control device 230 selects a vibration pattern of vibrating the right vibrator 221R built in the seat cushion 201 and the upper right vibrator 222RU and the lower right vibrator 222RD built in the seat back 202. Accordingly, the vibrator 220 located on the right side of the vehicle seat S20 is vibrated.

In other words, when the vehicle seat S20 is in a rotation position that faces backward, the control device 230 selects a vibration pattern of vibrating the vibrator 220 located on the opposite side around the rotation axis B20 of the rotation device 205 relative to the vibrator 220 vibrated when the vehicle seat S20 is in a rotation position that faces forward.

FIG. 34B shows a state in which the control device 230 performs the start notification process to vibrate the right vibrator 221R built in the seat cushion 201 and the upper right vibrator 222RU and the lower right vibrator 222RD built in the seat back 202. As shown in FIG. 34B, when the vehicle seat S20 is in a rotation position that faces backward, the control device 230 vibrates the vibrator 220 located on the right side of the vehicle seat S20 to notify the seated person that another vehicle is approaching from the left side of the vehicle V20 when the vehicle starts moving. In other words, the control device 230 vibrates the vibrator 220 located on the right side of the seat in relation to the rotation axis B20 of the rotation device 205 of the vehicle seat S20. Accordingly, the seated person's attention can be directed toward the right side of the seat, and the seated person can be alerted to another vehicle approaching from the right side.

When the driving control of the vibrator 220 in step S233 and step S234 ends, the control device 230 ends the start notification process.

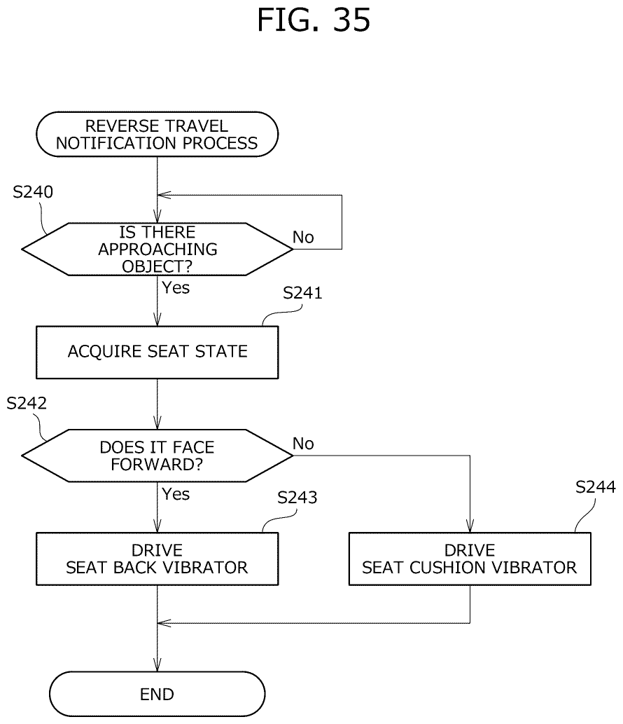

Next, the reverse travel notification process which is performed by the control device 230 when the vehicle V20 moves backward will be described. FIG. 35 shows the flow of the reverse travel notification process performed by the control device 230. As shown in FIG. 35, the control device 230 first determines the presence and approaching direction of an approaching object (for example, an obstacle present behind the vehicle V20 that has started moving backward) (step S240). More specifically, the control device 230 determines the presence or absence and the approaching direction of an approaching object based on the situation recognition result output by the situation recognition unit 232.

If it is not determined that there is an approaching object (step S240: No), the control device 230 waits.

On the other hand, if it is determined that there is an approaching object (step S240: Yes), the control device 230 acquires information regarding the state of the vehicle seat S20 (step S241). More specifically, the control device 230 acquires signals related to the position and posture of the vehicle seat S20 from the slide position sensor 241, the rotation angle sensor 242, and the reclining angle sensor 243. Furthermore, in the following description, it is assumed that the approaching direction of an approaching object is from behind the vehicle V20.

Next, the control device 230 determines whether or not the vehicle seat S20 is in a rotation position that faces forward (step S242). Specifically, the control device 230 determines whether or not the vehicle seat S20 faces the front side of the vehicle V20 by comparing the rotation angle signal output by the rotation angle sensor 242 with a predetermined value.

If it is determined that the vehicle seat S20 is in a rotation position that faces forward (step S242: Yes), the control device 230 controls the seat back vibrator 222 to be vibrated (step S243). Specifically, the control device 230 selects a vibration pattern of vibrating the seat back vibrator 222. Accordingly, the seat back vibrator 222 is vibrated.

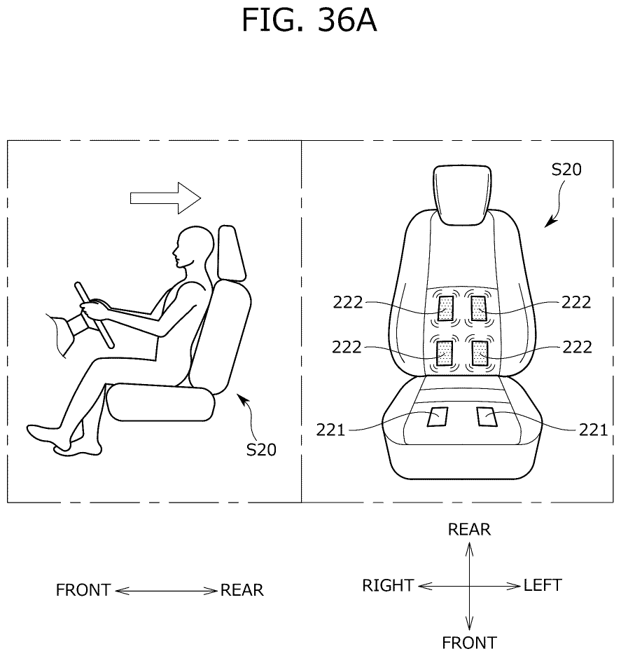

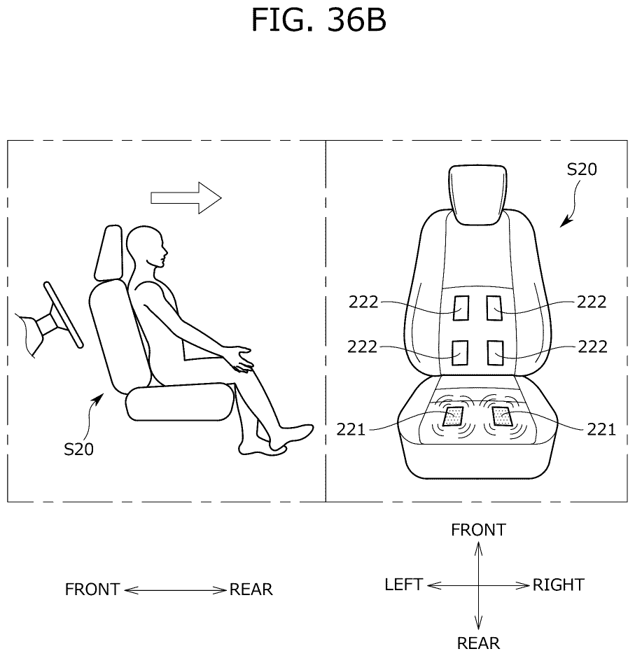

FIG. 36A shows a state in which the control device 230 performs the reverse travel notification process to vibrate the seat back vibrator 222. As shown in FIG. 36A, when the vehicle seat S20 is in a rotation position that faces the front side of the vehicle V20, the control device 230 vibrates the seat back vibrator 222 to notify the seated person of the presence of an approaching object approaching from the rear side the vehicle V20 while the vehicle is moving backward. In other words, the control device 230 vibrates the vibrator 220 disposed on the rear side of the seat in relation to the rotation axis B20 of the rotation device 205 of the vehicle seat S20. Further, the seat back vibrator 222 is vibrated at the position on the rear side of the seat in relation to the body axis of the seated person. Accordingly, the seated person's attention can be directed toward the rear side of the seat, and the seated person can be alerted to an approaching object approaching from behind.

On the other hand, if it is not determined that the vehicle seat S20 is in a rotation position that faces forward (step S242: No), the control device 230 controls the seat cushion vibrator 221 to be vibrated (step S244). Specifically, the control device 230 selects a vibration pattern of vibrating the seat cushion vibrator 221. Accordingly, the seat cushion vibrator 221 is vibrated.

FIG. 36B shows a state in which the control device 230 performs the reverse travel notification process to vibrate the seat cushion vibrator 221. As shown in FIG. 36B, when the vehicle seat S20 is in a rotation position that faces the rear side of the vehicle V20, the control device 230 vibrates the seat cushion vibrator 221 to notify the seated person of the presence of an approaching object approaching from behind. In other words, the control device 230 vibrates the vibrator 220 located on the rear side of the seat in relation to the rotation axis B20 of the rotation device 205 of the vehicle seat S20. Further, the seat cushion vibrator 221 is vibrated at the position on the front side of the seat in relation to the body axis of the seated person. Accordingly, the seated person's attention can be directed toward the front side of the seat, and the seated person can be alerted to an approaching object approaching from behind the vehicle V20.

When the driving control of the vibrator 220 in step S243 and step S244 ends, the control device 230 ends the reverse travel notification process.

### Modified Examples

Although the configuration of the vehicle seat S20 according to an embodiment of the present invention has been described above, the above-described embodiment is merely an example for making the present invention easier to understand, and is not intended to limit the present invention. In other words, the present invention can be modified or improved without departing from the spirit of the invention, and it goes without saying that the present invention includes equivalents thereof.

In the above-described embodiments, although it has been described that the vehicle seat S20 is changeable between the rotation position that faces the front side of the vehicle V20 and the rotation position that faces the rear side of the vehicle V20, the present invention is not limited thereto. The vehicle seat S20 may be rotated by 90° to a rotation position that faces the side (right or left side) of the vehicle V20. When the vehicle seat S20 is rotated by 90° in one rotation direction, the control device 230 selects a vibration pattern of vibrating the vibrator 220 located in a direction rotated by 90° in the other rotation direction relative to the vibration pattern selected when the vehicle seat S20 faces the front side of the vehicle V20. Specifically, for example, if it is determined that an approaching object is approaching from the left side of the vehicle V20, the control device 230 vibrates the seat back vibrator 222 when the vehicle seat S20 is in a rotation position that faces the right side of the vehicle V20. Further, when the vehicle seat S20 is in a rotation position that faces the left side of the vehicle V20, the control device 230 vibrates the seat cushion vibrator 221. Accordingly, when the vehicle seat S20 is in a rotation position that faces the side of the vehicle V20, it is possible to provide appropriate vibration notification using the vibrator 220. The rotation position in which the vehicle seat S20 faces the front side of the vehicle V20 corresponds to the first rotation position, and the rotation position in which the vehicle seat S20 faces the side of the vehicle V20 corresponds to the third rotation position. Further, the vibration pattern at the rotation position in which the vehicle seat S20 faces the front side of the vehicle V20 corresponds to the first vibration notification pattern, and the vibration pattern selected at the rotation position in which the vehicle seat S20 faces the side of the vehicle V20 corresponds to the third vibration notification pattern.

Further, the rotation positions of the vehicle seat S20 are not limited to the front, rear, and side. The vehicle seat S20 may be rotatable to positions of 45°, 90°, 135°, 180°, 225°, 270°, and 315° relative to the front side of the vehicle V20. Further, the seated person may be able to set his/her preferred rotation position. At this time, the control device 230 selects a vibration pattern of vibrating the vibrator 220 located at the same angle in the opposite rotation direction relative to the rotation axis B20 of the rotation device 205 when the vehicle seat S20 is rotated to a predetermined angle. Accordingly, when the vehicle seat S20 is in any rotation position, the vibrator 220 can provide an appropriate vibration notification.

### Second Modified Example

Further, in the above-described embodiments, although it has been described that the position of the vibrator 220 that vibrates is changed according to the rotation position of the vehicle seat S20, the present invention is not limited thereto. The vibration parameter of the vibrator 220 may be changed according to the rotation position of the vehicle seat S20. Specifically, when the vehicle seat S20 is in a rotation position that faces the rear side of the vehicle V20, a vibration pattern may be selected in which the vibration strength of the vibrator 220 is stronger (the vibration frequency is higher) than when the vehicle seat S20 is in a rotation position that faces the front side of the vehicle V20. Accordingly, even when it is difficult for the seated person to recognize the surrounding situation since the vehicle seat S20 faces the rear side of the vehicle V20, it is possible to strongly alert the seated person to the presence of an approaching object.

Further, the vibration time, vibration period, and vibration rhythm may be changed depending on the rotation position of the vehicle seat $20. By making the vibration parameters selectable in this way, it is possible to increase the variety of vibration notifications and to increase the amount of information provided by the vibration notifications.

### Third Modified Example

Further, the control device 230 may select a vibration pattern based on the position of the vehicle seat S20 in the front to rear direction of the vehicle V20 when the vehicle seat S20 moves forward and backward in the vehicle V20 by the rail device 204. Specifically, the control device 230 may select a vibration pattern in which the vibration strength of the vibrator 220 is increased when the vehicle seat S20 is in a state in which the vehicle seat is largely slid toward the rear side of the vehicle V20 by the rail device 204. Accordingly, even when it is difficult for the seated person to recognize the surrounding situation of the vehicle V20 since the vehicle seat S20 is located on the rear side of the vehicle V20, it is possible to strongly alert the seated person to the approach of an approaching object.

Further, the control device 230 may select a vibration pattern in which the vibration strength of the vibrator 220 is decreased (the vibration frequency is decreased) when the vehicle seat S20 is largely slid toward the rear side of the vehicle V20 by the rail device 204. Accordingly, when the vehicle seat S20 is located on the rear side of the vehicle V20 and the seated person is in a relaxed state, it is possible to suppress the seated person from feeling uncomfortable due to the vibration of the vibrator 220.

### Fourth Modified Example

Further, the control device 230 may select a vibration pattern based on the posture of the vehicle seat S20, that is, the tilt angle of the seat back 202 relative to the seat cushion 201. Specifically, the control device 230 may select a vibration pattern in which the vibration strength of the vibrator 220 is increased when the seat back 202 is largely tilted toward the rear side of the vehicle seat S20 by the reclining device 206. Accordingly, even when it is difficult for the seated person to recognize the surrounding situation of the vehicle V20 since the seat back 202 is tilted backward, it is possible to strongly alert the seated person to the approach of an approaching object.

Further, the control device 230 may select a vibration pattern in which the vibration strength of the vibrator 220 is decreased when the seat back 202 is largely tilted toward the rear side of the vehicle seat S20. Accordingly, when the seat back 202 is tilted toward the rear side of the vehicle V20 and the seated person is in a relaxed state, it is possible to suppress the seated person from feeling uncomfortable due to the vibration of the vibrator 220.

### Fifth Modified Example

Further, the control device 230 may change the speaker 244 that outputs an audio signal according to the rotation position of the vehicle seat S20. Specifically, if it is determined that an approaching object is approaching from the right side of the vehicle V20, a warning sound is output from the right speaker 244R when the vehicle seat S20 is in a rotation position that faces the front side of the vehicle V20. On the other hand, when the vehicle seat S20 is in a rotation position that faces the rear side of the vehicle V20, a warning sound is output from the left speaker 244L. In other words, the control device 230 outputs a warning sound from the speaker 244 that is located in the approaching direction of an approaching object as viewed from the seated person and that is located in the same direction as the vibrator 220 that is driven and controlled to be vibrated. By using the right speaker 244R and the left speaker 244L in combination with vibration notification of the vibrator 220 in this way, it is possible to more effectively call attention to an approaching object.

### Second Example

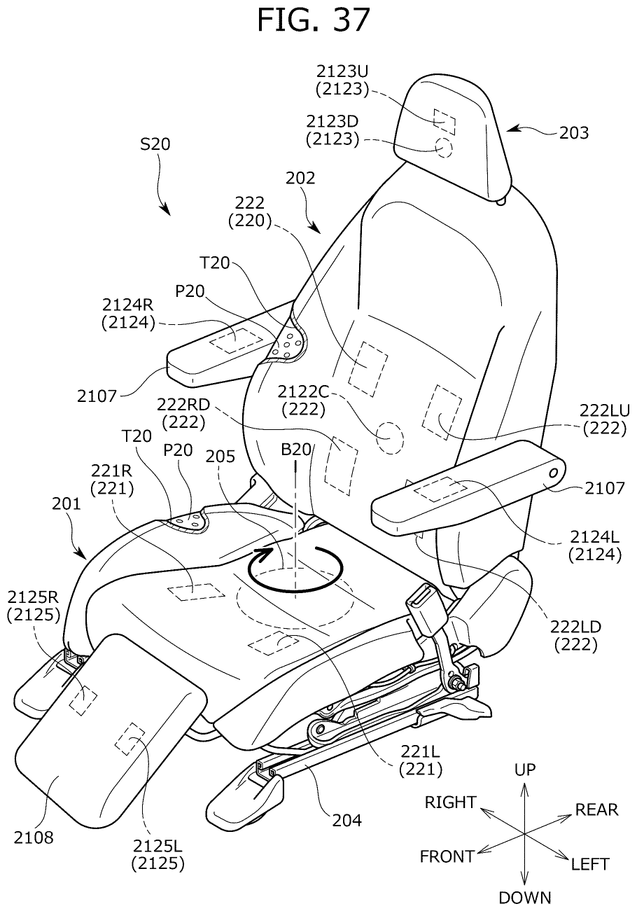

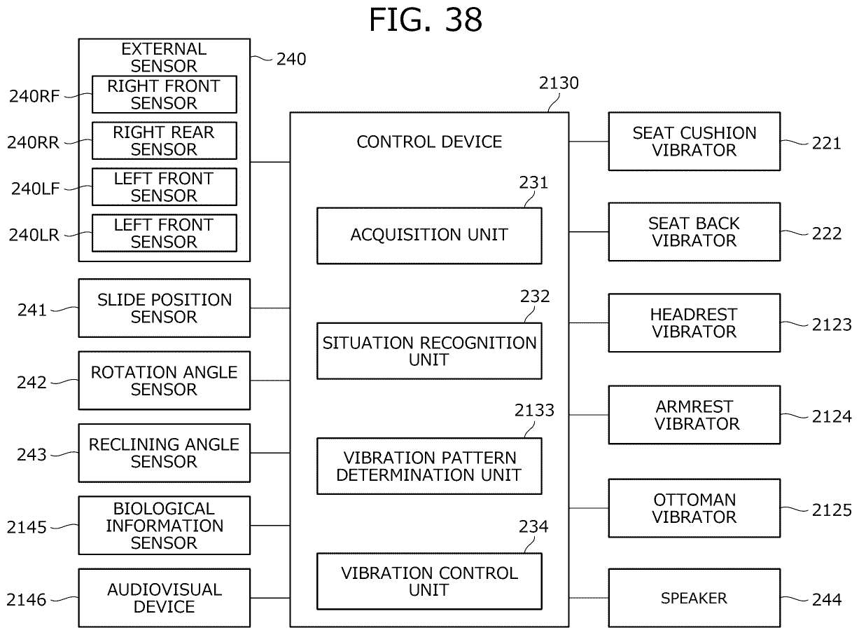

Hereinafter, the vehicle seat S20 according to a second example of the second embodiment will be described with reference to FIGS. 37 and 38. The vehicle seat S20 according to the second example mainly includes the seat cushion 201, the seat back 202, the headrest 203, an armrest 2107, and an ottoman 2108. Hereinafter, the components having the same shape and structure as those in the above-described embodiment are denoted by the same reference numerals and the description thereof is omitted, and differences between the components having different shapes and structures are clarified.

The seat back vibrator 222 which is used as a notification means for the seated person is built in the seat back 202. The seat back vibrator 222 mainly includes the upper right vibrator 222RU, the lower right vibrator 222RD, the upper left vibrator 222LU, the lower left vibrator 222LD, and a center vibrator 2122C. The upper right vibrator 222RU, the lower right vibrator 222RD, the upper left vibrator 222LU, and the lower left vibrator 222LD are eccentric motors. The eccentric motor generates small vibrations when rotating at a high frequency.

On the other hand, the center vibrator 2122C are piezoelectric vibrators. The piezoelectric vibrators generate gentle vibrations by vibrating linearly at relatively low frequency.

By incorporating a plurality of types of vibrators 220 in the seat back 202 in this way, it is possible to improve the variety of vibration notifications. To explain this with a specific example, the eccentric motor can be vibrated to notify the approach of an obstacle from the outside, while the piezoelectric vibrator can provide guidance information output by a navigation device installed in the vehicle V20 or a notification corresponding to music output by an audiovisual device 2146. More specifically, a control device 2130 to be described later converts the guidance information output by the navigation device into a coded signal (Morse code) using long and short dots, and vibrates the signal via a piezoelectric vibrator. Accordingly, it is possible to convey guidance information to the seated person having difficulty in recognizing information visually or aurally. Further, the control device 2130 vibrates the piezoelectric vibrator in synchronization with the timing at which the music output from the audiovisual device 2146 outputs low-pitched sounds. Accordingly, the seated person can feel the realism of the music output by the audiovisual device. Furthermore, the seat back vibrator 222 is not limited to a combination of the eccentric motor and the piezoelectric vibrator. The seat back vibrator 222 may be combined with a linear resonant actuator that is mainly composed of a magnet and a winding.

A headrest vibrator 2123 which is used as a notification means is built in the headrest 203. The headrest vibrator 2123 mainly includes an upper vibrator 2123U and a lower vibrator 2123D. The upper vibrator 2123U is an eccentric motor. On the other hand, the lower vibrator 2123D is a piezoelectric vibrator, but the present invention is not limited thereto. The lower vibrator 2123D may be a linear resonant actuator.

An armrest vibrator 2124 which is used as a notification means is built in the armrest 2107. The armrest vibrator 2124 mainly includes a right vibrator 2124R and a left vibrator 2124L. The right vibrator 2124R and the left vibrator 2124L are eccentric motors, but the present invention is not limited thereto. The right vibrator 2124R and the left vibrator 2124L may be piezoelectric vibrators or linear resonant actuators. The armrest vibrator 2124 corresponds to the arm vibrator.

An ottoman vibrator 2125 which is used as a notification means is built in the ottoman 2108. The ottoman vibrator 2125 mainly includes a right vibrator 2125R and a left vibrator 2125L. The right vibrator 2125R and the left vibrator 2125L are eccentric motors, but the present invention is not limited thereto. The right vibrator 2125R and the left vibrator 2125L may be piezoelectric vibrators or linear resonant actuators. The ottoman vibrator 2125 corresponds to the leg vibrator.

Since the seat cushion 201 is the same as the above-described embodiment, a detailed description thereof will be omitted.

Next, the functional configuration of the vehicle seat S20 according to the second example will be described. FIG. 38 shows the functional configuration of the vehicle seat S20. As shown in FIG. 38, the external sensor 240, the slide position sensor 241, the rotation angle sensor 242, the reclining angle sensor 243, a biological information sensor 2145, the audiovisual device 2146, the seat cushion vibrator 221, the seat back vibrator 222, the headrest vibrator 2123, the armrest vibrator 2124, the ottoman vibrator 2125, and the speaker 244 are connected to the control device 2130 that controls the vehicle seat S20.

Since the external sensor 240, the slide position sensor 241, the rotation angle sensor 242, the reclining angle sensor 243, and the speaker 244 have the same configurations as those of the above-described embodiment, a detailed description thereof will be omitted.

The biological information sensor 2145 is a detection means capable of acquiring biological information of the seated person. Specifically, the biological information sensor 2145 is an acceleration sensor that detects the heartbeat and breathing of the seated person, thereby measuring the heart rate and breathing rate of the seated person. Further, the biological information sensor 2145 may be a temperature sensor capable of measuring the body temperature of the seated person. In this way, the biological information of the seated person is acquired and monitored by the biological information sensor 2145, and if an abnormality is detected, a warning signal can be output according to a predetermined rule.

The biological information sensor 2145 is built in the seat cushion 201, but the present invention is not limited thereto. The biological information sensor 2145 may be built in the seat back 202.

The audiovisual device 2146 is an electronic device capable of playing and outputting music and video. The audiovisual device 2146 includes an audio output device and a display device, and outputs audio signals such as music from the audio output device and displays video signals such as videos on the display device by playing information recorded on a recording medium.

The audiovisual device 2146 may be an electronic device that is integrated with a navigation device installed in the vehicle V20 or may be configured separately. Further, the audiovisual device 2146 may be a portable terminal that can be carried by the seated person.

The seat cushion vibrator 221, the seat back vibrator 222, the headrest vibrator 2123, the armrest vibrator 2124, and the ottoman vibrator 2125 are vibration notification means consisting of an eccentric motor and a piezoelectric vibrator as described with reference to FIG. 37.

A vibration pattern determination unit 2133 according to the second embodiment selects a vibration pattern of vibrating at least one of the plurality of armrest vibrators 2124 in a predetermined order and a predetermined vibration parameter based on the position and posture of the seat body. Specifically, for example, when it is determined that an approaching object is approaching from the left side of the vehicle V20 and the vehicle seat S20 is in a rotation position that faces the front side of the vehicle V20, the control device 2130 vibrates the left vibrator 2124L of the armrest vibrator 2124. Further, when the vehicle seat S20 is in a rotation position that faces the rear side of the vehicle V20, the control device 2130 vibrates the right vibrator 2124R of the armrest vibrator 2124. Accordingly, regardless of the rotation position of the seat body, the seated person's attention can be directed toward the left side of the vehicle V20, and the seated person can be alerted to an approaching object approaching from the left side of the vehicle V20.

Further, the vibration pattern determination unit 2133 according to the second example selects a vibration pattern of vibrating at least one of the plurality of ottoman vibrators 2125 in a predetermined order and a predetermined vibration parameter based on the position and posture of the seat body. Specifically, for example, when it is determined that an approaching object is approaching from the right side of the vehicle V20 and the vehicle seat S20 is in a rotation position that faces the front side of the vehicle V20, the control device 2130 vibrates, the right vibrator 2125R of the right vibrator 2125R and the left vibrator 2125L. Further, when the vehicle seat S20 is in a rotation position that faces the rear side of the vehicle V20, the control device 2130 vibrates the left vibrator 2125L. Accordingly, regardless of the rotation position of the seat body, the seated person's attention can be directed toward the right side of the vehicle V20, and the seated person can be alerted to an approaching object approaching from the right side.

Further, each control device 2130 of the plurality of vehicle seats S20 installed in the vehicle V20 may receive an input of setting information by an occupant and perform specific vibration notification based on the input setting information. To explain this with a specific example, it is assumed that the vehicle V20 has a plurality of occupants with different destinations. The control device 2130 built in each vehicle seat S20 receives an input of the destination from each occupant. The control device 2130 acquires the position information of the vehicle V20 from a navigation device configured integrally with the audiovisual device 2146, and determines whether or not the vehicle V20 has arrived within a predetermined distance from the destination of the seated person. When it is determined that the vehicle V20 has arrived within a predetermined distance from the destination of the seated person, the control device 2130 performs vibration notification to the seated person. Accordingly, it is possible to prevent unnecessary vibration notification from being given to other seated persons.

Further, when the control device 2130 receives complaint from an occupant of the vehicle V20 about other occupants, the control device 2130 may perform vibration notification to notify the other occupants of the complaint. The control devices 2130 built in each vehicle seat S20 are communicatively connected to each other and are configured to be able to anonymously notify information related to a complaint. In this way, the fact that there has been a complaint from another occupant can be notified by using the vibrator 220. Therefore, the seated person can deal with the complaint without being noticed by the other occupants.

Further, the control device 2130 may acquire occupant biological information output by the biological information sensor 2145 built in the vehicle seat S20, and may issue vibration notification to notify only a predetermined person of an abnormality in the biological information based on the biological information.

Further, the control device 2130 may determine whether or not vibration notification is required for each occupant based on previously input setting information. In other words, the control device 2130 may store previously input setting information as setting history information, and generate a determination condition for determining whether or not vibration notification is required based on the setting history information.

### Other Modified Examples

In the above-described examples, although it has been described that the control device 230 is built in the vehicle seat S20, the present invention is not limited thereto. The control device 230 may be provided in the vehicle V20 and communicatively connected to electrical components built in the vehicle seat S20 to control the vehicle seat S20.

Further, in the above-described examples, although the control device 230 performing vibration notification using the vibrator 220 has been described, notification may be performed in combination with notification means other than the vibrator 220. As a specific example, the control device 230 may transmit a notification signal to a portable terminal of an occupant, and may combine the vibration notification by the vibrator 220 with the notification by the portable terminal. More specifically, the control device 230 notifies the mobile terminal of the detailed information together with the vibration notification by the vibrator 220. Similarly, the control device 230 may transmit detailed information to the display device D20 provided in the vehicle V20, and may combine notification be provided by the display device D20.

Further, when the vibration pattern is changed due to a change in the position or posture of the seat body, the control device 230 may transmit the change in the vibration pattern to the occupant's mobile terminal or the display device D20. By using the occupant's mobile terminal or display device D20, it is possible to employ a variety of notification means, such as voice, text or images, and lighting.

Further, when the control device 230 is not able to change the vibration pattern due to an abnormality in the device or the like, the control device may transmit a message to that effect to the occupant's mobile terminal or the display device D20.

### Third Embodiment

Hereinafter, a third embodiment of the present invention will be described.

### Technical Field

The third embodiment relates to a conveyance seat and particularly to a conveyance seat with a vibrator.

### Background Art

Conventionally, a technology is known in which a vibrator is disposed on a seat back or a seat cushion of a vehicle seat (for example, see JP-A-2000-225877). By vibrating the vibrator based on a signal obtained from a sensor or the like, it is possible to notify the occupants of, for example, the approach of another vehicle, an obstacle, or the like.

### SUMMARY OF INVENTION

### Technical Problem

However, in the past, there was no sufficient consideration for arranging a vibrator at an appropriate position in the seat back or seat cushion, and there was a demand for arranging the vibrator at an optimal position for the seated person. For example, optimization based on the positional relationship with functional components such as sensors and heaters was required.

Further, as another problem, there was a need for a way to more appropriately transmit the vibration from the vibrator to the seated person.

The present invention has been made in view of the above-described problems, and an object of the present invention is to provide a conveyance seat having a vibrator disposed at a more appropriate position.

### Solution to Problem

According to the conveyance seat of the present invention, the above-described problems are solved by a conveyance seat with a pad member including: a functional component which is provided in the pad member and at least one vibrator which is provided in the pad member and generates a vibration, in which the vibrator is disposed at a position in which at least a part thereof does not overlap with the functional component when the pad member is viewed from the seating surface.

According to the conveyance seat of the present invention with the above-described configuration, since a part of the vibrator is disposed at a position in which a part of them do not overlap with the functional component when viewed from the seating surface, the deterioration of performance of the functional component is suppressed. Therefore, it is possible to provide the conveyance seat in which the vibrator is disposed at a more appropriate position.

Further, in the above-described configuration, the functional component may be a sensor device including a sensor unit which detects a state of an occupant, a harness, and a connection portion which connects the sensor unit and the harness, and the vibrator may be disposed at a position that avoids at least a part of the sensor device.

Since the vibrator is disposed at a position that avoids at least a part of the sensor device, the deterioration of sensor performance of the sensor device can be suppressed.

Further, in the above-described configuration, the vibrator may be disposed at a position that avoids the sensor unit of the sensor device.

Since the vibrator is disposed at a position that avoids the sensor unit, the deterioration of sensor performance of the sensor device can be suppressed.

Further, in the above-described configuration, the vibrator may be disposed at a position that avoids the connection portion of the sensor device.

Since the vibrator is disposed at a position that avoids the connection portion, the deterioration of electrical performance can be suppressed.

Further, in the above-described configuration, the vibrator may be disposed at a position that avoids the harness of the sensor device.

Since the vibrator is disposed at a position that avoids the harness, the deterioration of electrical performance can be suppressed.

Further, in the above-described configuration, the vibrator may be disposed at a position that avoids the entire sensor device.

Since the vibrator is disposed at a position that avoids the entire sensor device, the deterioration of sensor performance and electrical performance can be suppressed.

Further, in the above-described configuration, the functional component may be a heater device which includes a heater wire portion heating the seating surface and a base fabric, and the vibrator may be disposed at a position that avoids at least a part of the heater device.

Since the vibrator is disposed at a position that avoids at least a part of the heater device, the deterioration of performance of the vibrator due to the heater device can be suppressed.

Further, in the above-described configuration, the functional component is an air cell, and at least one vibrator may be disposed at a position that avoids the air cell.

Since the vibrator is disposed at a position that avoids at least a part of the air cell, the deterioration of performance of the vibrator due to the air cell can be suppressed.

Further, in the above-described configuration, the functional component is an airbag, and the vibrator may be disposed at a position that avoids at least a part of the airbag.

Since the vibrator is disposed at a position that avoids at least a part of the airbag, the deterioration of performance of the vibrator due to the airbag can be suppressed.

Further, in the above-described configuration, the conveyance seat may include a seat back which supports a back of the occupant, a seat cushion which supports buttocks of the occupant, a frame which forms a framework, and a skin which covers the pad member, and the pad member may be placed on the frame.

### Advantageous Effects of Invention

According to the conveyance seat of the present invention, since a part of the vibrator is disposed at a position in which a part of them do not overlap with the functional component when viewed from the seating surface, the deterioration of performance of the functional component is suppressed. Therefore, it is possible to provide the conveyance seat in which the vibrator is disposed at a more appropriate position.

Further, since the vibrator is disposed at a position that avoids at least a part of the sensor device, the deterioration of sensor performance of the sensor device can be suppressed.

Since the vibrator is disposed at a position that avoids the sensor unit, the deterioration of sensor performance of the sensor device can be suppressed.

Since the vibrator is disposed at a position that avoids the connection portion, the deterioration of electrical performance can be suppressed.

Since the vibrator is disposed at a position that avoids the harness, the deterioration of electrical performance can be suppressed.

Since the vibrator is disposed at a position that avoids the entire sensor device, the deterioration of sensor performance and electrical performance can be suppressed.

Since the vibrator is disposed at a position that avoids at least a part of the heater device, the deterioration of performance of the vibrator due to the heater device can be suppressed.

Since the vibrator is disposed at a position that avoids at least a part of the air cell, the deterioration of performance of the vibrator due to the air cell can be suppressed.

Since the vibrator is disposed at a position that avoids at least a part of the airbag, the deterioration of performance of the vibrator due to the airbag can be suppressed.

### Description of Embodiments

Hereinafter, the configuration of a conveyance seat according to a third embodiment (this embodiment) of the present invention will be described with reference to the drawings. However, the embodiment described below is an example for facilitating understanding of the present invention, and is not intended to limit the present invention. In other words, the present invention can be modified or improved without departing from the spirit of the invention, and it goes without saying that the present invention includes equivalents thereof.

Hereinafter, a vehicle seat will be taken as an example of a conveyance seat, and a configuration example thereof will be described. However, the present invention is not limited to vehicle seats installed in conveyances that travel on land and have wheels, such as automobiles and trains, but may also be seats installed in aircraft, ships, and other vehicles that move other than on land. The present invention may also be applied to ordinary chairs or sofas.

Further, in the following description, the “front to rear direction” refers to the front to rear direction of the conveyance seat and coincides with the travel direction when the vehicle is traveling. Further, the “seat width direction” refers to the width direction of the conveyance seat and coincides with the right to left direction as viewed from the occupant (seated person) seated on the conveyance seat. Further, the “up to down direction” refers to the up to down direction of the conveyance seat and coincides with the vertical direction when the vehicle travels on a horizontal plane.

Further, in the following description, when describing various directions with the word “seat” added, such as the “seat width direction”, the “up to down direction of the seat”, and the “front to rear direction of the seat”, this indicates the direction relative to the conveyance seat, and when describing various directions with the word “vehicle” added, such as the “inside of the vehicle” and the “outside of the vehicle”, this indicates the direction relative to the vehicle.

Further, the shape, position, and posture of each part of the conveyance seat described below will be described assuming that the conveyance seat is in a seated state, which will be described later, unless otherwise specified.

### Conveyance Seat S30

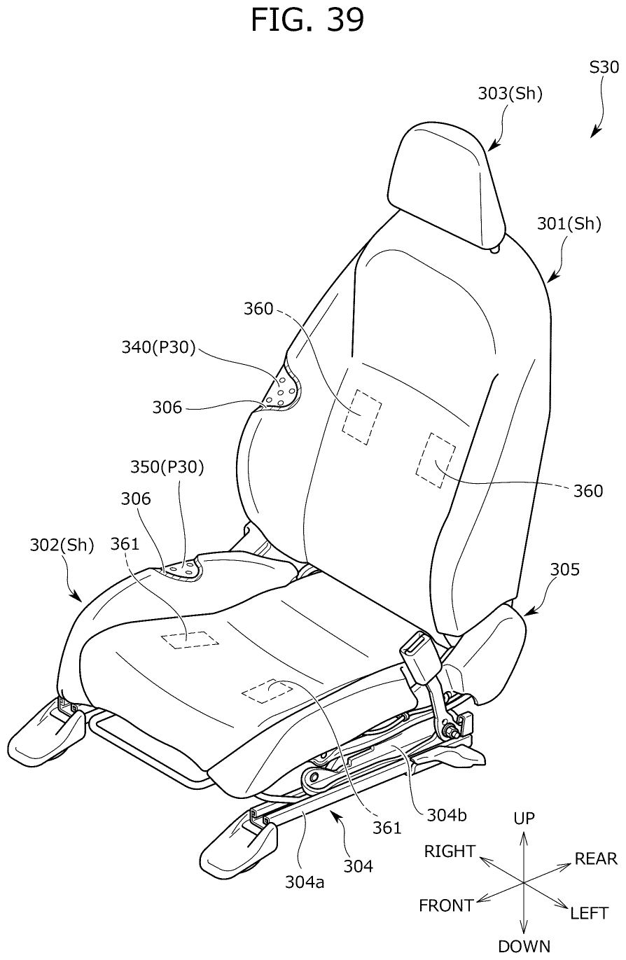

The basic configuration of a conveyance seat S30 according to this embodiment will be described with reference to FIG. 39. FIG. 39 is a perspective view of the conveyance seat S30, and for convenience of illustration, a part of the conveyance seat S30 is shown in FIG. 39 with a skin 306 removed.

The conveyance seat S30 is a seat that is placed on the floor of the vehicle and on which the occupant (hereinafter, sometimes referred to as the seated person) of the vehicle is seated. In this embodiment, the conveyance seat S30 is used as a front seat corresponding to the front seat of the vehicle. However, the present invention is not limited thereto, and the conveyance seat S30 can also be used as a rear seat, and can also be used as a second-row middle seat or a third-row rear seat in a vehicle having three rows of seats in the front to rear direction.

As shown in FIG. 39, the conveyance seat S30 mainly includes a seat back 301 that serves as a backrest portion supporting the back of the seated person, a seat cushion 302 that serves as a seating portion supporting the buttocks of the seated person, and a headrest 303 that is disposed on the upper portion of the seat back 301 and supports the head of the seated person. Furthermore, the seat back 301, the seat cushion 302, and the headrest 303 may be collectively referred to as a seat body Sh30.

The seat back 301 and the seat cushion 302 are connected to sandwich a reclining mechanism 305. The reclining mechanism 305 allows the seat back 301 to be rotatable relative to the seat cushion 302, and the tilt angle thereof is adjustable.

A headrest pillar 331 extends downward from the headrest 303 and is connected to the upper end of the seat back 301.

Further, a rail device 304 is installed below the conveyance seat S30. The conveyance seat S30 is attached to the vehicle floor by the rail device 304 so that the seat body Sh30 is slidable in the front to rear direction. The rail device 304 includes a lower rail 304a which is fixed onto the vehicle floor and an upper rail 304b which is slidable relative to the lower rail 304a.

### Seat Frame F30

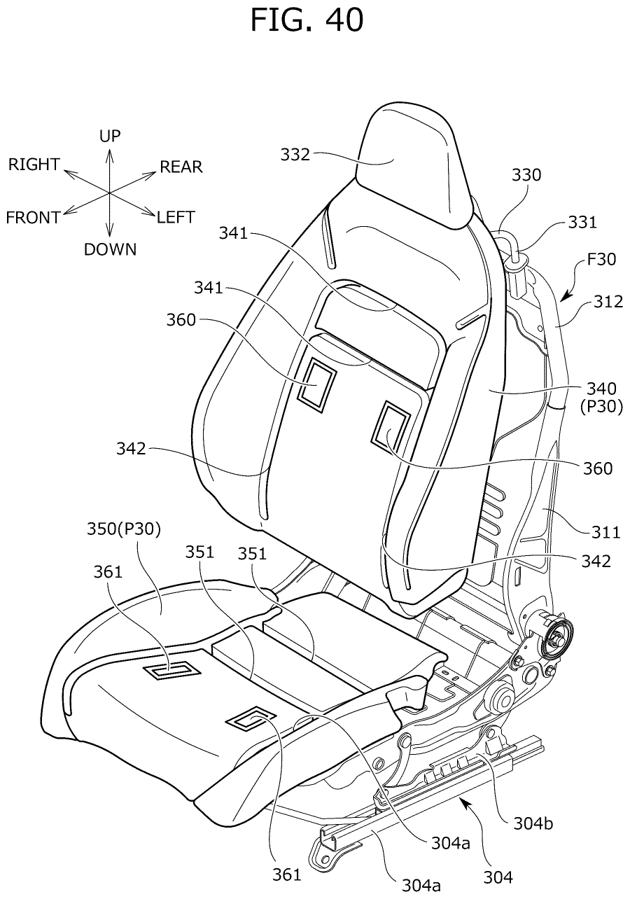

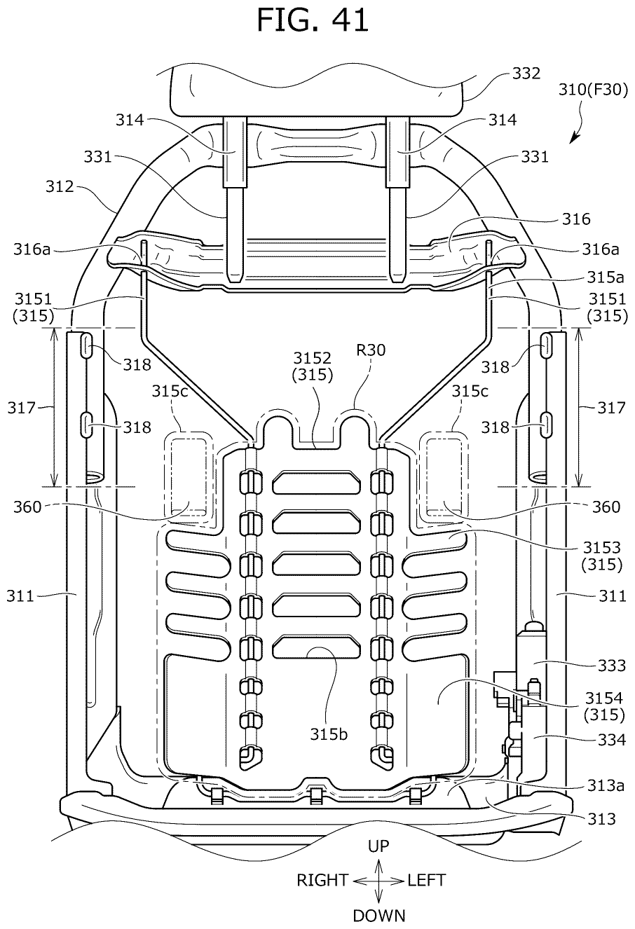

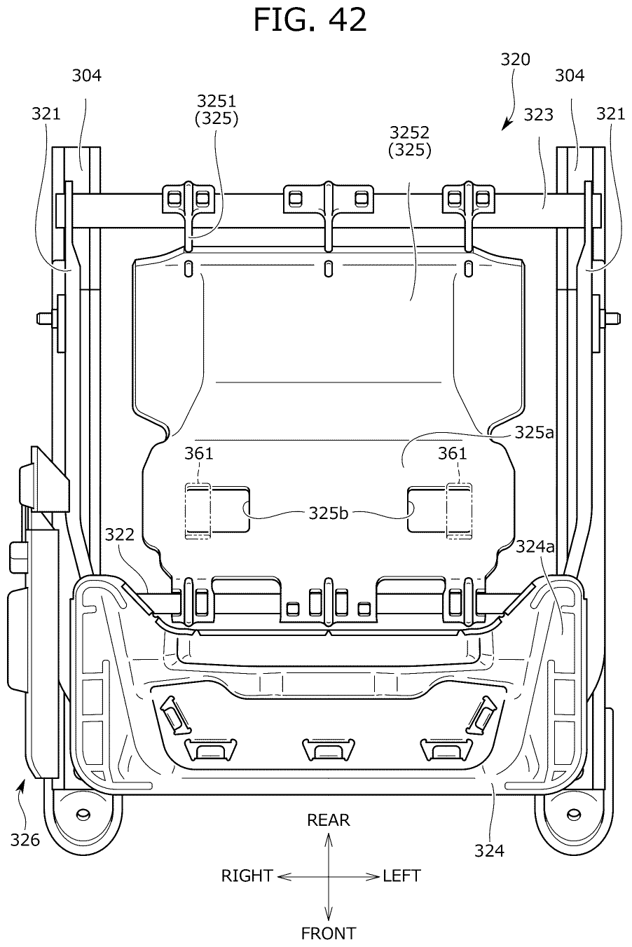

The basic configuration of a seat frame F30 that forms a framework of the conveyance seat S30 will be described with reference to FIG. 40. FIG. 40 is an exploded perspective view showing the seat frame F30 and a pad member P30 of the conveyance seat S30. FIG. 41 is a front view showing a seat back frame 310, and FIG. 42 is a top view showing a seat cushion frame 320.

As shown in FIG. 40, the seat frame F30 is provided inside the conveyance seat S30. The seat frame F30 includes the seat back frame 310 which forms a framework of the seat back 301, the seat cushion frame 320 which forms a framework of the seat cushion 302, and a headrest frame 330 which forms a framework of the headrest 303.

### Seat Back Frame 310

As shown in FIGS. 40 and 41, the seat back frame 310 is formed in a rectangular frame shape as a whole, and the seat back frame 310 includes a pair of back side frames 311 and 311 arranged on the right and left, an upper frame 312, and a lower frame 313.

As described above, the pair of back side frames 311 and 311 are arranged on the right and left sides of the seat back frame 310, and are basically members configured symmetrically on the right and left sides. The pair of back side frames 311 and 311 are provided to extend in the up to down direction of the seat. The pair of back side frames 311 and 311 are each formed so that the width in the front to rear direction of the seat increases from the upper side of the seat toward the lower side of the seat. The peripheral edge portion on the front side of the seat and the peripheral edge portion on the rear side of the seat are formed in a curved shape to protrude toward the front side of the seat.

The upper frame 312 is a member formed by bending a pipe into an inverted U-shape, and is disposed between the pair of back side frames 311 and 311 to connect the upper ends of the pair of back side frames 311 and 311. A connection frame 316 is provided at a portion of the upper frame 312 that connects the back side frames 311 and 311.

The upper frame 312 and the pair of back side frames 311 and 311 are connected by welding the overlapping portions (overlapping portions 317) of the upper frame 312 and the pair of back side frames 311 and 311. Hereinafter, the welded portion will be referred to as a welding portion 318.

The upper frame 312 is provided with a pair of headrest holders 314 into which headrest pillars 331 of the headrest 303 are inserted. The headrest holder 314 is formed as a high-hardness metal member to keep the holding strength of the headrest 303 and suppress rattling. Furthermore, the headrest holder 314 is not limited to being made of metal, but may be made of resin.

Further, an actuator 333 is attached to the lower end of the back side frame 311 disposed on the left side via an actuator attachment portion 334. The reclining mechanism 305 can be driven by using the actuator 333.

The seat back frame 310 is provided with a back pressure receiving member 315. The back pressure receiving member 315 is also called a lumbar and is a member that receives the load of the seated person. The pressure receiving member 315 is provided to be movable within a predetermined range of the seat back frame 310 when a load is applied from the seated person.

The back pressure receiving member 315 shown in FIG. 41 includes a wire member 3151 and a plate-shaped member 3152 that is formed in a plate shape to mainly receive a load of the seated person. The back pressure receiving member 315 is attached in such a manner that an upper end 315a is fixed to an upper attachment portion 316a of the connection frame 316 and a lower end is fixed to the lower frame 313.

The plate-shaped member 3152 of the pressure receiving member 315 is elastically supported by the wire member 3151 and is movable in the front to rear direction or the right to left direction, for example, within a movable range R shown in FIG. 41.

As shown in FIG. 41, a plurality of openings 315b which are long in the seat width direction are formed in the plate-shaped member 3152. Further, a first side portion 3153 and a second side portion 3154 which extend outward in the seat width direction are provided on both side portions of the plate-shaped member 3152. The first side portion 3153 is located at the center of the side portion of the plate-shaped member 3152 and is made of a plurality of ribs extending in the right to left direction (seat width direction). In other words, the first side portion 3153 is formed in a comb shape by a plurality of ribs. The second side portion 3154 is located on the lower side of the side portion of the plate-shaped member 3152 and is provided to extend outward in the seat width direction.

### Seat Cushion Frame 320

As shown in FIGS. 40 and 42, the seat cushion frame 320 is formed in a rectangular frame shape in the top view of the conveyance seat S30, and a pair of cushion side frames 321 and 321 are provided on the right and left sides. The pair of cushion side frames 321 and 321 are basically members that are configured symmetrically on the right and left sides, and are provided to extend in the front to rear direction of the seat.

Further, the seat cushion frame 320 includes a front connection frame 322 which connects the pair of cushion side frames 321 and 321 at the front side and a rear connection frame 323 which connects them at the rear side. The front connection frame 322 and the rear connection frame 323 are formed as round pipes. Further, a plate-shaped pan frame 324 is provided in front of the front connection frame 322.

Further, as shown in FIGS. 40 and 42, the seat cushion frame 320 is provided with a cushion pressure receiving member 325 that is disposed between the front connection frame 322 and the rear connection frame 323 to bridge them. The cushion pressure receiving member 325 can support the buttocks of the seated person from below.

The cushion pressure receiving member 325 shown in FIG. 42 includes a wire member 3251 and a plate-shaped member 3252. The wire member 3251 includes a front end and a rear end each formed in a hook shape and elastically supports the plate-shaped member 3252 of the cushion pressure receiving member 325 by being hooked onto the front connection frame 322 and the rear connection frame 323.

An inclined portion 325a which is inclined downward toward the rear side is formed on the plate-shaped member 3252 of the cushion pressure receiving member 325. Further, as shown in FIG. 42, a plurality of openings 325b are formed in the plate-shaped member 3252.

Further, a seat switch unit 326 is provided in the cushion side frame 321 disposed on the right side of the seat cushion frame 320. The seat switch unit 326 may be disposed on the left side. By pressing a button or the like on the seat switch unit 326, the occupant can drive the actuator 333 provided in the reclining mechanism and adjust the backward tilt angle of the seat back 301. Further, an actuator (not shown) provided on the rail device 304 can be driven to adjust the front-rear position of the seat body Sh30.

### Headrest Frame 330

As described above, the headrest frame 330 is a member that forms a framework of the headrest 303. The headrest frame 330 is formed in an inverted U-shape in the front view, and can be attached to the upper end of the seat back 301 by inserting the headrest pillar 331 extending downward into the headrest holder 314.

### Pad Member P30

The pad member P30 will be described with reference to FIGS. 40, 43, and 44. The pad member P30 includes a back pad 340 which is attached to the seat back frame 310, a cushion pad 350 which is attached to the seat cushion frame 320, and a headrest pad 332 which is attached to the headrest frame 330 and serves as a headrest pad member.

The back pad 340 is provided to cover the back pressure receiving member 315.

Further, the cushion pad 350 is provided to cover the cushion pressure receiving member 325.

Each of the back pad 340, the cushion pad 350, and the headrest pad 332 is covered with the skin 306.

The pad member P30 is a urethane base material formed by foam molding using, for example, a urethane foam material, and the skin 306 is made of, for example, cloth, synthetic leather, genuine leather, or the like.

### Back Pad 340

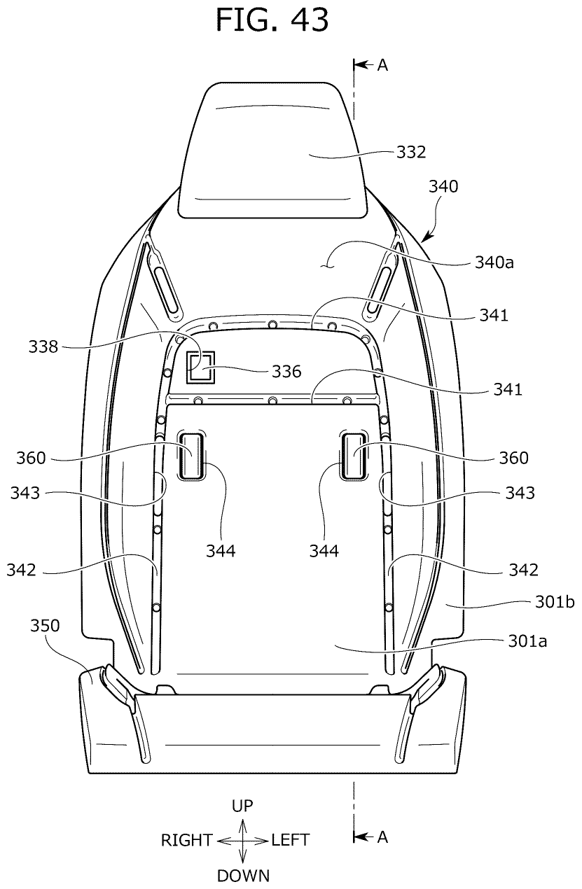

As shown in FIG. 43, the back pad 340 is provided with a first horizontal suspension groove 341 which extends in the seat width direction and a first vertical suspension groove 342 which extends in the up to down direction. The first horizontal suspension groove 341 corresponds to the horizontal suspension groove of the present invention, and the first vertical suspension groove 342 corresponds to the vertical suspension groove of the present invention.

The first horizontal suspension groove 341 connects the upper ends of the first vertical suspension grooves 342. The first vertical suspension groove 342 is disposed between the main body 301a and the bank portion 301b of the seat back 301.

### Pad Through Hole 343

A pad through hole 343 is formed in a part of the first vertical suspension groove 342 along the first vertical suspension groove 342. Since the pad through hole 343 is formed, the back pad 340 is easily deformed. Further, the pad through hole 343 can absorb the deformation of the back pad 340 due to a vibrator 360 to be described later.

Further, when a blower 335 that blows air is provided in the conveyance seat S30, a duct through hole 338 which is inserted through a duct 336 may be formed in the back pad 340.

### Storage Recess 344

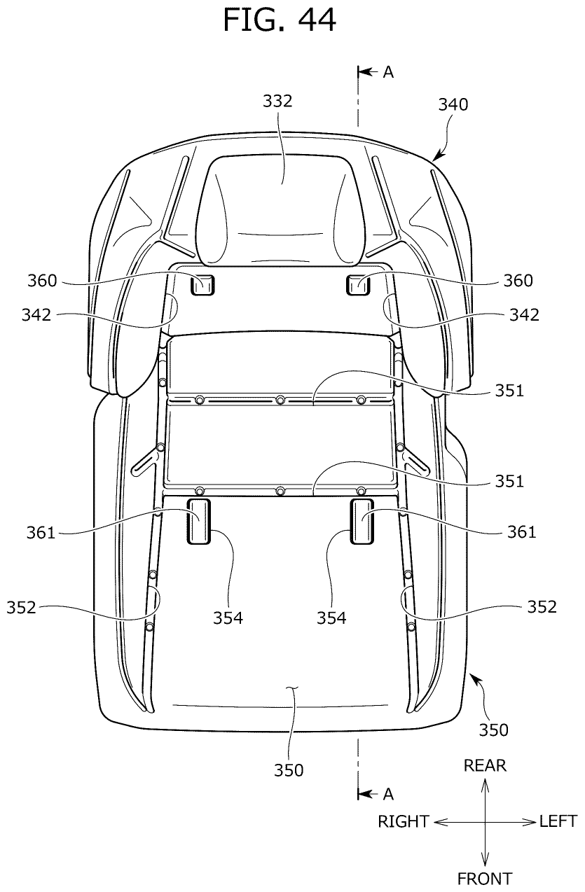

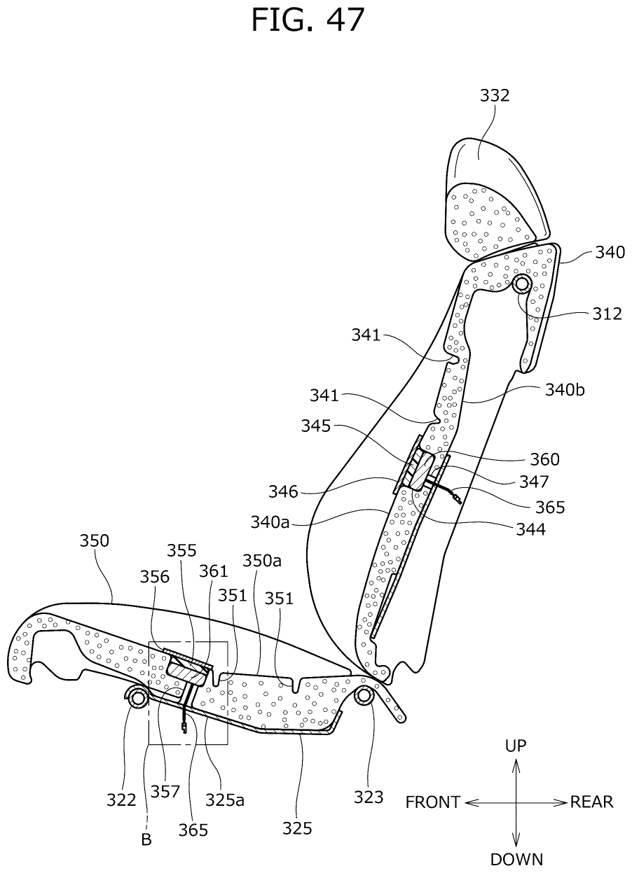

As shown in FIGS. 44 and 47, a storage recess 344 which stores the back side vibrator 360 is formed in a seating surface 340a of the back pad 340. The vibrator 360 can be attached by inserting the vibrator 360 into the storage recess 344.

After the vibrator 360 is inserted into the storage recess 344, a slab 345 is disposed on the vibrator 360 to close the storage recess 344. The slab 345 is fixed by a fixing tape 346.

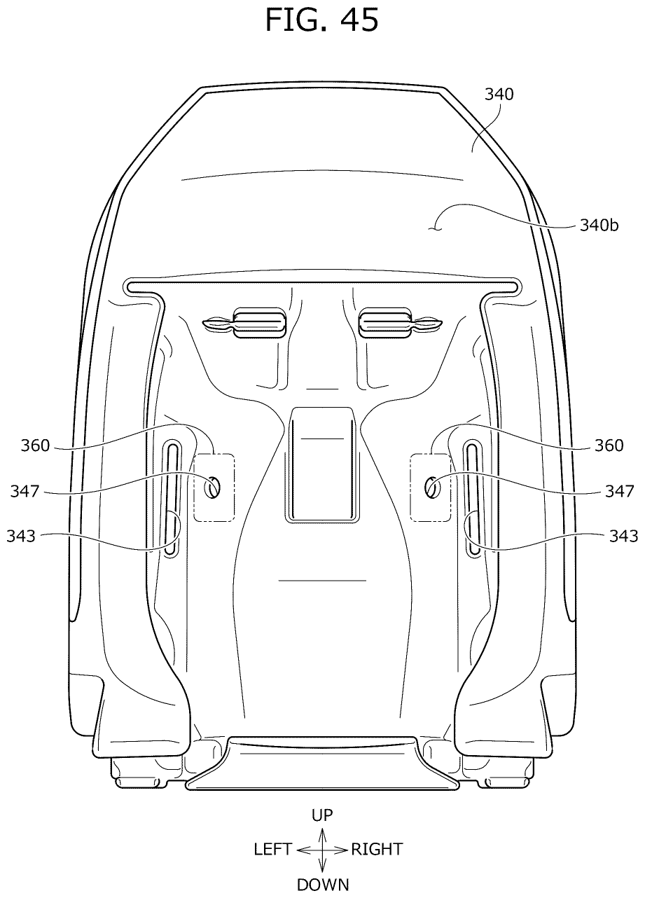

As shown in FIGS. 45 and 47, a harness hole 347 is formed in the bottom surface of the storage recess 344, and a harness 365 extending from the vibrator 360 is inserted through the harness hole so that the harness 365 is pulled into a back surface 340b of the back pad 340.

### Vibrator 360

The vibrator 360 is a device that applies a vibration to the seated occupant. In this embodiment, two vibrators 360 are arranged on the back pad 340. Two vibrators 360 are also arranged on the cushion side (hereinafter, referred to as cushion side vibrators 361). The back side vibrator 360 and the cushion side vibrator 361 have the same mechanism.

An eccentric motor is used in the vibrator 360. The present invention is not limited to the eccentric motor, and a linear vibration actuator or a piezoelectric element may be used in the vibrator 360. The harness 365 extends from the vibrator 360 and is connected to an ECU installed in the vehicle. The ECU can control the strength and timing of vibration of the vibrator 360.

### Cushion Pad 350

As shown in FIG. 44, the cushion pad 350 is provided with a second horizontal suspension groove 351 which extends in the seat width direction and a second vertical suspension groove 352 which extends in the front to rear direction. The second horizontal suspension groove 351 corresponds to the horizontal suspension groove of the present invention, and the second vertical suspension groove 352 corresponds to the vertical suspension groove of the present invention.

The second vertical suspension groove 352 is disposed between a main body 302a of the seat cushion 302 and bank portions 302b arranged on the right and left sides thereof. The second horizontal suspension groove 351 is provided to connect two second vertical suspension grooves 352.

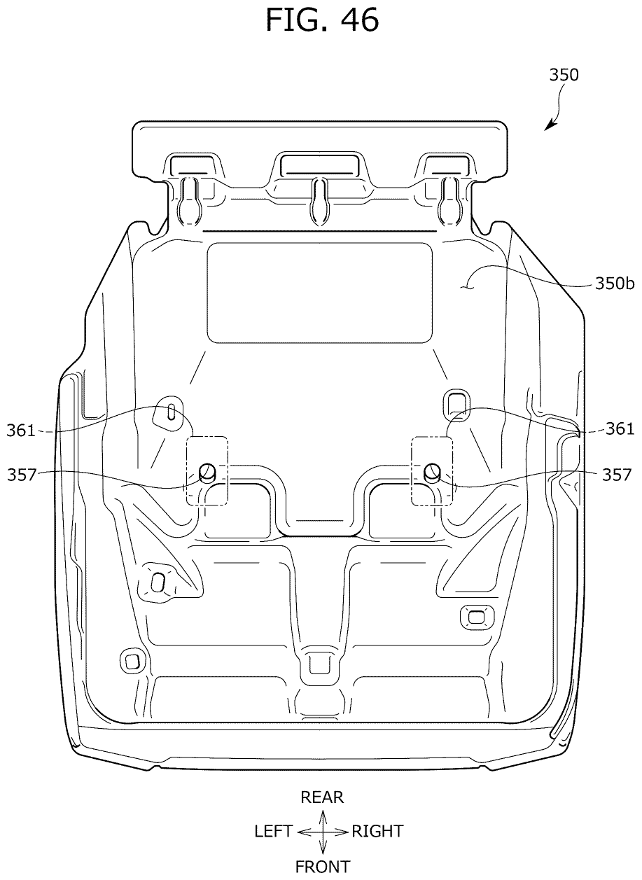

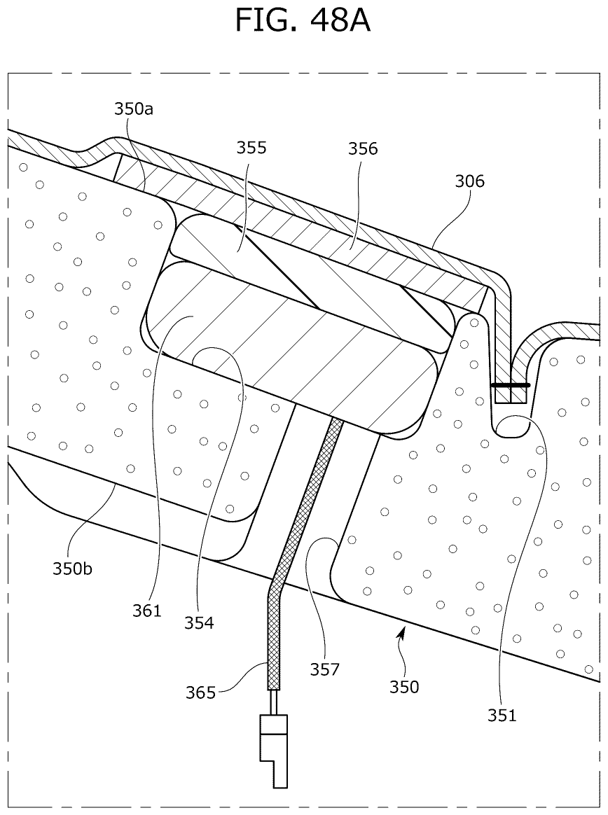

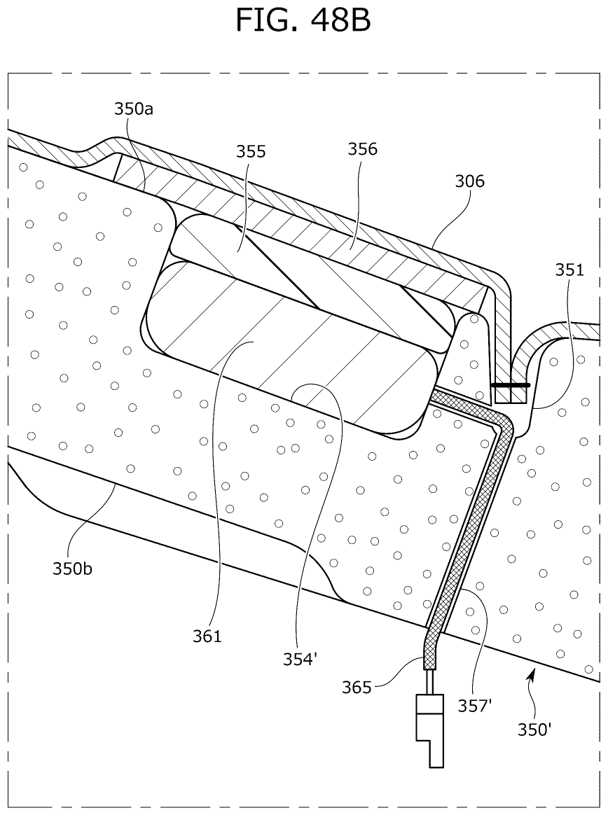

A storage recess 354 which stores the cushion side vibrator 361 is formed in a seating surface 350a of the cushion pad 350. The vibrator 361 can be attached by inserting the vibrator 361 into the storage recess 354. As shown in FIGS. 46 and 48A, a harness hole 357 is formed in the bottom surface of the storage recess 354, and the harness 365 extending from the vibrator 361 is inserted through the harness hole so that the harness 365 is pulled into a bottom surface 350b of the cushion pad 350.

After the vibrator 361 is inserted into the storage recess 354, a slab 355 is disposed on the vibrator 361 to close the storage recess 344. The slab 355 is fixed by a fixing tape 356. As shown in FIGS. 46 and 48A, a harness hole 357 is formed in the bottom surface of the storage recess 354, and the harness 365 extending from the vibrator 361 is inserted through the harness hole so that the harness 365 is pulled into the bottom surface 350b of the cushion pad 350.

Furthermore, in the cushion pad 350 shown in FIG. 48A, the harness hole 357 is formed in the bottom surface of the storage recess 354, but the position of the harness hole 357 is not limited thereto. As in a storage recess 354′ of a cushion pad 350′ shown in FIG. 48B, a harness hole 357′ may be formed in a side wall so that the harness hole 357′ is formed from the bottom portion of the second horizontal suspension groove 351 to the bottom surface 350b through the second horizontal suspension groove 351. Further, a suspension hole formed in the second horizontal suspension groove 351 may be used as the harness hole 357′.

### Positions of Vibrators 360 and 361

Hereinafter, the arrangement of the vibrator 360 of the back pad 340 and the vibrator 361 of the cushion pad 350 will be described with reference to the drawings.

Conventionally, the vibrator has been arranged on the seat back or the seat cushion of the vehicle seat in order to notify the occupant, but the appropriate arrangement position of the vibrator has not been sufficiently considered.

In the conveyance seat S30 of this embodiment, the back pad 340 is provided with two vibrators 360 that generate a vibration. As shown in FIG. 41, two vibrators 360 are arranged at positions in which at least a part of them do not overlap with the pressure receiving member 315 in the front view of the conveyance seat S30.

Specifically, two vibrators 360 are arranged at positions on the sides of the plate-shaped member 3152 of the pressure receiving member 315 and overlapping with the opening 315c located above the first side portion 3153 in the front view.

With such an arrangement, for example, when the occupant sits down or when the vehicle crashes head-on, the occupant sinks into the cushion pad 350, but at that time, the vibrator 360 does not suppress the occupant from sinking. That is, when sinking, the occupant presses the vibrator 360 backward, but since the movement of the vibrator 360 is suppressed from being hindered by the pressure receiving member 315, the sinking of the occupant is not hindered. In this way, since the vibrator 360 is disposed in consideration of the position of the pressure receiving member 315, it is possible to provide the conveyance seat S30 in which the vibrator 360 is disposed at an appropriate position.

Further, as described above, the pressure receiving member 315 is provided to be movable in the movable range R (predetermined range) shown in FIG. 41, but the vibrator 360 is provided to be located outside the movable range R. Therefore, even when the pressure receiving member 315 moves, the vibrator 360 does not interfere with the pressure receiving member 315. With such an arrangement, it is possible to suppress an increase in the sense of discomfort caused by the movement of the pressure receiving member 315.

Further, as shown in FIG. 43, the vibrator 360 is disposed at a position that overlaps with the pad through hole 343 formed in the cushion pad 350 in the seat width direction. In other words, the vibrator 360 is disposed at a position substantially at the same height as the pad through hole 343 in the up to down direction of the seat. With such an arrangement, the pad through hole 343 can absorb the deformation of the back pad 340 due to the vibrator 360.

Further, as shown in FIG. 43, the vibrator 360 is disposed to be located below the first horizontal suspension groove 341 extending in the seat width direction. Further, the vibrator 360 is disposed on the inside in the seat width direction in relation to the first vertical suspension groove 342 extending in the up to down direction of the seat. In other words, the vibrator 360 is disposed to be sandwiched between two first vertical suspension grooves 342.

Since the vibrator 360 is disposed in this way, for example, it is possible to suppress the discomfort felt by the seated person while suppressing the influence on the first horizontal suspension groove 341 and the first vertical suspension groove 342.

Further, when the conveyance seat S30 is provided with the blower and configured to blow air from the seat back 301, as shown in FIG. 43, the duct 336 may be disposed on the upper portion of the seat back 301. In such a case, the vibrator 360 may be disposed at a position that avoids the duct 336 provided in the cushion pad 350. Since the vibrator is disposed at a position that avoids the duct 336 extending from the blower 335, the influence on the air blown out from the blower can be suppressed.

Furthermore, the vibrator 360 may be disposed at a position that avoids not only the duct 336 but also the opening of the blower or the blower attachment portion of the blower.

### Sensor Device 370

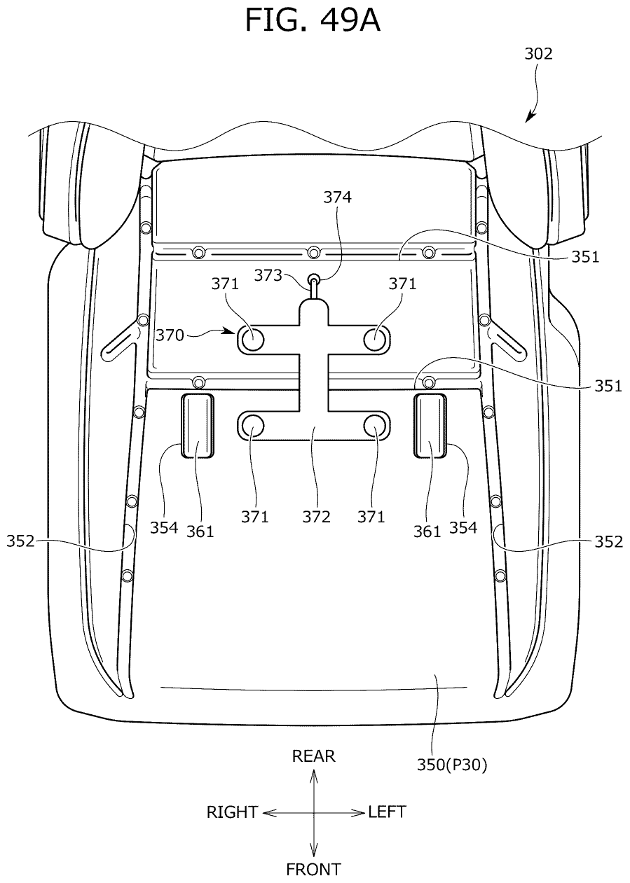

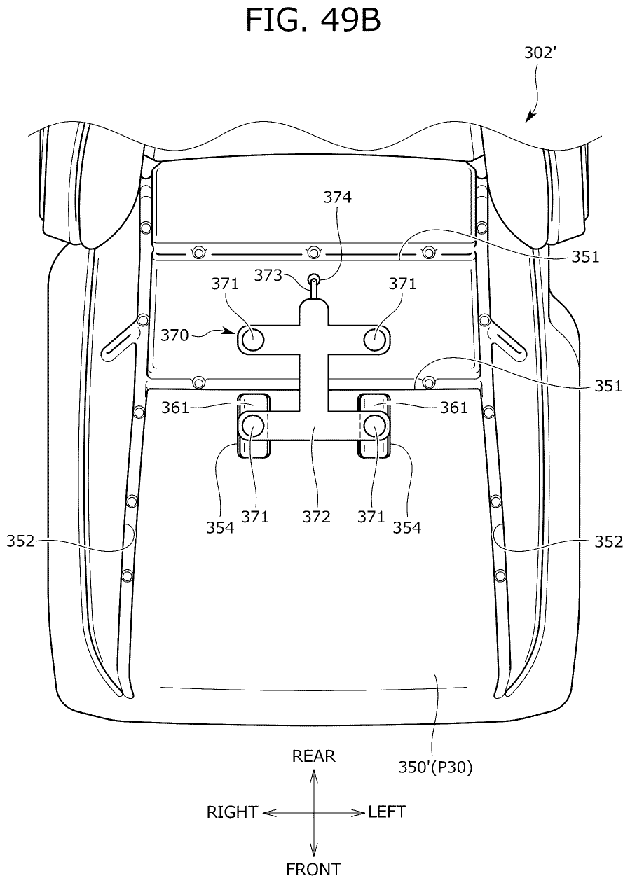

Next, the relationship between the vibrator 361 and a sensor device 370 will be described. FIG. 49A is a top view showing the seat cushion 302 in which the sensor device 370 is disposed. Furthermore, this figure shows the seat cushion 302 with the skin 306 removed. As shown in FIG. 49A, the sensor device 370 is disposed on the cushion pad 350 of the seat cushion 302.

The sensor device 370 is a seat belt reminder switch, and includes a plurality of sensor units 371 which detect the state of the seated person, a connection portion 372 which connects the plurality of sensor units 371 and the harness 365, and a harness 373 which extends from the connection portion 372. The harness 373 is connected to the ECU or the like via the harness hole 374 formed in the cushion pad 350. The sensor unit 371 is a pressure sensor, but may be a capacitance sensor. The sensor unit is a biological information detection device that detects biological information of the seated person. Furthermore, the sensor device 370 corresponds to the functional component of the present invention.

As shown in FIG. 49A, the vibrator 361 and the storage recess 354 (hereinafter, referred to as the vibrator 361 and the like) storing the vibrator 361 are arranged at positions that avoid the sensor device 370. In other words, the vibrator 361 and the like are arranged at position that do not overlap with the sensor device 370 in the top view of the conveyance seat S30. Specifically, the vibrator 361 and the like are arranged to be separated from each other by a predetermined distance from the sensor device 370 in the seat width direction. Since the vibrator 361 and the like are arranged at positions that avoid the sensor device 370, the deterioration of sensor performance can be suppressed.

Further, the vibrator 361 and the like may be arranged at positions that avoid the sensor unit 371. Since the vibrator is disposed at a position that avoids the sensor unit 371, the deterioration of sensor performance can be suppressed.

Further, the vibrator 361 and the like may be arranged at positions that avoid the connection portion 372 connecting the sensor units 371. Since the vibrator is disposed at a position that avoids the connection portion 372, the deterioration of electrical performance can be suppressed.

Further, the vibrator 361 and the like may be arranged at positions that avoid the entire sensor including the sensor unit and the connection portion. The deterioration of sensor performance and electrical performance can be suppressed.

Further, the vibrator 361 and the like may be arranged at positions that avoid the harness hole 374. Since the vibrator 361 is disposed to avoid the harness hole 374, the layout of the harness 373 is improved.

Furthermore, as described above, the bottom portion of the storage recess 354 is provided with the harness hole 357 through which the harness 365 of the vibrator 361 passes, but the harness hole 357 may also serve as the harness hole 374 through which the harness 373 of the sensor passes.

The harness 365 of the vibrator 361 and the harness 373 of the sensor device 370 passed through the bottom surface side may be bundled together on the bottom surface side. By bundling, the harness can be arranged compactly.

Further, as in a seat cushion 302′ shown in FIG. 49B, the vibrator 361 and the storage recess 354 may be arranged to overlap with the sensor device 370. Since the vibrator is disposed in an overlapping manner, a plurality of members can be arranged compactly.

Further, when the cushion pad 350′ includes a pad body and an upper pad portion combined with the pad body, it is preferable to first arrange the vibrator 361 and the sensor device 370 on the upper pad portion and then assemble them to the pad body. By assembling in this way, it is possible to facilitate the assembling.

Furthermore, the vibrator 3061 disposed on the seat cushion 302 has been described as an example, but the vibrator 360 and the storage recess 344 arranged in the seat back 301 may be also arranged at positions that avoid the sensor device 370 disposed on the seat back 301. That is, the vibrator 360 and the like may be arranged at positions that do not overlap with the sensor device 370 in the front view of the conveyance seat S30 (when viewed from the seating surface).

### Heater Device 380

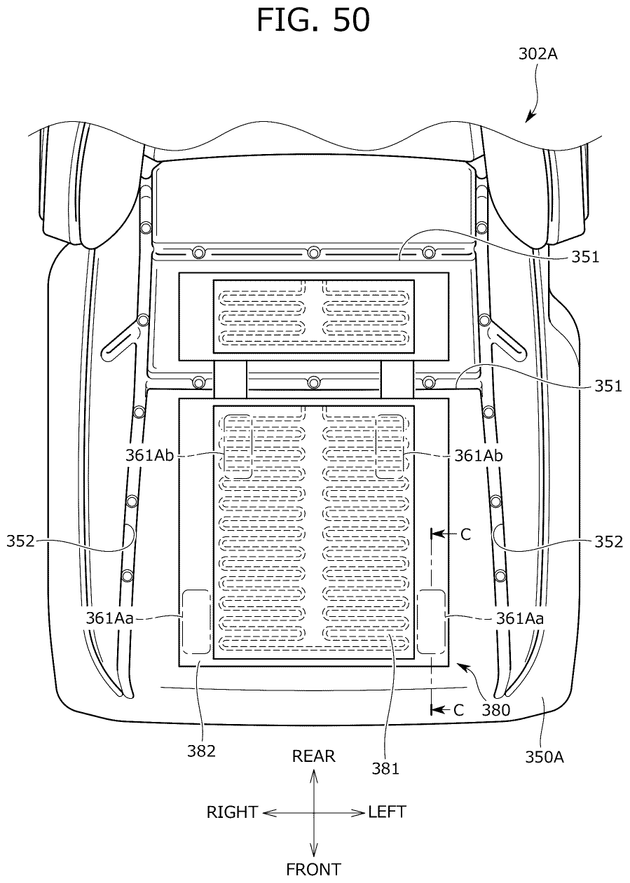

Next, the relationship between the vibrator 361 and a heater device 380 will be described. FIG. 50 is a top view showing a seat cushion 302A in which the heater device 380 is disposed. Furthermore, this figure shows the seat cushion 302 with the skin 306 removed.

The heater device 380 is disposed on a cushion pad 350A of the seat cushion 302A.

The heater device 380 includes a base fabric 382 and a heater wire portion 381 which is disposed on the base fabric 382 and serves as a heat source. Furthermore, the heater device 380 corresponds to the functional component of the present invention.

The vibrator 361 may be disposed at a position that overlaps with the heater device 380 in the top view. Since the vibrator is disposed in an overlapping manner, the deterioration of performance of the vibrator 361 due to the lower temperature can be suppressed.

As in a vibrator 361Aa shown in FIG. 50, the vibrator 361 may be disposed at a position that overlaps with only the base fabric 382. Further, as in a vibrator 361Ab shown in FIG. 50, the vibrator 361 may be disposed at a position that overlaps with the base fabric 382 and the heater wire portion 381. With such an arrangement, the deterioration of performance of the vibrator 361 due to the low temperature can be suppressed.

Further, when the cushion pad 350A includes a pad body and an upper pad portion combined with the pad body, it is preferable to first arrange the vibrator 361 and the heater device 380 on the upper pad portion and then assemble them to the pad body. By assembling in this way, it is possible to facilitate the assembling.

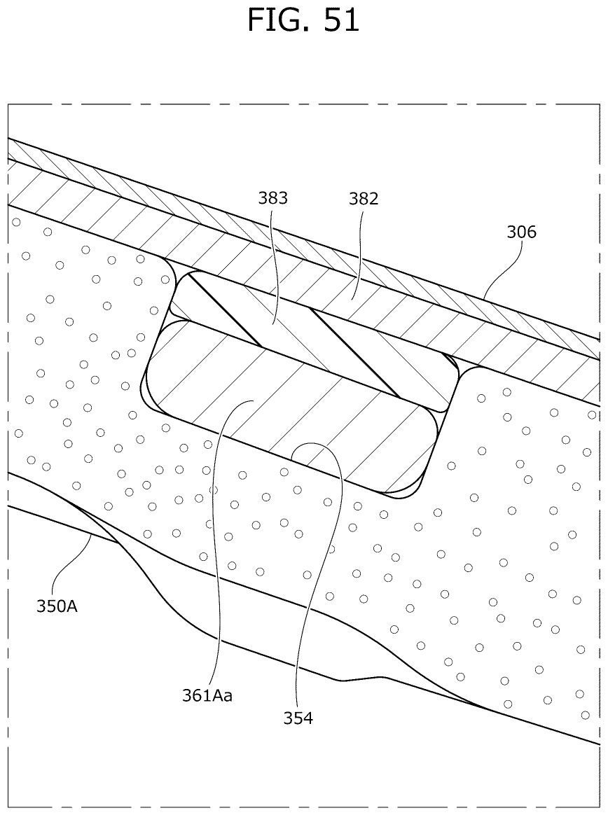

As shown in FIG. 51, the vibrator 361 is fixed by being stored in the storage recess 354, but when the vibrator 361 is disposed in a position overlapping with the heater device 380, it is preferable to cover the vibrator 361 with a lid having a high heat insulating effect. By providing a lid 383 with a high heat insulating effect, it is possible to suppress the deterioration of the temperature rise performance of the heater device 380. Further, since the base fabric 382 is adhered to the cushion pad 350A, no fixing tape is required.

The harness of the vibrator 361 and the harness of the heater device (not shown) are preferably bundled together on the bottom surface side of the cushion pad. By bundling the harnesses, the harnesses can be arranged in a compact manner.

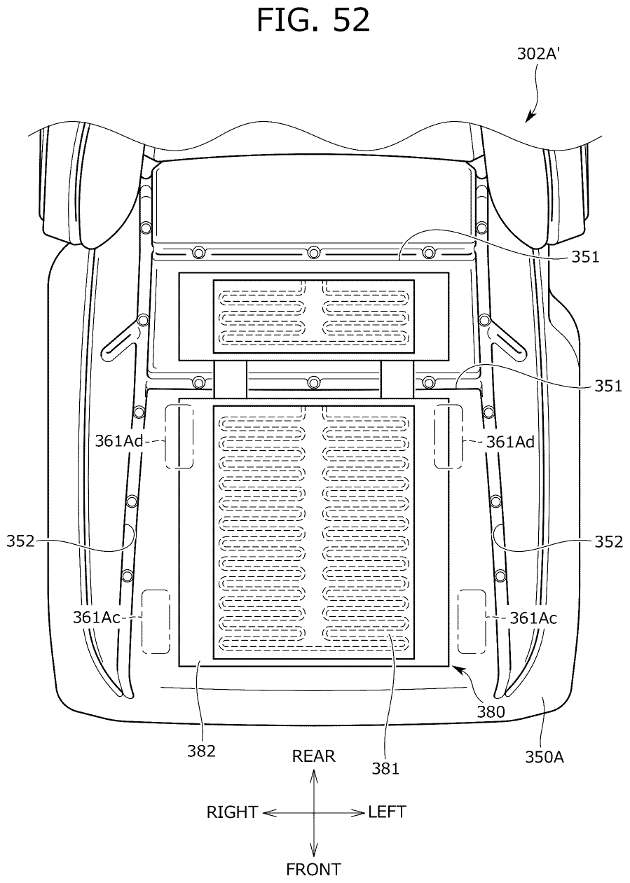

Further, the vibrator 361 may be disposed to avoid the heater device 380. As in a vibrator 361Ac of a seat cushion 302A′ shown in FIG. 52, the vibrator 361 may be disposed to completely avoid the heater device 380. In other words, the vibrator 361 may be disposed at a position that does not overlap with the heater device 380 in the top view.

As in a vibrator 361Ad shown in FIG. 52, the vibrator 361 may be disposed not to partially overlap with the heater device 380.

Since the vibrator 361 is disposed to avoid the heater device 380, the deterioration of performance of the heater device 380 can be suppressed.

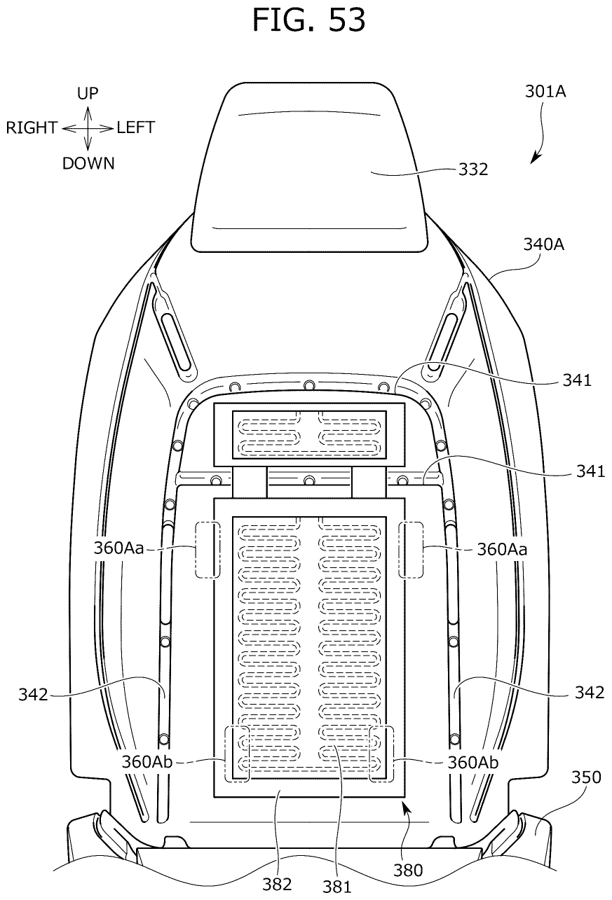

Further, as in a vibrator 360Aa of the seat back 301A shown in FIG. 53, the vibrator 360 may be disposed at a position that partially overlaps with the base fabric 382 of the heater device 380 disposed on the seat back 301A in the front view.

Further, as in a vibrator 360Ab shown in FIG. 53, the vibrator 360 may be disposed at a position that overlaps with the base fabric 382 and the heater wire portion 381. The deterioration of performance of the vibrator 360 due to the low temperature can be suppressed.

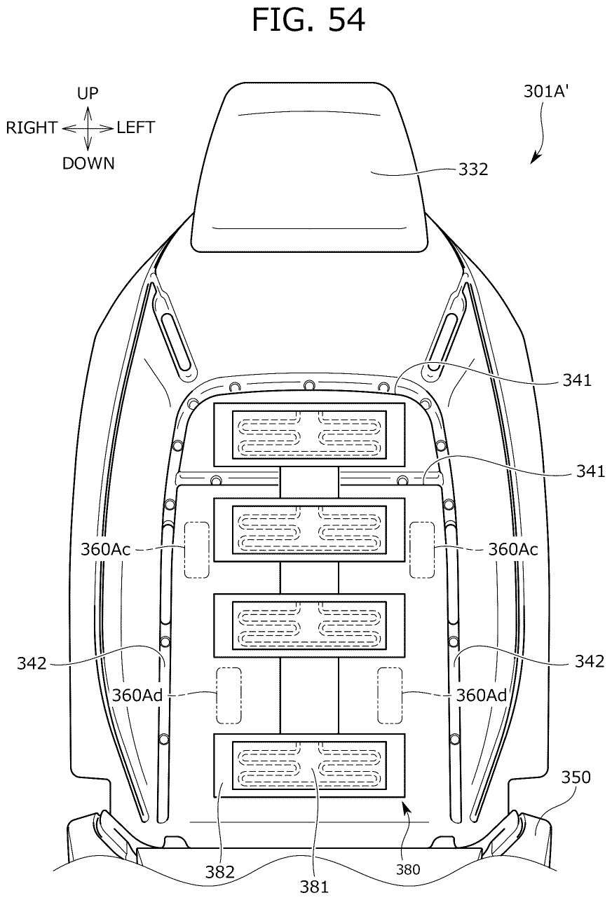

Further, as in a vibrator 360Ac shown in FIG. 54, the vibrator 360 may be disposed to avoid the heater device 380. That is, the vibrator 360 may be disposed at a position that does not overlap with the heater device 380 in the front view.

Further, when the heater device 380 is configured as a divided part as in a seat back 301A′ shown in FIG. 54, the vibrator 360 may be disposed in the gap of the heater device 380 to avoid the heater device 380 as in a vibrator 360Ad shown in FIG. 54.

Since the vibrator 361 is disposed to avoid the heater device 380, the deterioration of performance of the heater device 380 can be suppressed.

### Air Cell 390

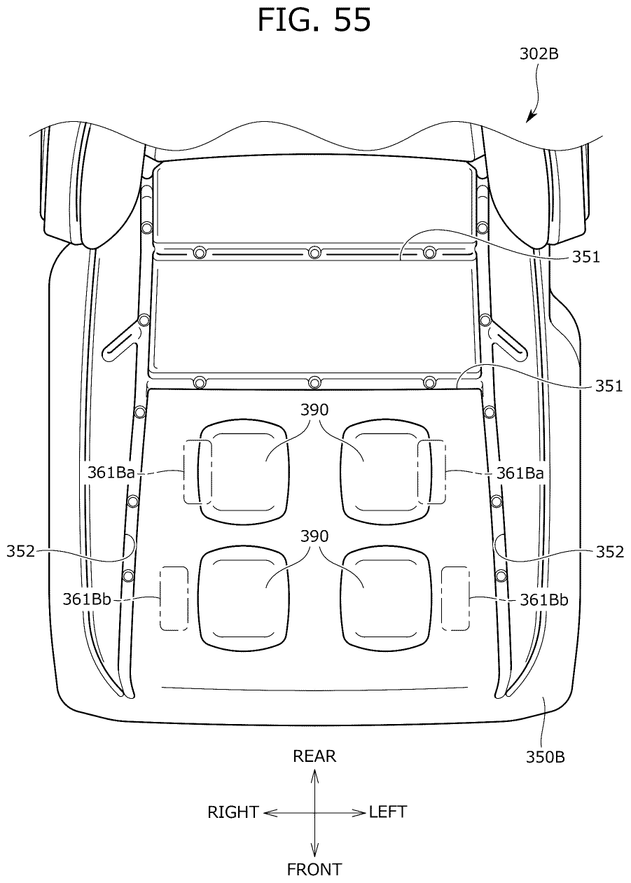

Next, the relationship between the vibrator 361 and an air cell 390 provided on a cushion pad 350B will be described. FIG. 55 is a top view showing a seat cushion 302B in which an air cell 390 is disposed. Furthermore, the skin 306 is shown in a removed state.

The air cell 390 is a bag that can be inflated by injecting air, and the air cell 390 can be inflated to change the shape of the seat or the posture of the seated person. Furthermore, the air cell 390 corresponds to the functional component of the present invention.

As in a vibrator 361Ba shown in FIG. 55, the vibrator 361 may be disposed at a position that does not partially overlap with the air cell 390 in the top view, that is, when viewed from the seating surface of the seat cushion 302B. Further, as in a vibrator 361Bb of FIG. 55, the vibrator may be disposed at a position in which the front portion does not overlap with the air cell 390. In other words, the vibrator 361 may be disposed at a position that avoids the air cell 390. Since the vibrator 361 is disposed at a position that avoids the air cell, the deterioration of performance of the air cell can be suppressed.

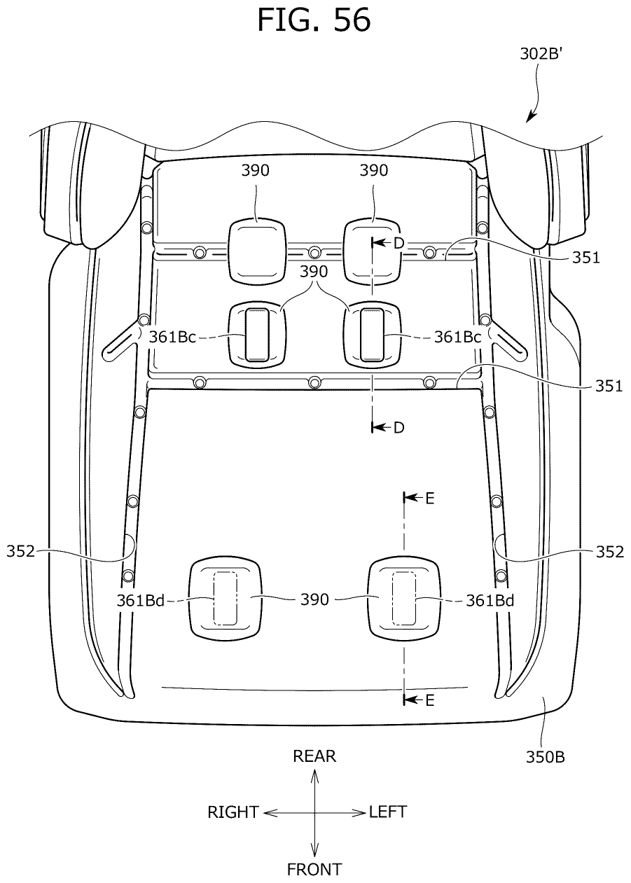

Further, as in vibrators 361Bc and 361Bd of a cushion pad 302B′ shown in FIG. 56, the vibrator 361 may be disposed to overlap with the air cell 390. Since the vibrator 361 is disposed in this way, the vibrator 361 can be arranged compactly.

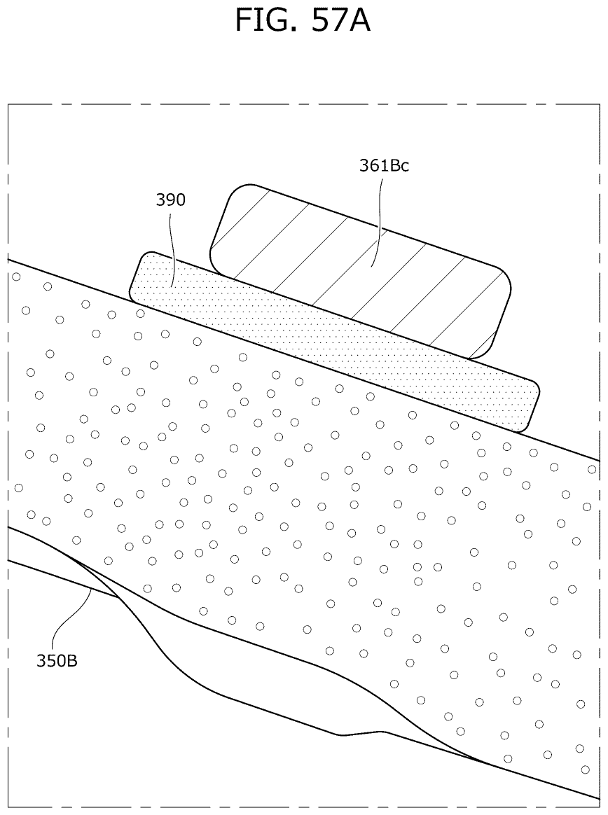

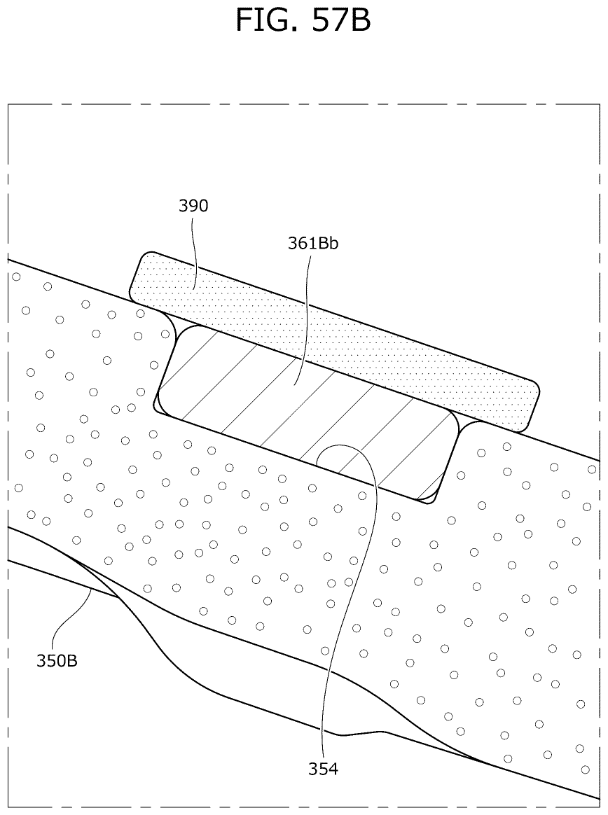

Further, as shown in FIG. 57A, the vibrator 361 may be disposed on the air cell 390. Since the vibrator 361 is disposed on the air cell 390, the vibration is easily transmitted to the seated person.

Further, as shown in FIG. 57B, the vibrator 361 may be embedded in the storage recess 354 of the cushion pad 302B′ and disposed below the air cell 390 of the vibrator 361Ba. The vibrator 361 can be arranged compactly.

Further, the distance between the air cells 390 may be changed according to the interval between the vibrators 361.

Further, when the cushion pad 350B includes a pad body and an upper pad portion combined with the pad body, it is preferable to first arrange the vibrator 361 and the air cell 390 on the upper pad portion and then assemble them to the pad body. By assembling in this way, it is possible to facilitate the assembling.

Further, the harness 365 of the vibrator 361 and the harness (not shown) of the air cell 390 are preferably bundled together on the bottom surface side of the cushion pad. By bundling the harnesses, the harnesses can be arranged in a compact manner.

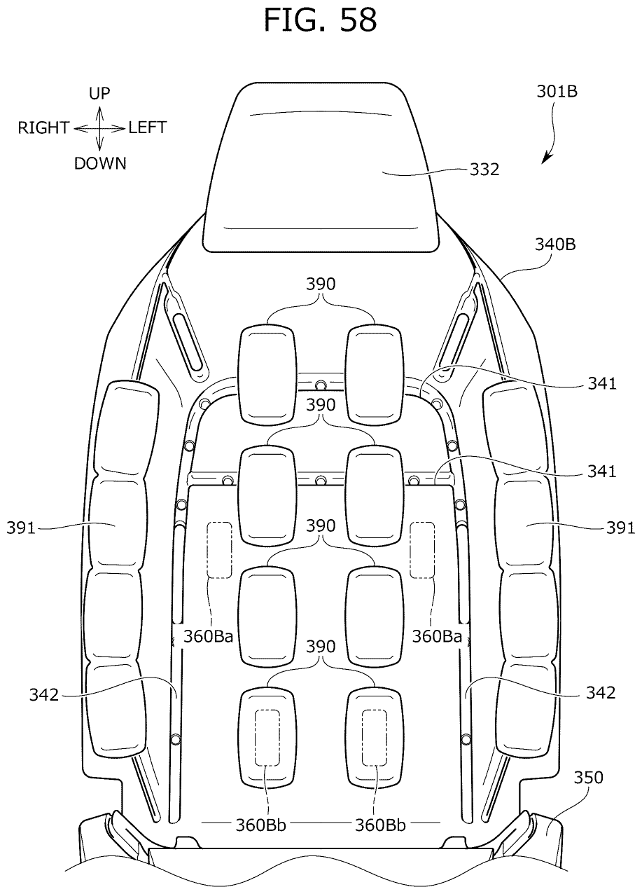

Further, as in a vibrator 360Ba of a seat back 301B shown in FIG. 58, a part of the vibrator 360 may be disposed at a position that does not overlap with the air cell 390 disposed on the seat back 301B when viewed from the seating surface, that is, in the front view. The deterioration of performance of the air cell 390 can be suppressed.

Further, as in a vibrator 360Bb shown in FIG. 58, the vibrator 360 may be disposed at a position that overlaps with the air cell 390 when viewed from the seating surface, that is, in the front view. The vibrator 360 can be arranged compactly.

Further, since the vibrator is disposed to overlap with an air cell 391 of the bank portion installed in the seat back 301B in the seat width direction, the occupant can easily feel the vibration.

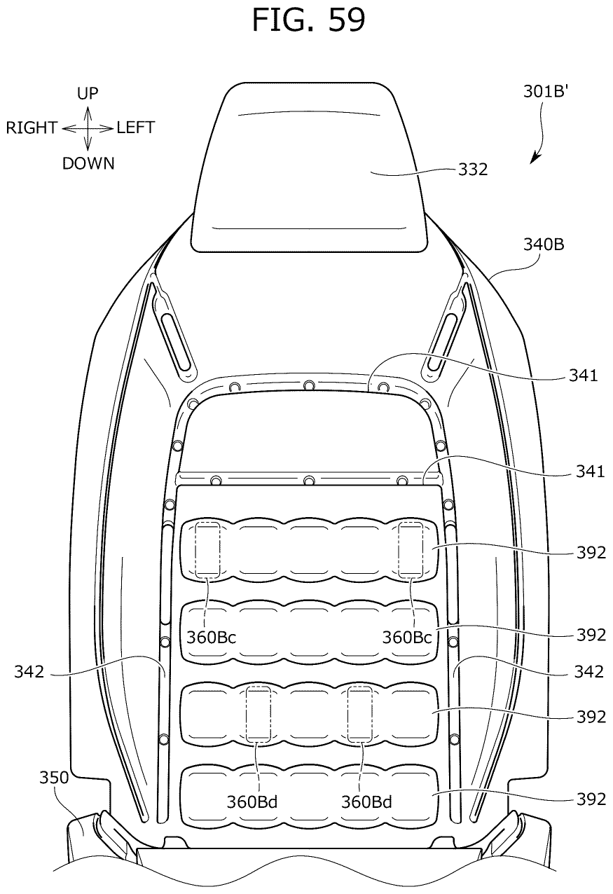

Further, as in a seat back 301B′ shown in FIG. 59, a horizontally elongated air cell 392 may be disposed on a back pad 340B. As in vibrators 360Bc and 360Bd of FIG. 59, the vibrator 360 is disposed at a position that overlaps with the air cell 392. By forming the air cell 392 in a horizontally elongated shape, it is easy to arrange the vibrators 360 in an overlapping manner.

### Relationship With Suspension Groove

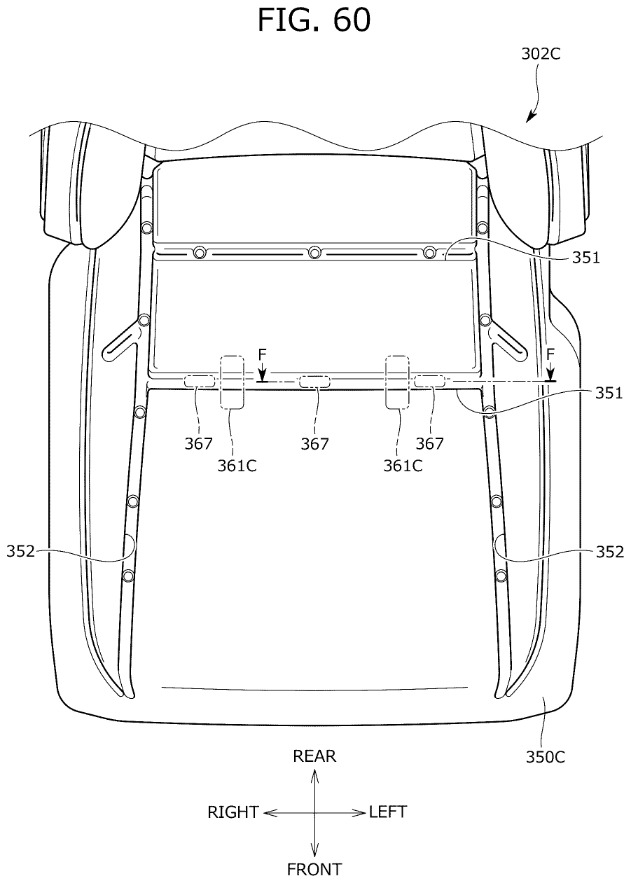

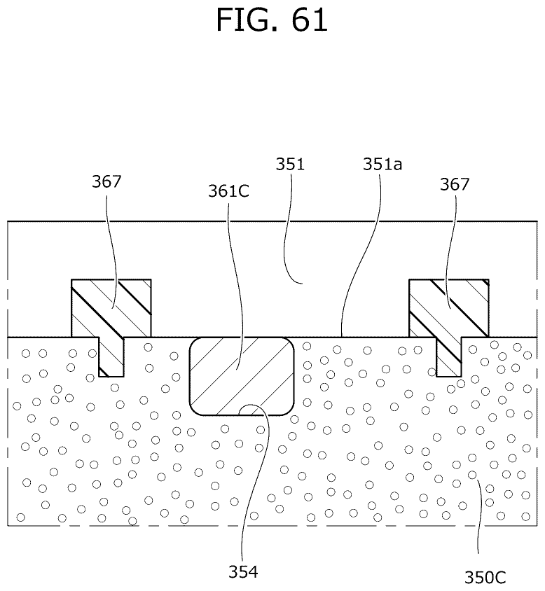

The relationship between the vibrator and the suspension groove will be described with reference to FIG. 60. FIG. 60 is a top view of a cushion pad 350C of a seat cushion 302C, and FIG. 61 is a cross-sectional view taken along line F-F of FIG. 60.

As in a vibrator 361C of FIG. 60, the vibrator 361 may be disposed at a position that overlaps with the suspension groove formed in the cushion pad 350C, particularly the second horizontal suspension groove 351 in the top view. With such an arrangement, the vibrator 361 can be arranged compactly. The vibrator 361 may be disposed at a position that overlaps with the second vertical suspension groove 352 in the top view.

The vibrator 361 may be disposed at a position that avoids the suspension groove. The deterioration of performance of the vibrator 361 can be suppressed. The vibrator 361 may be disposed at a position that avoids a clip member 367 for fixing the suspended skin 306. The deterioration of performance of the vibrator can be suppressed.

The vibrator may be disposed near an area sandwiched between a plurality of skin fixing portions (portions where clip members, C-rings, etc. are provided) that fix the skin. Accordingly, it is possible to prevent the skin from becoming loose.

In some cases, the skin is suspended using a suspension wire, but since there is a risk that a vibration may not be transmitted, it is preferable to use the vibrator 361 when the skin 306 is fixed with the clip member 367 rather than a suspension wire.

Further, the storage recess 354 that stores the vibrator 361 may be disposed at a position that overlaps with the suspension groove. Further, the storage recess 354 may be disposed at a position that overlaps with the bottom portion or side portion of the suspension groove. The vibrator 361 can be arranged compactly.

Further, the storage recess 354 overlaps with the suspension groove, but the vibrator 361 may be disposed at a position that avoids the Suspension groove. The deterioration of performance of the vibrator can be suppressed.

### Relationship With Variable Bank Portion 3121

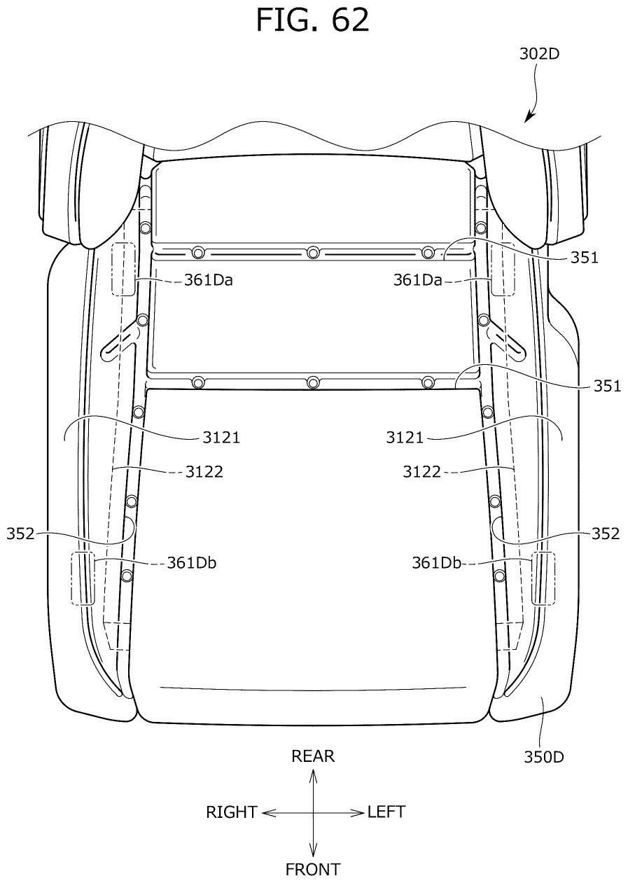

Some vehicle seats have a variable bank portion 3121 that allows the bank portion of the cushion pad to be moved. The relationship between the vibrator 361 and the variable bank portion 3121 will be described with reference to FIG. 62.

FIG. 62 is a top view of a seat cushion 302D having the variable bank portion 3121 whose position can be changed to the right or left. The seat cushion 302D includes a movable mechanism 3122 that allows the bank portion to be opened and closed in the right to left direction. Furthermore, the variable bank portion 3121 corresponds to the functional component of the present invention.

As in a vibrator 361Da shown in FIG. 62, the vibrator 361 may be disposed at a position that overlaps with the movable mechanism 3122 provided inside the variable bank portion 3121 when viewed from the seating surface, that is, in the top view. The vibrator 361 can be arranged compactly.

Further, the vibrator 361 may be disposed at a position that avoids the movable mechanism 3122 as in a vibrator 361Db of FIG. 62. That is, the vibrator may be disposed at a position that does not overlap with the movable mechanism 3122 in the top view. Since the vibrator 361 is disposed in this way, the influence on the movable mechanism 3122 can be suppressed.

### Relationship With Front-Rear Adjustment Mechanism 3123

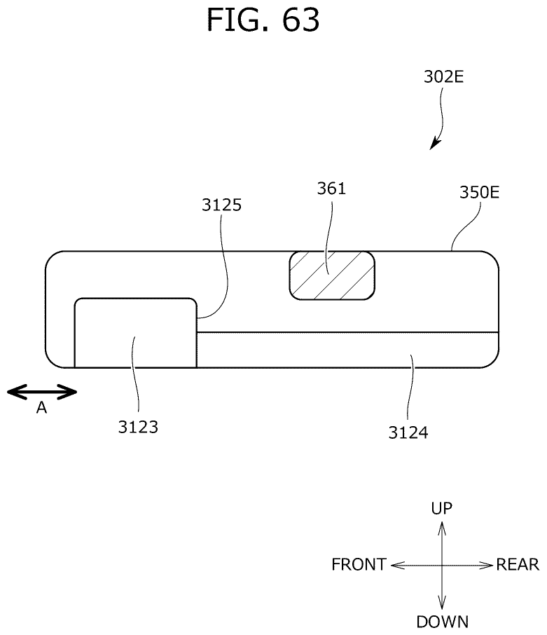

Some vehicle seats have a front-rear adjustment function that allows the front end of the cushion pad to be extended forward. FIG. 63 is a cross-sectional view showing a schematic configuration of a seat cushion 302E having a front-rear adjustment mechanism 3123 at the front. The front-rear adjustment mechanism 3123 can move the front end of the seat cushion 302E as shown by the double arrow A in FIG. 63. The cushion pad 350E is supported by the fixing portion 3124. Furthermore, the front-rear adjustment mechanism 3123 corresponds to the functional component of the present invention.

As shown in FIG. 63, the vibrator 361 is disposed such that the movable portion of the front-rear adjustment mechanism 3123 is located behind the storage recess 3125 (the position where the front end of the cushion pad 350E is not extended). Since the rear of the cushion pad 350 is not moved by the front-rear adjustment mechanism 3123, the vibrator 361 can be easily installed.

### Relationship With Airbag

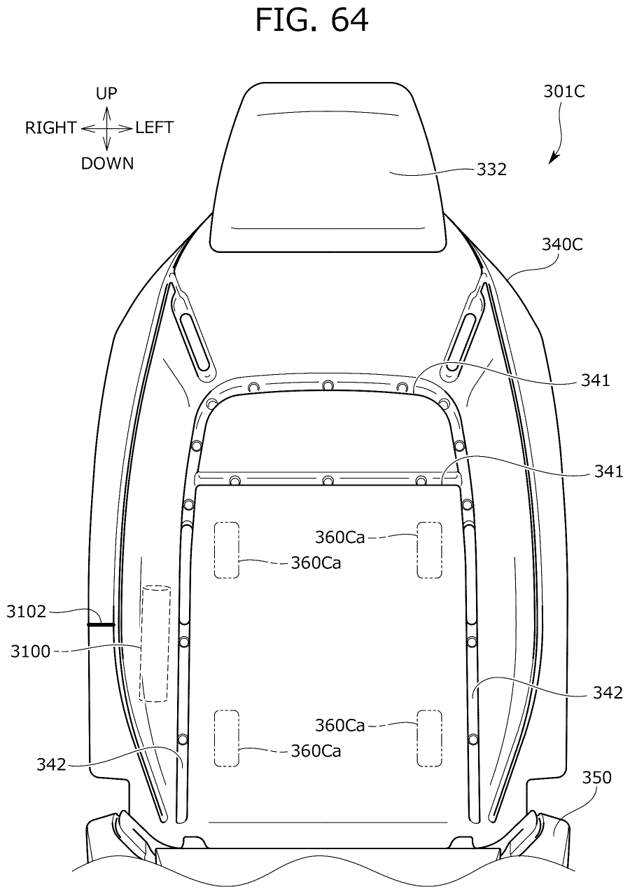

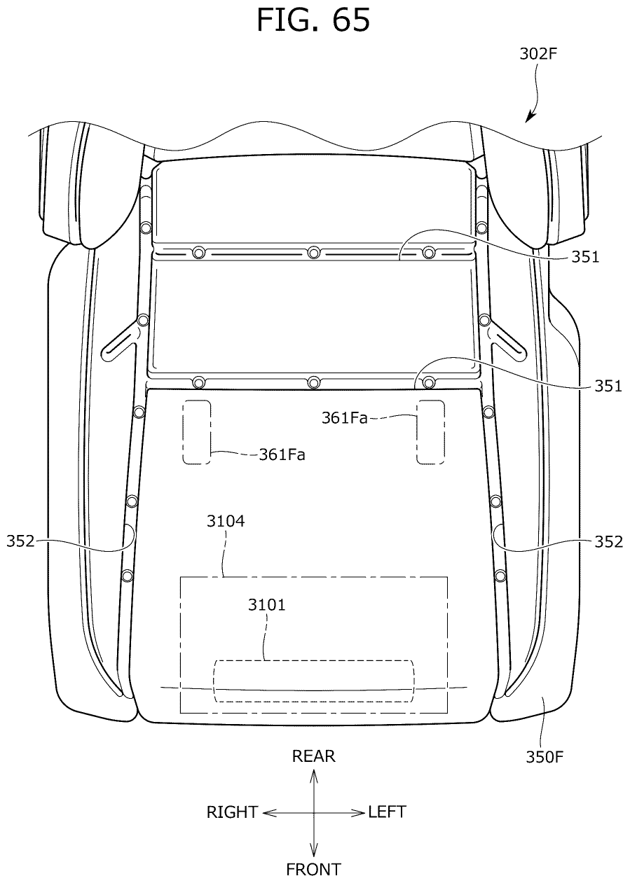

Some vehicle seats have side airbags. Airbags include side airbags provided on the sides of the seat back and cushion airbags disposed in front of the upper surface of the cushion airbag. FIG. 64 is a front view showing a seat back 301C in which a side airbag module 3100 of the side airbag is provided, and FIG. 65 is a top view showing a seat cushion 302F in which a cushion airbag module 3101 is provided. Furthermore, the skin 306 is shown in a removed state. Furthermore, the airbag corresponds to the functional component of the present invention.

The side airbag module 3100 for the side airbag is provided on the left side of the seat back 301C, and a tear line (tear portion) is formed on the side of the side airbag module 3100. As in a vibrator 360Ca shown in FIG. 63, the vibrator 360 provided in the seat back 301C is disposed at a position that avoids the side airbag module 3100. Further, the vibrator is disposed at a position that avoids the tear line 3102 in the up to down direction. In other words, the vibrator is disposed at a non-overlapping position in the seat width direction, that is, above or below the tear line 3102. By arranging the vibrator 360 in this way, the deployment of the side airbag module 3100 is not hindered.

As shown in FIG. 65, the cushion airbag module 3101 of the cushion airbag is disposed on the front side of the upper surface of the seat cushion 302F. As in a vibrator 361Fa shown in FIG. 65, the vibrator 361 provided in the seat cushion 302F is disposed at a position that avoids the bag bulge area 3104 of the cushion airbag module 3101. With such an arrangement, the deployment of the cushion airbag module 3101 is not hindered.

### Relationship With Lighting

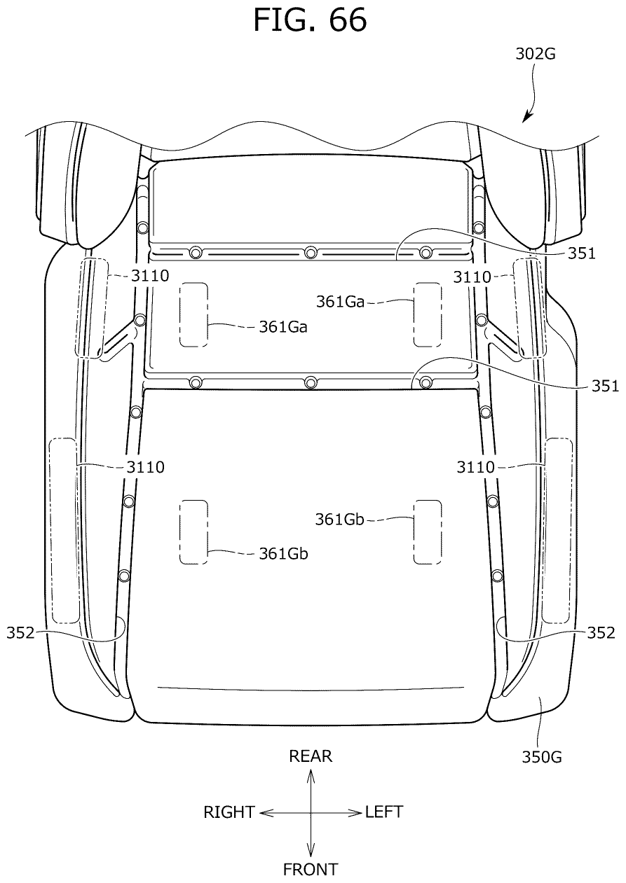

Some vehicle seats have lighting on the sides of the seat cushion. FIG. 66 is a top view of a seat cushion 302G provided with lighting 3110. Furthermore, the seat cushion 302G is shown with the skin 306 removed. Furthermore, the lighting 3110 corresponds to the functional component of the present invention.

As in a vibrator 361Ga shown in FIG. 65, the vibrator 361 provided in the seat cushion 302G is disposed in the vicinity of the lighting 3110 in the seat width direction. That is, the lighting 3110 is disposed on the front side, lateral side, upper side, and the like of the vibrator 361Ga. In the drawing, the vibrator 361Ga is disposed at a position that overlaps with the lighting 3110 in the seat width direction.

By turning on the lighting 3110 in the vicinity of the vibrator 361Ga when the vibrator 361Ga is in operation, it is easy to tell that the vibrator 361Ga is in operation.

### Relationship With Pads of Different Hardness

Some vehicle seats have back pads and cushion pads made of a plurality of pad materials with different hardnesses.

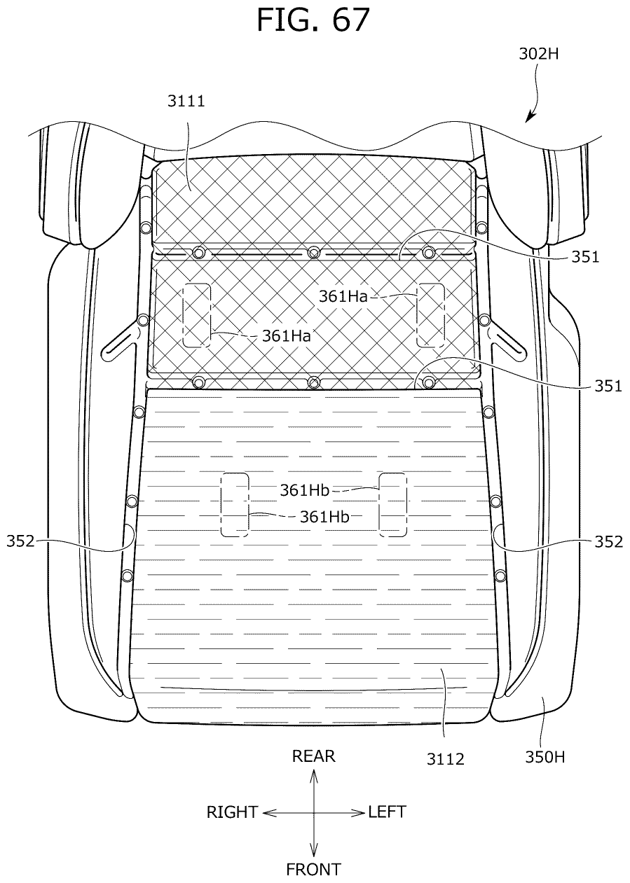

FIG. 67 is a top view showing a seat cushion 302H made of pad materials with different hardness. Furthermore, the seat cushion 302H is shown with the skin 306 removed.

The cushion pad 350H of the seat cushion 302H is made of a low-hardness pad material 3111 at its rear side and a high-hardness pad material 3112 at its front side.

The vibrator 361 provided in the seat cushion 302H may be provided in the area of the low-hardness pad material 3111 as in a vibrator 361Ha shown in FIG. 67. The low-hardness pad material 3111 has a low density and is less likely to transmit a vibration, so that the transmission of the vibration to other areas can be suppressed.

Further, as in a vibrator 361Hb shown in FIG. 67, the vibrator 361 may be provided in the area of the high-hardness pad material 3112. The vibration can be transmitted in a wide range.

### Positional Relationship Between Vibrator 361 and Heater Device 380

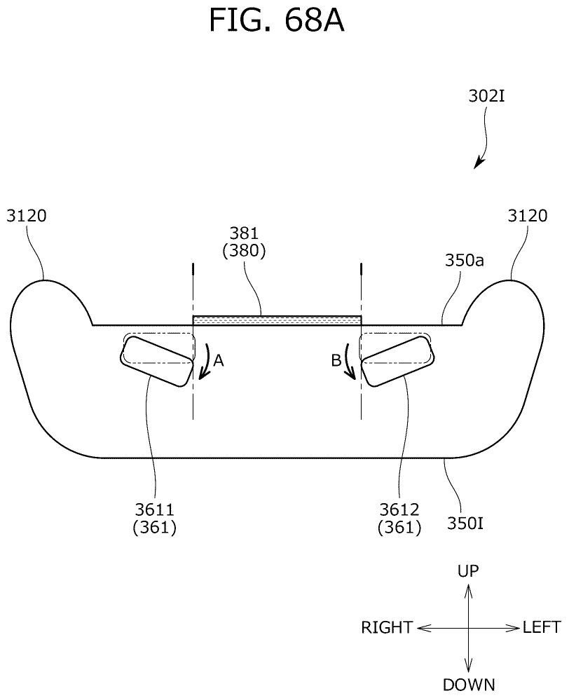

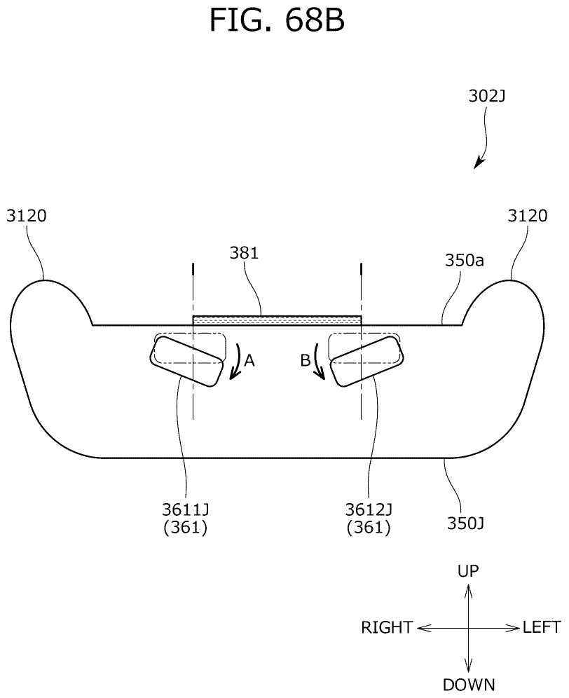

FIG. 68A is a schematic view of a seat cushion 302I showing the positional relationship between the heater device 380 and the vibrator 361.

Side support portions 3120 which are bank portions bulging toward the seated person are provided on both sides of the seat cushion 302I. Further, a heater wire portion 381 of the heater device 380 is disposed on the seating surface 350a of the cushion pad 350I of the seat cushion 302I.

The vibrator 361 is disposed on the outside in the seat width direction in relation to the side portion of the heater wire portion 381. That is, the vibrator 361 is disposed at a position that does not overlap with the heater wire portion 381 in the top view.

As in a first vibrator 3611 on the right side, the vibrator 361 may be rotated in the direction of the arrow A of FIG. 68A to be disposed at an angle. Further, as in a second vibrator 3612 on the left side, the vibrator may be rotated in the direction of the arrow B of FIG. 68A to be disposed at an angle.

With such an arrangement, the vibrator 361 can be separated from the heater area (heater wire portion 381), and the mutual influence can be suppressed.

FIG. 68B is a schematic view of a seat cushion 302J showing the positional relationship between the heater device 380 and the vibrator 361.

As in the seat cushion 302I shown in FIG. 68A, the side support portions 3120 which are bank portions bulging toward the seated person are provided on both sides of the seat cushion 302J. Further, the heater wire portion 381 of the heater device 380 is disposed on the seating surface 350a of a cushion pad 350J of the seat cushion 302I.

The vibrator 361 of the seat cushion 302J is disposed on the inside in the seat width direction in relation to the side portion of the heater wire portion 381. That is, a part of the vibrator 361 is disposed to overlap with the heater wire portion 381 in the top view.

Even in such a case, the vibrator 361 may be rotated in the direction of the arrow A in FIG. 68B to be disposed at an angle as in a first vibrator 3611J on the right side. Further, the vibrator may be rotated in the direction of the arrow B in FIG. 68B to be disposed at an angle as in a second vibrator 3612J on the left side.

By disposing the vibrator 361 at an angle, the vibrator 361 can be separated from the heater area (heater wire portion 381), and the mutual influence can be suppressed.

### Positional Relationship Between Vibrator 361 and Sensor Unit

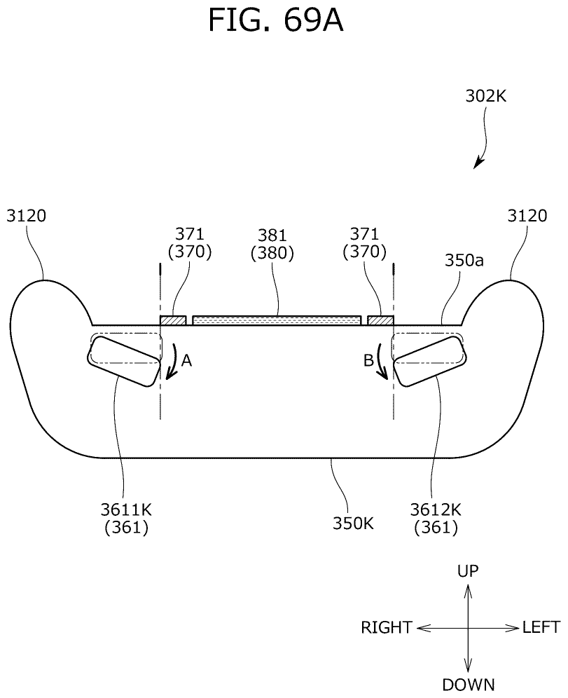

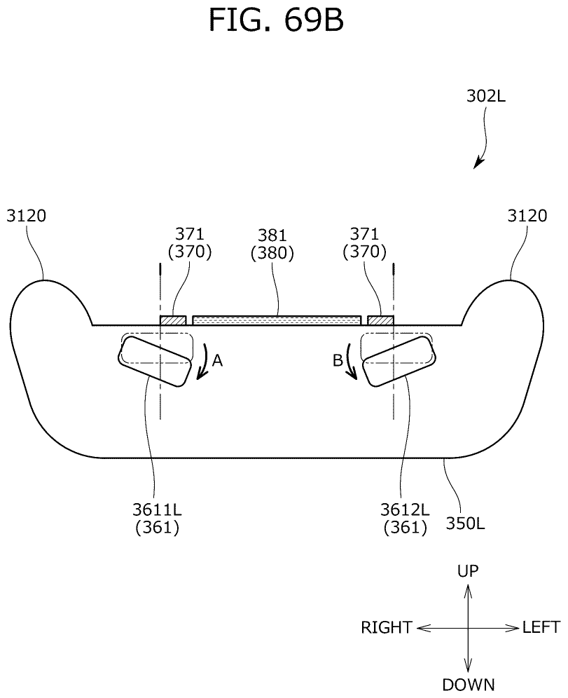

FIG. 69A is a schematic view of a seat cushion 302K showing the positional relationship of the heater device 380, the sensor device 370, and the vibrator 361.

As in the seat cushion 302I shown in FIG. 68A, the side support portions 3120 which are bank portions bulging toward the seated person are provided on both sides of the seat cushion 302K. Further, the heater wire portion 381 of the heater device 380 and the sensor units 371 of the sensor device 370 provided on both sides thereof are arranged on the seating surface 350a of the cushion pad 350K of the seat cushion 302K. The sensor device 370 is a biological detection means and is, for example, a pressure sensor that detects the seating state or the like.

The vibrator 361 of the seat cushion 302K is disposed on the outside in the seat width direction in relation to the side portion of the sensor unit 371. That is, a part of the vibrator 361 is disposed at a position that does not overlap with the heater wire portion 381 and the sensor unit 371 in the top view.

Even in such a case, as in a first vibrator 3611K on the right side, the vibrator 361 may be rotated in the direction of the arrow A of FIG. 69A to be disposed at an angle. Further, as in a second vibrator 3612K on the left side, the vibrator may be rotated in the direction of the arrow B of FIG. 69B to be disposed at an angle.

By disposing the vibrator 361 at an angle, the vibrator 361 can be separated from the sensor area (sensor unit 371), and the mutual influence can be suppressed.

FIG. 69B is a schematic view of the seat cushion 302K showing another example of the positional relationship of the heater device 380, the sensor device 370, and the vibrator 361.

As in the seat cushion 302K shown in FIG. 69A, the side support portions 3120 which are bank portions bulging toward the seated person are provided on both sides of a seat cushion 302L. Further, the heater wire portion 381 of the heater device 380 and the sensor units 371 of the sensor device 370 provided on both sides thereof are arranged on the seating surface 350a of a cushion pad 350L of the seat cushion 302L.

The vibrator 361 of the seat cushion 302L is disposed on the inside in the seat width direction in relation to the side portion of the sensor unit 371. That is, the vibrator 361 is disposed at a position that partially overlaps with the sensor unit 371 in the top view.

Even in such a case, the vibrator 361 may be rotated in the direction of the arrow A of FIG. 69B to be disposed at an angle as in a first vibrator 3611L on the right side. Further, the vibrator may be rotated in the direction of the arrow B of FIG. 69B to be disposed at an angle as in a second vibrator 3612L on the left side.

Even when the vibrator 361 and the sensor unit 371 overlap with each other in the top view, the vibrator 361 can be separated from the sensor area (sensor unit 371) by disposing the vibrator 361 at an angle, and the mutual influence can be suppressed.

In FIGS. 68A to 69B, although an example has been described in which the vibrator 361 is disposed on the seat cushion 302, the vibrator 360 is disposed at an angle on the seat back 301 to be separated from the heater device 380 or the sensor device 370. The mutual influence can be suppressed.

As described above, the conveyance seat S30 according to this embodiment has been described with reference to the drawings. Furthermore, in this embodiment, the present invention is applied to the conveyance seat S30 installed in the vehicle, but the seat provided with the vibrators 360 and 361 is not limited to the conveyance seat S30. The present invention can be applied to any ordinary chair or sofa as long as it has a seating surface. Further, the arrangement of the vibrator 360 of the seat back 301 described above may be applied to the vibrator 361 of the seat cushion 302 or the arrangement of the vibrator 361 of the seat cushion 302 may be applied to the vibrator 360 of the seat back 301.

### Fourth Embodiment

Hereinafter, fourth embodiment of the present invention will be described.

### Technical Field

The fourth embodiment of the present invention relates to a conveyance seat and particularly to a conveyance seat with a vibrator.

### Background Art

Conventionally, a technology is known in which a vibrator is disposed on a seat back or a seat cushion of a vehicle seat (for example, see JP-A-2000-225877). By vibrating the vibrator based on a signal obtained from a sensor or the like, it is possible to notify the occupants of, for example, the approach of another vehicle, an obstacle, or the like.

### SUMMARY OF INVENTION

### Technical Problem

However, in the conventional technology, the appropriate arrangement and structure of the relationship between the vibrator and other members such as a heater and a skin was not sufficiently considered. In particular, complex structures have been used to fix the vibrator.

Further, as another problem, there is also room for improvement in terms of the functionality of the vibrator itself, such as the performance of transmitting vibration to the occupant.

The present invention has been made in view of the above-described problems, and an object of the present invention is to provide a conveyance seat capable of more easily fixing a vibrator.

### Solution to Problem

According to the conveyance seat of the present invention, the above-described problems are solved by a conveyance seat including: a vibrator; and a pad having a recess in which the vibrator is disposed, in which the vibrator is fixed by a covering member that covers at least the recess and has a function other than fixing the vibrator in the recess.

According to the conveyance seat, sine the vibrator is fixed by the covering member having a function other than fixing the vibrator in the recess, the adhesive tape, cloth, slab, and the like previously required to fix the vibrator in the recess are no longer necessary and thus the vibrator is more easily fixed. Furthermore, since the adhesive tape and the like are no longer necessary, the number of components can be decreased and manufacturing costs can be decreased.

Further, in the above-described configuration, the covering member may be a sheet-shaped heating element that heats a seating surface.

Since the sheet-shaped heating element is used to fix the vibrator in the recess, the adhesive tape used to fix the vibrator is no longer necessary and thus the vibrator can be easily fixed. In addition, since the adhesive tape and the like are no longer necessary, the number of components can be decreased and manufacturing costs can be decreased.

Further, in the above-described configuration, the heating element is fixed to the pad by a fixing portion provided on the back surface of the heating element, and the fixing portion may be disposed at a position that overlaps with the vibrator.

Since the fixing portion for fixing the heating element is disposed at a position that overlaps with the vibrator, the fixing force for fixing the vibrator can be improved.

Further, in the above-described configuration, the heating element is fixed to the pad by a fixing portion provided on the back surface of the heating element, and the fixing portion may be disposed at a position that does not overlap with the vibrator.

Since the fixing portion for fixing the heating element is disposed at a position that does not overlap with the vibrator, the influence of the vibrator on the heater can be reduced.

Further, in the above-described configuration, the heating element may be configured so that the temperature of the area overlapping with the vibrator is different from the temperature of the area not overlapping with the vibrator.

The vibrator may absorb heat from the heating element, or the vibrator itself may generate heat and add heat. Since it is possible to eliminate differences due to heat absorption and heat generation using the vibrator by setting the temperature of the area overlapping with the vibrator to be different from the temperature of the non-overlapping area, for example, the heat transmitted to the occupant can be adjusted uniformly over the entire area of the heating element to prevent discomfort to the occupant.

Further, in the above-described configuration, the heating element may include a heater wire, and the vibrator overlapping with the heater wire may be disposed so that the longitudinal direction of the vibrator intersects with the heater wire extension direction at substantially a right angle.

Since the vibrator is disposed at a right angle to intersect the heater wire extension direction, the occupant is less likely to feel uncomfortable and the vibration can be applied in a natural manner.

Further, in the above-described configuration, the heating element may include the heater wire, and the vibrator overlapping with the heater wire may be disposed so that the longitudinal direction of the vibrator intersects with the heater wire extension direction at an acute or obtuse angle.

Since the vibrator is disposed to intersect with the heater wire extension direction at an acute or obtuse angle, the vector of the excessive load applied to the heater wire and the vibrator is shifted to the side, thereby reducing the influence on the heater wire (for example, breakage due to vibration, etc.).

Further, in the above-described configuration, the covering member may be a protective skin of the pad, the skin may be fixed to the pad by a surface fastener, and the surface fastener may be disposed at a position that overlaps with at least a part of the vibrator.

Since the vibrator is fixed to the recess using the protective skin, the vibrator can be easily fixed. Further, since the adhesive tape for fixing the vibrator is not required, the number of components can be decreased. Further, since the surface fastener is disposed to overlap with a part of the vibrator, the performance of the vibrator is less likely to be hindered.

Further, in the above-described configuration, the covering member may be a protective skin of the pad, the skin is fixed to the pad by a surface fastener, and the surface fastener may be disposed at a position that does not overlap with the vibrator.

Since the vibrator is fixed to the recess using the protective skin, the vibrator can be easily fixed. Further, since the adhesive tape for fixing the vibrator is not required, the number of components can be decreased. Further, since the surface fastener is disposed not to overlap with the vibrator, the performance of the vibrator is less likely to be hindered.

Further, in the above-described configuration, the covering member may be a protective skin of the pad, the skin may be fixed to the pad by a suspension portion, the pad may be provided with a suspension groove into which the suspension portion is inserted, and the vibrator may be disposed in the suspension groove.

Since the vibrator is fixed to the suspension groove using a protective skin, the vibrator can be easily fixed. Further, both the suspension groove and the vibrator can be provided, and the influence on the appearance of the skin can be suppressed.

Further, in the above-described configuration, the suspension member may be disposed at a position that avoids the vibrator.

Since the suspension member is disposed at a position that avoids the vibrator, both the suspension groove and the vibrator can be provided, and the influence on the appearance of the skin can be suppressed.

Further, in the above-described configuration, the vibrator may be provided with a directivity adjustment portion which directs the vibration of the vibrator in a predetermined direction.

Since the directivity adjustment portion is provided in the vibrator, the vibration can be more efficiently transmitted to the occupant.

Further, in the above-described configuration, the directivity adjustment portion may be a plate-shaped member that is disposed on an occupant side surface of the vibrator.

Since the directivity adjustment portion is made of a plate-shaped member, the directivity adjustment portion can be easily provided in the vibrator.

Further, in the above-described configuration, the directivity adjustment portion may be a seating surface side wall portion formed to be thicker than the other wall portions in the case of the vibrator.

Since the directivity adjustment portion is provided by forming the occupant side wall portion in the case of the vibrator to be thick, the directivity adjustment portion can be provided without increasing the number of components.

### Advantageous Effects of Invention

According to the conveyance seat of the fourth embodiment of the present invention, since the vibrator is fixed by the covering member having a function other than fixing the vibrator in the recess, the adhesive tape, cloth, slab, and the like previously required to fix the vibrator in the recess are no longer necessary and thus the vibrator is more easily fixed. Furthermore, since the adhesive tape and the like are no longer necessary, the number of components can be decreased and manufacturing costs can be decreased.

Further, since the vibrator is fixed in the recess by using the sheet-shaped heating element, the adhesive tape used to fix the vibrator is no longer necessary and thus the vibrator can be easily fixed. In addition, since the adhesive tape and the like are no longer necessary, the number of components can be decreased and manufacturing costs can be decreased.

Further, since the fixing portion for fixing the heating element is disposed at a position that overlaps with the vibrator, the fixing force for fixing the vibrator can be improved.

Further, since the fixing portion for fixing the heating element is disposed at a position that does not overlap with the vibrator, the influence of the vibrator on the heater can be reduced.

Further, since it is possible to eliminate differences due to heat absorption and heat generation using the vibrator by setting the temperature of the area overlapping with the vibrator to be different from the temperature of the non-overlapping area, for example, the heat transmitted to the occupant can be adjusted uniformly over the entire area of the heating element to prevent discomfort to the occupant.

Further, since the vibrator is disposed at a right angle to intersect the heater wire extension direction, the occupant is less likely to feel uncomfortable and the vibration can be applied in a natural manner.

Further, since the vibrator is disposed to intersect with the heater wire extension direction at an acute or obtuse angle, the vector of the excessive load applied to the heater wire and the vibrator is shifted to the side, thereby reducing the influence on the heater wire (for example, breakage due to vibration, etc.).

Further, since the vibrator is fixed to the recess using the protective skin, the vibrator can be easily fixed. Further, since the adhesive tape for fixing the vibrator is not required, the number of components can be decreased. Further, since the surface fastener is disposed to overlap with a part of the vibrator, the performance of the vibrator is less likely to be hindered.

Further, since the vibrator is fixed to the recess using the protective skin, the vibrator can be easily fixed. Further, since the adhesive tape for fixing the vibrator is not required, the number of components can be decreased. Further, since the surface fastener is disposed not to overlap with the vibrator, the performance of the vibrator is less likely to be hindered.

Further, since the vibrator is fixed to the suspension groove using a protective skin, the vibrator can be easily fixed. Further, both the suspension groove and the vibrator can be provided, and the influence on the appearance of the skin can be suppressed.

Further, since the suspension member is disposed at a position that avoids the vibrator, both the suspension groove and the vibrator can be provided, and the influence on the appearance of the skin can be suppressed.

Further, since the directivity adjustment portion is provided in the vibrator, the vibration can be more efficiently transmitted to the occupant.

Further, since the directivity adjustment portion is made of a plate-shaped member, the directivity adjustment portion can be easily provided in the vibrator.

Further, since the directivity adjustment portion is provided by forming the occupant side wall portion in the case of the vibrator to be thick, the directivity adjustment portion can be provided without increasing the number of components.

### Description of Embodiments

Hereinafter, the configuration of a conveyance seat according to a fourth embodiment of the present invention will be described with reference to the drawings. However, the embodiment described below is an example for facilitating understanding of the present invention, and is not intended to limit the present invention. In other words, the present invention can be modified or improved without departing from the spirit of the invention, and it goes without saying that the present invention includes equivalents thereof.

Hereinafter, a vehicle seat will be taken as an example of a conveyance seat, and a configuration example thereof will be described. However, the present invention is not limited to vehicle seats installed in vehicles that have wheels and travel on land, such as automobiles and trains, but may also be seats installed in aircraft, ships, and other vehicles that move other than on land.

Further, in the following description, the “front to rear direction” refers to the front to rear direction of the conveyance seat and coincides with the travel direction when the vehicle is traveling. Further, the “seat width direction” refers to the width direction of the conveyance seat and coincides with the right to left direction as viewed from the occupant (seated person) seated on the conveyance seat. Further, the “up to down direction” refers to the up to down direction of the conveyance seat and coincides with the vertical direction when the vehicle travels on a horizontal plane.

Further, the shape, position, and posture of each part of the conveyance seat described below will be described assuming that the conveyance seat is in a seated state, that is, the seat back is not tilted forward or backward, unless otherwise specified.

### First Example

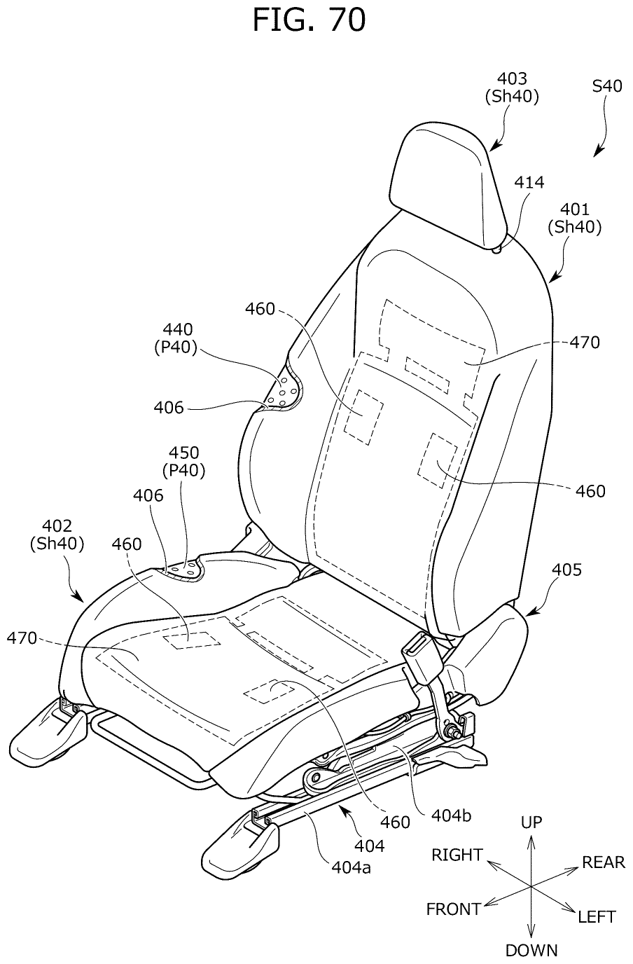

The basic configuration of a conveyance seat S40 according to a first example of this embodiment will be described with reference to FIG. 70. FIG. 70 is a perspective view of the conveyance seat S40, and for convenience of illustration, a part of the conveyance seat S40 in FIG. 70 is shown with a skin 406 removed to expose a pad P40.

The conveyance seat S40 is a seat which is placed on the floor of the vehicle and on which the occupant of the vehicle (hereinafter, sometimes referred to as a seated person) is seated. In this embodiment, the conveyance seat S40 is used as a front seat corresponding to the front seat of the vehicle. However, the present invention is not limited thereto, and the conveyance seat S40 can also be used as a rear seat, and can also be used as a second-row middle seat or a third-row rear seat in a vehicle having three rows of seats in the front to rear direction.

As shown in FIG. 70, the conveyance seat S40 mainly includes a seat back 401 that supports the back of the seated person, a seat cushion 402 that supports the buttocks of the seated person, and a headrest 403 that is disposed on the upper portion of the seat back 401 and supports the head of the seated person. Furthermore, the seat back 401, the seat cushion 402, and the headrest 403 may be collectively referred to as a seat body Sh40.

The seat back 401 and the seat cushion 402 are connected to each other with a reclining mechanism 405 interposed therebetween. The seat back 401 is rotatable relative to the seat cushion 402 by the reclining mechanism 405, and the tilt angle is adjustable.

A headrest pillar 431 extends downward from the headrest 403, and is connected to the upper end of the seat back 401.

Further, a rail device 404 is provided in the lower portion of the conveyance seat S40. The conveyance seat S40 is attached to the vehicle floor by the rail device 404 so that the seat body Sh40 is slidable in the front to rear direction. The rail device 404 includes a lower rail 404a which is fixed onto the vehicle floor and an upper rail 404b which is slidable relative to the lower rail 404a.

### Seat Frame F40

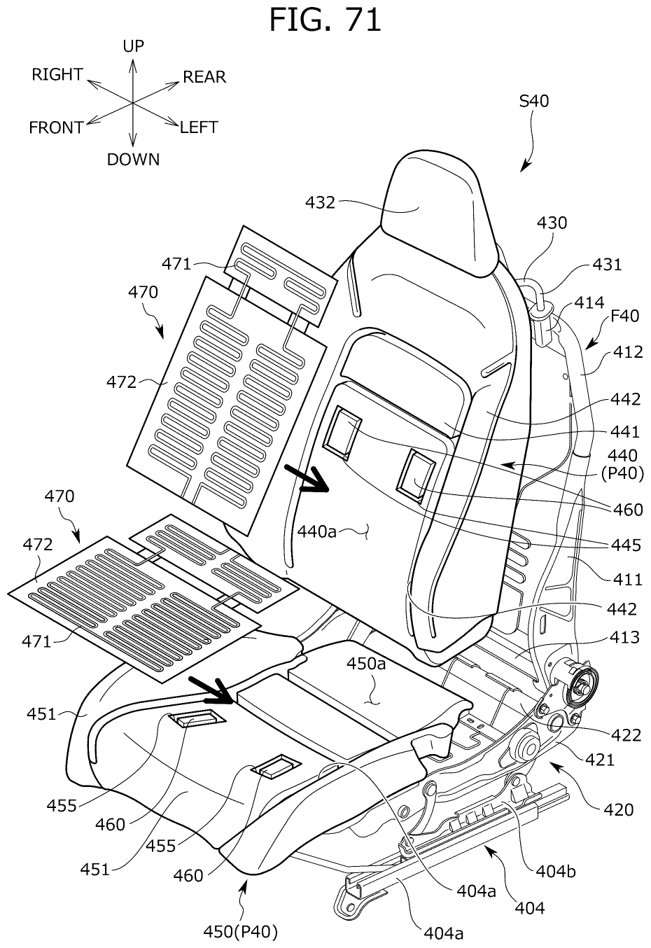

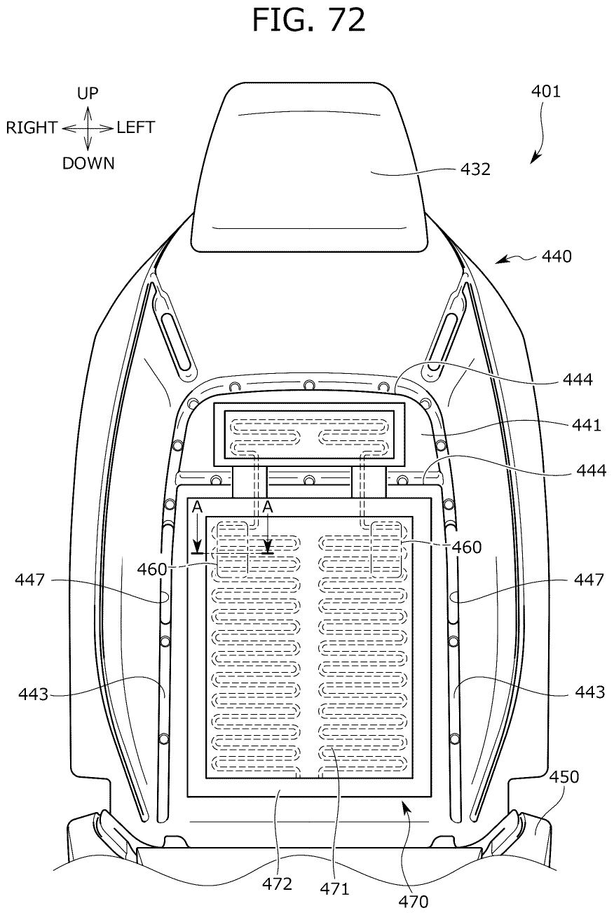

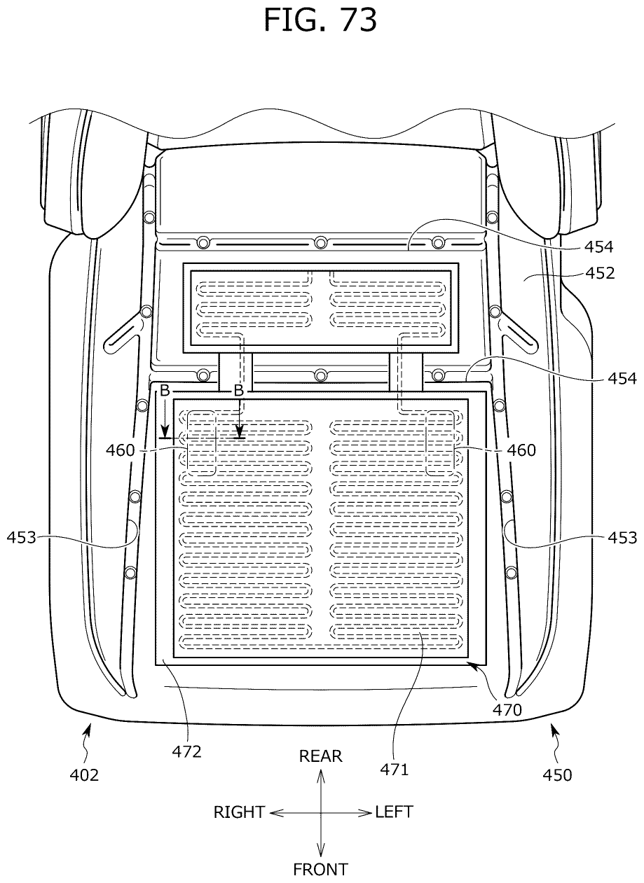

The basic configuration of a seat frame F40 which forms a framework 4 the conveyance seat S40 will be described with reference to FIG. 71. FIG. 71 is an exploded perspective view showing the configuration of the conveyance seat S40 with the skin 406 removed, and shows the seat frame F40, the pad P40, and a heater 470 (heating element). FIG. 72 is a front view showing the seat back 401 with a skin removed, and FIG. 73 is a top view showing the seat cushion 402.

As shown in FIG. 71, the seat frame F40 is provided inside the conveyance seat S40. The seat frame F40 includes a seat back frame 410 which forms a framework of the seat back 401, a seat cushion frame 420 which forms a framework of the seat cushion 402, and a headrest frame 430 which forms a framework of the headrest 403.

As shown in FIG. 71, the seat back frame 410 includes a pair of back side frames 411 and 411 which are formed in a frame shape as a whole and are arranged on the right and left sides, an upper frame 412, and a lower frame 413. The upper frame 412 is provided with a pair of headrest holders 414 through which the headrest pillar 431 of the headrest 403 is inserted.

As shown in FIG. 71, the seat cushion frame 420 is formed in a rectangular frame shape in the top view of the conveyance seat S40, and a pair of cushion side frames 421 and 421 are formed on the right and left sides thereof. The pair of cushion side frames 421 and 421 are basically members that are configured symmetrically on the right and left sides, and are provided to extend in the front to rear direction of the seat.

Further, the seat cushion frame 420 includes a front connection frame (not shown) which connects the pair of cushion side frames 421 and 421 at the front side and a rear connection frame 422 which connects them at the rear side. Further, a plate-shaped pan frame is provided in front of the front connection frame. Further, the seat cushion frame 420 is provided with a cushion pressure receiving member 425 that is disposed between the front connection frame and the rear connection frame 422 to bridge them. The cushion pressure receiving member 425 can support the buttocks of the seated person from below.

As described above, the headrest frame 430 is a member that forms a framework of the headrest 403. The headrest frame 430 is formed in an inverted U-shape in the front view, and can be attached to the upper end of the seat back 401 by inserting the headrest pillar 431 extending downward into the headrest holder 414.

### Pad P40

The pad P40 will be described with reference to FIG. 71. The pad P40 includes a back pad 440 which is attached to the seat back frame 410, a cushion pad 450 which is attached to the seat cushion frame 420, and a headrest pad 432 which is attached to the headrest frame 430. The pad P40 is made of a urethane base material formed by foam molding using, for example, a urethane foam material.

Further, each of the back pad 440, the cushion pad 450, and the headrest pad 432 is covered with the skin 406. The skin 406 is made of, for example, cloth, synthetic leather, or genuine leather.

### Back Pad 440

The back pad 440 includes a main body 441 which supports the back of the occupant and a bank portion 442 which supports the back from the sides. Further, as shown in FIGS. 71 and 72, two vertical suspension grooves 443 extending in the up to down direction and a horizontal suspension groove 444 extending in the seat width direction are provided. The vertical suspension groove 443 is formed in the boundary part between the main body 441 and the bank portion 442. Further, the horizontal suspension groove 444 connects the upper end parts of two vertical suspension grooves 443.

Further, a through hole 447 is formed in a part of the vertical suspension groove 443 along the vertical suspension groove 443. Since the through hole 447 is formed, the back pad 440 is easily deformed. Further, the through hole 447 is disposed at a position that overlaps with a vibrator 460 to be described later in the up to down direction, and the through hole 447 can absorb the deformation of the vibrator 460.

### Cushion Pad 450

The cushion pad 450 includes a main body 451 which supports the buttocks of the occupant and a bank portion 452 which supports the buttocks from the sides. Further, as shown in FIG. 73, the cushion pad 450 is provided with a vertical suspension groove 453 which extends in the front to rear direction and a horizontal suspension groove 454 which extends in the seat width direction. The vertical suspension groove 453 is disposed between the main body 441 and the bank portion 452. Further, the horizontal suspension groove 444 connects two vertical suspension grooves 453 and 453.

### Vibrator 460

The vibrator 460 is a device that applies a vibration to the seated occupant. In this embodiment, as shown in FIG. 71, the back pad 440 is provided with two vibrators 460. Further, the cushion pad 450 is also provided with two vibrators 460. The vibrator 460 provided in the back pad 440 and the vibrator 460 provided in the cushion pad 450 have the same mechanism.

Furthermore, the positions and numbers of the vibrators 460 shown in FIGS. 71 to 73 are merely examples, and the number of vibrators 460 provided on the back pad 440 or the cushion pad 450 may be one, or two or more vibrators 460 may be provided on the back pad 440 or the cushion pad 450.

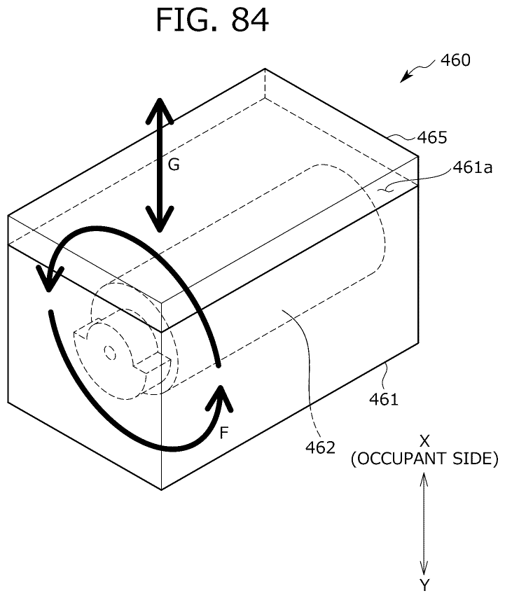

The vibrator 460 includes a case 461 and an eccentric motor 462 which is stored in the case 461 and generates a vibration (see FIG. 84). Furthermore, a linear vibration actuator or a piezoelectric element may be used to generate the vibration of the vibrator 460. Further, a harness 463 extends from the eccentric motor 462 of the vibrator 460 and is connected to an ECU (not shown) installed in the vehicle. The ECU can control the strength and timing of the vibration of the vibrator 460.

### Storage Recess 445

As shown in FIG. 71, a storage recess 445 which stores the back side vibrator 460 is formed in a seating surface 440a of the back pad 440. The vibrator 460 can be attached by inserting the vibrator 460 into the storage recess 445.

Further, as shown in FIG. 71, the storage recess 455 which stores the cushion side vibrator 460 is also formed in a seating surface 450a of the cushion pad 450. The vibrator 460 can be attached by inserting the vibrator 460 into the storage recess 455.

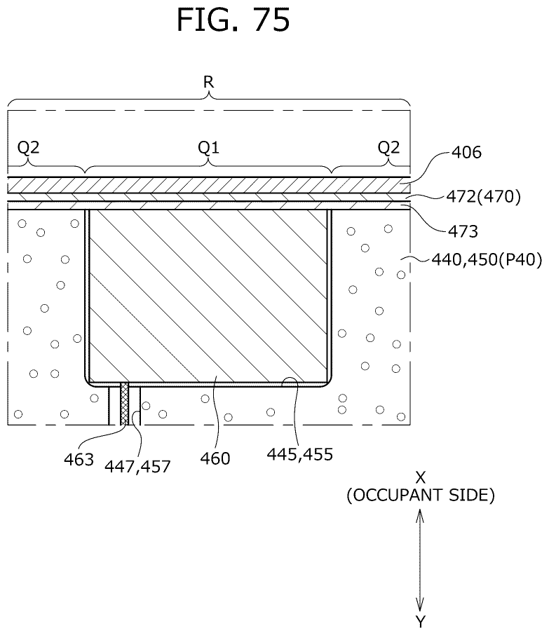

Further, as shown in FIG. 75, the bottom surfaces of the storage recesses 445 and 455 are provided with harness holes 446 and 456 through which the harness 463 extending from the vibrator 460 is passed, and the harness 463 can be pulled into the back surface of the back pad 440 or the bottom surface of the cushion pad 450.

Furthermore, the harness holes 446 and 456 are not limited to the bottom surface, but may be formed in the side walls of the storage recesses 445 and 455. In this case, for example, the harness 463 is passed through the side walls of the storage recesses 445 and 455 and the horizontal suspension grooves 444 and 454, and harness holes 446 and 456 are formed from the bottom portions of the horizontal suspension grooves 444 and 454 to the back surface of the back pad 440 and the bottom surface of the cushion pad 450. Further, the harness 463 may be pulled into the back surface of the back pad 440 or the bottom surface of the cushion pad 450 by using the suspension holes formed in the horizontal suspension grooves 444 and 454.

### Heater 470

As shown in FIG. 71, the sheet-shaped heater 470 is disposed on the seating surfaces 440a and 450a of the main bodies 441 and 451 of the back pad 440 and the cushion pad 450.

The heater 470 is a heater wire 471 (electric heating wire) that is disposed in a meandering manner on a sheet-shaped base fabric 472, and is disposed along the seating surfaces 440a and 440a in a flexible manner. The base fabric 472 is made of, for example, a nonwoven fabric.

The heater wire 471 is made of a material (for example, a metal wire or film) that generates heat when a current flows through the heater wire. Both ends of the heater wire 471 are connected to an ECU (not shown) So that the temperature can be adjusted by the ECU.

### Fixing Structure for Vibrator 460

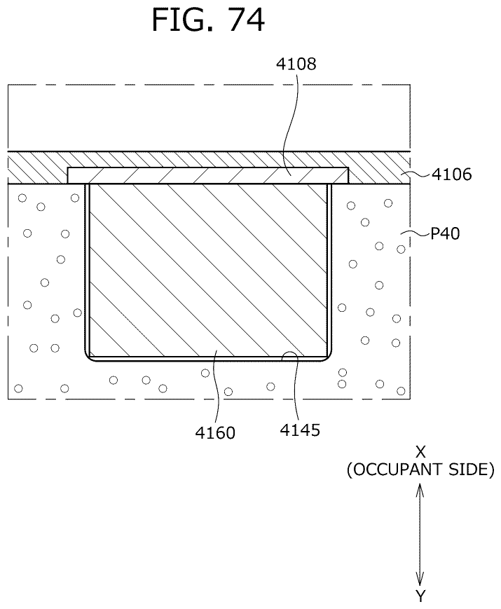

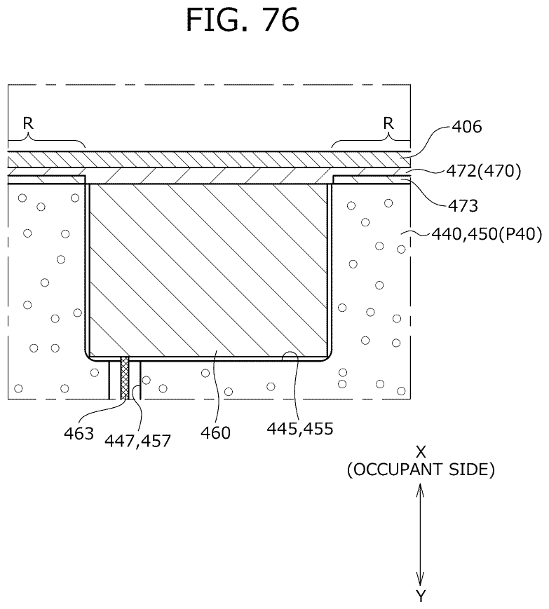

Hereinafter, the fixing structure for the vibrator 460 disposed on the back pad 440 and the cushion pad 450 will be described with reference to FIGS. 74 to 7. FIG. 74 is a cross-sectional view schematically showing a fixing structure for a conventional vibrator 4160, and FIGS. 75 and 76 are diagrams showing a fixing structure for the vibrator 460 of this embodiment and cross-sectional views taken along line A-A of FIG. 72 or line B-B of FIG. 73. Furthermore, in FIGS. 74 to 76, the direction of the arrow X indicates the occupant side, that is, the direction in which the seating surfaces 440a and 450a of the back pad 440 and the cushion pad 450 are located, and the direction of the arrow Y indicates the opposite side of the occupant, that is, the back surface of the back pad 440 or the cushion pad 450 is located.

In the past, as shown in FIG. 74, the vibrator 4160 is fixed to the pad P40 by inserting the vibrator 4160 into a storage recess 4145 and adhering an adhesive tape 4108 to the periphery of the opening of the storage recess 4145. Then, a skin 4106 is attached while the vibrator 4160 is fixed to the pad P40.

In the conveyance seat S40 of this embodiment, the vibrator 460 is fixed into the storage recess 445 by inserting the vibrator 460 into the storage recess 445, disposing the sheet-shaped heater 470 instead of the adhesive tape, and fixing the heater 470 to the back pad 440 or the cushion pad 450. The heater 470 is attached to the back pad 440 or the cushion pad 450 by an adhesive 473 (fixing portion), for example, a double-sided tape. The vibrator 460 is fixed to the storage recess 445 by the adhered heater 470. That is, the vibrator 460 is fixed to the storage recess 445 by the sheet-shaped heater 470 having a function other than fixing the vibrator 460 (a function of heating the seat surface).

Since the work of adhering the adhesive tape around the periphery of the storage recess as in the conventional fixing structure shown in FIG. 74 is no longer necessary, the vibrator 460 can be fixed more easily. Furthermore, since the adhesive tape conventionally used for fixing the vibrator is no longer necessary, the number of components can be decreased and manufacturing costs can be decreased. Furthermore, as shown in FIG. 75, an adhesive area R of the adhesive 473 may overlap with the vibrator 460. That is, when viewed from the occupant side, the adhesive area R for attaching the heater 470 to the back pad 440 or the cushion pad 450 may overlap with the vibrator 460. In other words, the adhesive 473 (fixing portion) may be disposed between the vibrator 460 and the heater 470. Since the adhesive area R overlaps with the vibrator 460, the fixing force for fixing the vibrator 460 by the heater 470 is improved.

Further, the adhesive area R of the adhesive 473 may be offset from the vibrator 4460 as shown in FIG. 76. That is, when viewed from the occupant side, the adhesive area R may be disposed not to overlap with the vibrator 460. Since the vibrator 460 is not adhered to the heater 470, the influence of the vibration of the vibrator 460 on the heater 470 (for example, breakage of the heater wire 471, etc.) is reduced.

Depending on the material and type of the vibrator 460, when the vibrator 460 comes into contact with the heater 470, the vibrator 460 may take heat from the heater 470, that is, the vibrator 460 may absorb heat from the heater 470. Furthermore, the vibrator 460 itself may generate heat due to vibration, which may heat the heater 470. Therefore, the temperature transmitted to the occupant may differ depending on the location.

Therefore, in the configuration in which the heater 470 is disposed on the vibrator 460, the area Q1 (see FIG. 75) overlapping with the vibrator 460 is set to have a higher temperature or is configured to have a lower temperature than the area Q2 not overlapping with the vibrator 460. That is, the amount of heat generated by heater 470 is adjusted so that the temperature transmitted to the occupant becomes uniform over the entire range of heater 470.

The following methods can be used to increase the temperature of heat generated only in the area overlapping with the vibrator 460. One is to arrange the heater wires 471 in the area Q1 that overlaps with the vibrator 460 more densely than in the other area Q2 that does not overlap. That is, since the interval at which the heater wire 471 is folded back is decreased to increase the amount of heat generated per unit area, the temperature of heat generated in the heater wire 471 is higher than that in the other non-overlapping area Q2.

Further, the heater wire 471 may be provided in different systems for the overlapping area Q1 and the non-overlapping area Q2. That is, the heater wire 471 disposed in the overlapping area Q1 and the heater wire 471 disposed in the non-overlapping area Q2 are controlled separately, and the wattage of the power flowing via the heater wire 471 in the overlapping area Q1 is set to be high.

Since the temperature of heat is controlled to be high only in the overlapping area Q1 in consideration of the heat taken away by the vibrator 460, the temperature can be made uniform over the entire area of the heater 470.

Further, the following methods can be used to decrease the temperature of heat generated in the area Q1 overlapping with the vibrator 460.

One is to arrange the heater wires 471 in the area Q1 that overlaps with the vibrator 460 more sparsely than in the other area Q2 that does not overlap. That is, since the interval at which the heater wire 471 is folded back is increased to decrease the amount of heat generated per unit area, the temperature of generated heat is lower than that of the other non-overlapping area Q2.

Further, as in the case of increasing the temperature, the heater wires may be provided in different systems for the overlapping area Q1 and the non-overlapping area Q2. That is, the wattage of the power flowing via the heater wire 471 is set to be low so that the temperature is low only in the overlapping area Q1 by separately controlling the heater wire 471 disposed in the overlapping area Q1 and the heater wire 471 disposed in the non-overlapping area Q2.

Since the temperature is controlled to be low only in the overlapping area Q1 in consideration of the heat generated by the vibrator 460, the temperature can be made uniform over the entire area of the heater 470.

Further, a heat absorbing member, such as a cloth material, may be disposed between the vibrator 460 and the heater 470 so that the temperature is low only in the overlapping area Q1.

Next, the positional relationship of the vibrator 460 with respect to the heater wire 471 will be described with reference to FIGS. 72, 73, 77A, and 77B.

As described above, the heater wires 471 meander on the base fabric 472, and are arranged so as to be parallel to each other at equal intervals except for the bent portions.

In this embodiment, as shown in FIGS. 72 and 73, the vibrator 460 is disposed so that the longitudinal direction of the vibrator 460 (the up to down direction of FIG. 72 or the front to rear direction of FIG. 73) intersects with the extension direction of the heater wire 471 (the seat width direction, the right to left direction of FIGS. 72 and 73) at substantially a right angle. Such an arrangement provides a more natural situation for the occupant, that is, a state in which the occupant is less likely to feel uncomfortable.

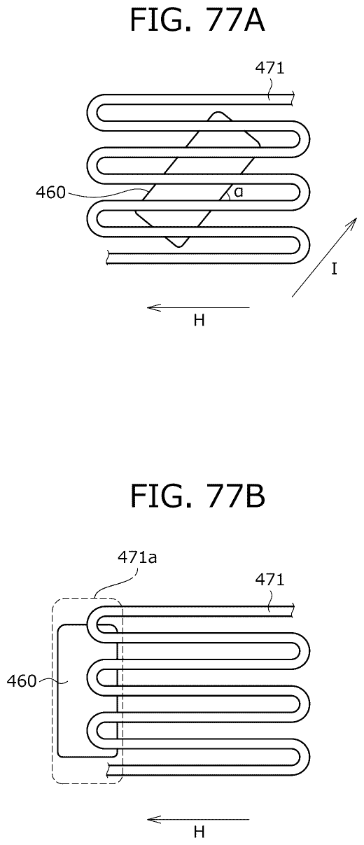

Further, as shown in FIG. 77A, the vibrator 460 may be disposed so that the longitudinal direction thereof (the direction of the arrow I of FIG. 77) intersects with the extension direction of the heater wire 471 (the direction of the arrow H of FIG. 77A) at an acute or obtuse angle. By making the intersecting angle a an acute angle or an obtuse angle, the vector of the excess load (boundary part) applied to the heater wire 471 with the vibrator 460 is shifted sideways, thereby reducing the impact on the heater wire 471, such as breakage due to vibration.

Further, as shown in FIG. 77B, the vibrator 460 and the bent portion 471a of the heater wire 471 may be arranged to overlap with each other.

### Second Example

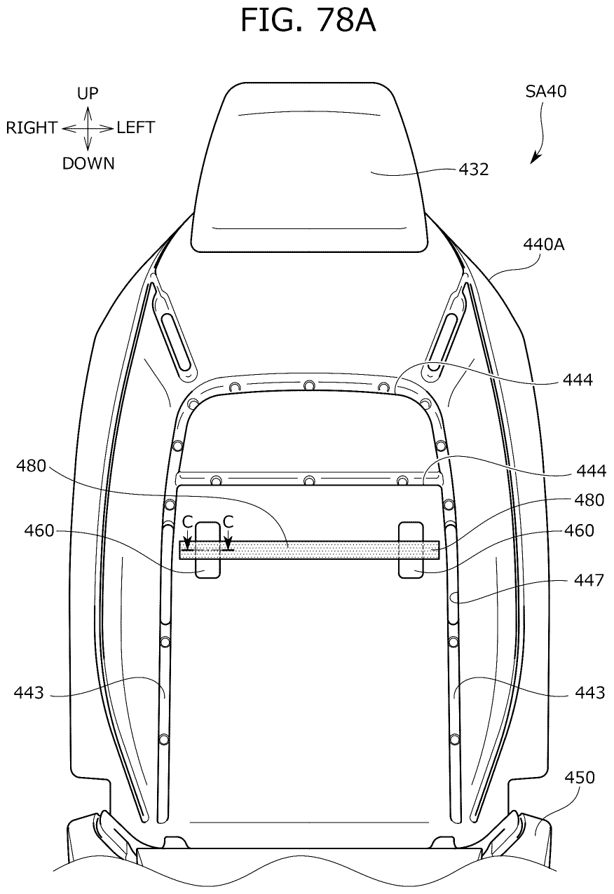

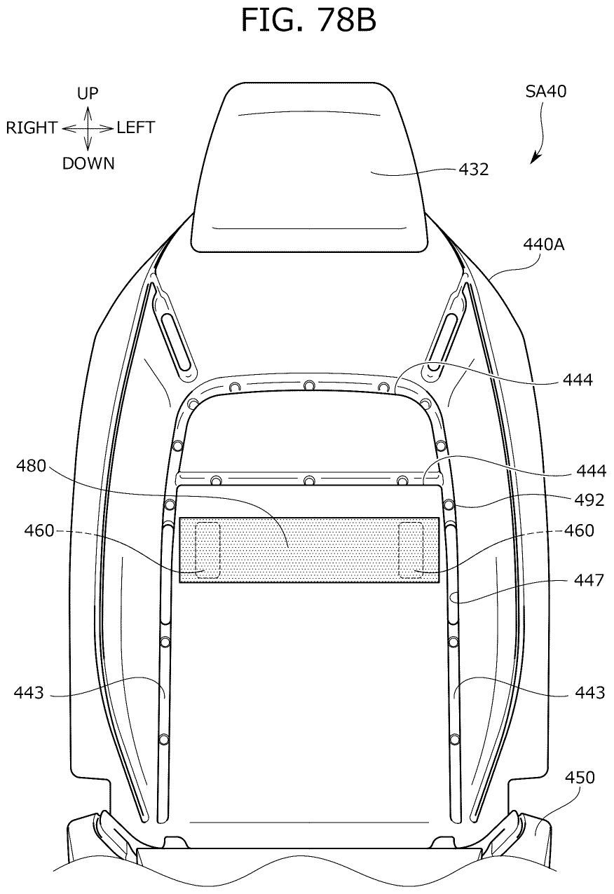

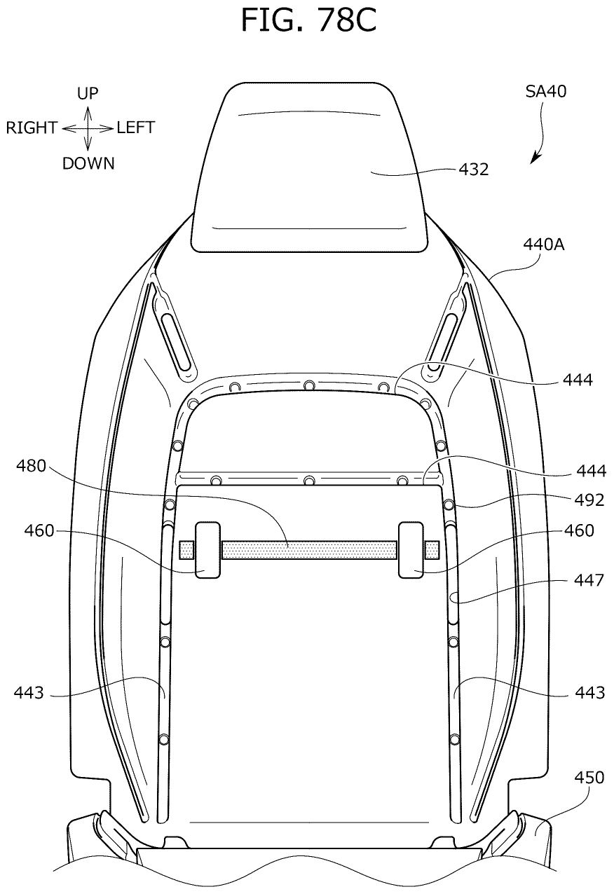

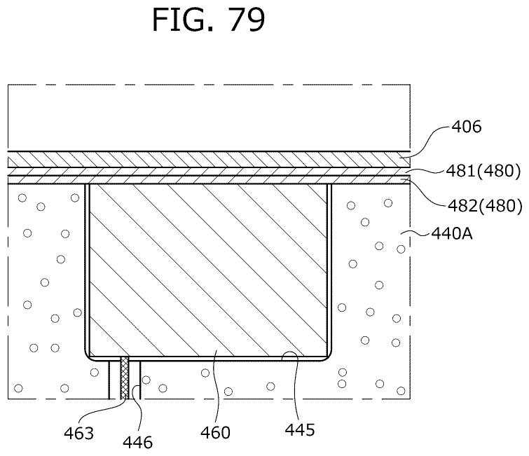

Next, a second example of this embodiment will be described with reference to FIGS. 78A to 79. FIGS. 78A to 78C are front views showing a back pad 440A of a conveyance seat SA40 of the second example and diagrams showing the position of a surface fastener 480 overlapping with the vibrator. FIG. 79 is a cross-sectional view taken along line C-C of FIG. 78 and a diagram showing the positional relationship between the surface fastener 480 and the vibrator 460.

In the conveyance seat S40 of the first example, the sheet-shaped heater 470 is used to fix the vibrator 460, but in the conveyance seat SA40 of the second example, the protective skin 406 (covering member) of the pad P40 is used to fix the vibrator 460. Hereinafter, the same reference numerals will be used for the same or equivalent members as those in the structure shown in FIGS. 70 and 71, and the description thereof will be omitted.

The conveyance seat SA40 of the second example includes the vibrator 460 and the back pad 440 formed in the storage recess 445 in which the vibrator 460 is disposed. The vibrator 460 is disposed at a position overlapping with the vibrator 460 and is fixed by the protective skin 406 of the pad P40.

As shown in FIG. 79, the skin 406 is fixed to the back pad 440 (pad P40) by the surface fastener 4080 attached to the back surface of the skin 406.

More specifically, as shown in FIG. 79, a skin side fastener member 481 that is a hook portion of the surface fastener 480 is attached to the back surface of the skin 406, and a pad side fastener member 482 that is a loop portion of the surface fastener 480 is attached to the front surface of the back pad 440A. The skin side fastener member 481 and the pad side fastener member 482 are fixed to the skin 406 and the back pad 440 by known fixing means such as adhesive or clips. The skin 406 can be fixed to the back pad 440 by the surface fastener 480.

As shown in FIG. 78A, the surface fastener 480 is disposed at a position that overlaps with a part of the vibrator 460. In other words, the vibrator 460 is disposed to be located inside the surface fastener 480 when viewed from the occupant side. Since the surface fastener 480 overlaps with a part of the vibrator 460, the vibrator 460 can be fixed while suppressing the deterioration of performance.

In this way, since the surface fastener 480 is used to fix the skin 406 to the back pad 440, the vibrator 460 can be fixed to the storage recess 445 without using an adhesive tape or the like that has been used conventionally for fixing the vibrator 460. Further, both the surface fastener 480 and the vibrator 460 can be provided.

Although the surface fastener 480 shown in FIG. 78A is fixed to the storage recess 445 while overlapping with a part of the vibrator 460, the surface fastener 480 may be disposed to cover the entire vibrator 460 as shown in FIG. 78B. Since the surface fastener 480 covers the entire vibrator 460, the influence on the appearance, such as bulging and wrinkles on the skin, can be suppressed.

Further, as shown in FIG. 78C, the surface fastener 480 may not directly overlap with the vibrator 460. By disposing the surface fastener 480 with the vibrator 460 interposed therebetween, the performance of the vibrator 460 is less likely to deteriorate.

Furthermore, FIGS. 78A to 78C show the surface fastener 480 that fixes the skin 406 to the back pad 440, but the surface fastener 480 may be used to fix the skin 406 to the cushion pad 450. The surface fastener 480 may be disposed at a position that overlaps with a part of the vibrator 460 provided in the cushion pad 450, and the surface fastener 480 may be disposed to cover the entire vibrator 460 provided in the cushion pad 450. The surface fastener 480 may be disposed to sandwich the vibrator 460 provided in the cushion pad 450.

### Arrangement Inside Vertical Suspension Groove 443

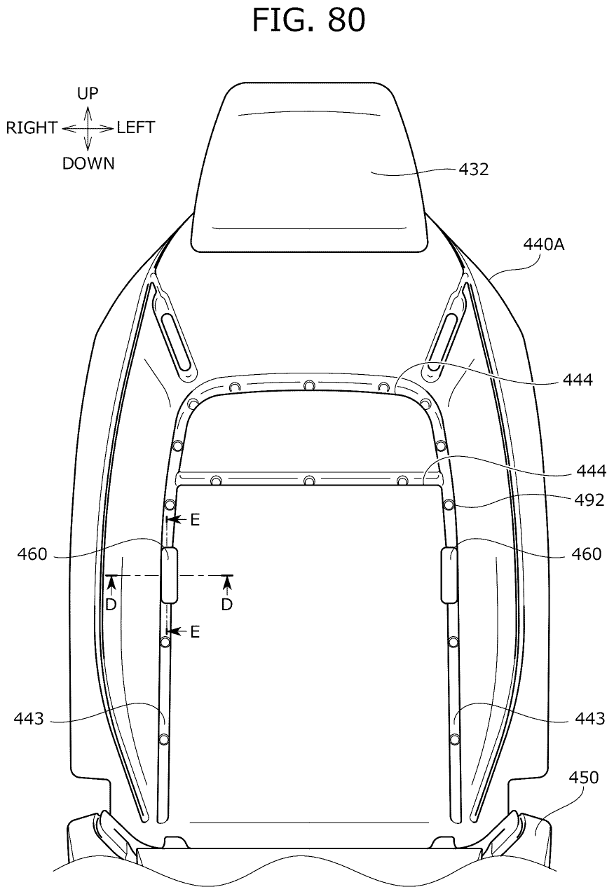

As shown in FIG. 80, the vibrator 460 may be disposed inside the vertical suspension groove 443 for suspending the skin 406.

By disposing the vibrator 460 inside the vertical suspension groove 443, the vertical suspension groove 443 can be used instead of the storage recess 445 storing the vibrator 460. Accordingly, for example, the influence on the appearance of the skin 406 can be suppressed.

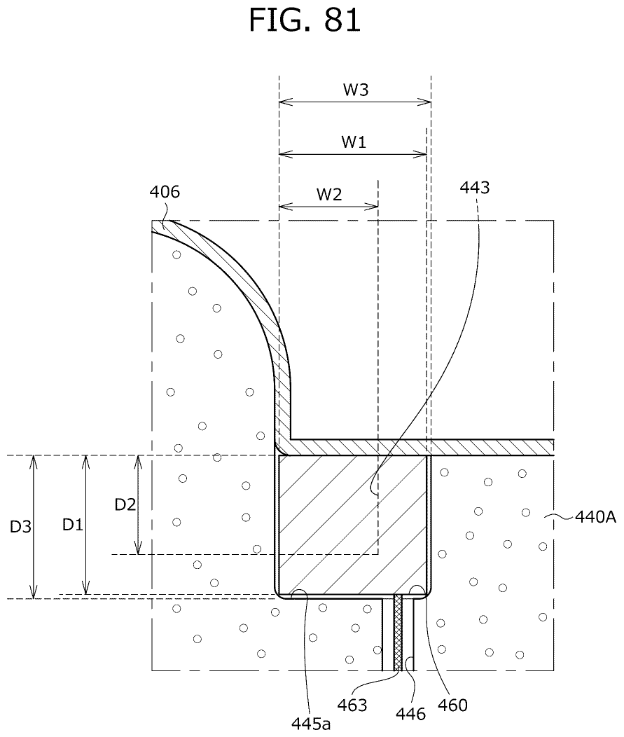

Furthermore, since the width W1 of the vibrator 460 is larger than the width W2 of the normal vertical suspension groove 443, as shown in FIG. 81, the width W3 of the vertical suspension groove 443 where the vibrator 460 is disposed is formed to be wider than the width W2 of the other portions.

Further, since the height D1 of the vibrator 460 is also larger than the depth D2 of the normal vertical suspension groove 443, the depth D3 of the portion where the vibrator 460 is disposed is formed to be larger than the depth D2 of the other portions.

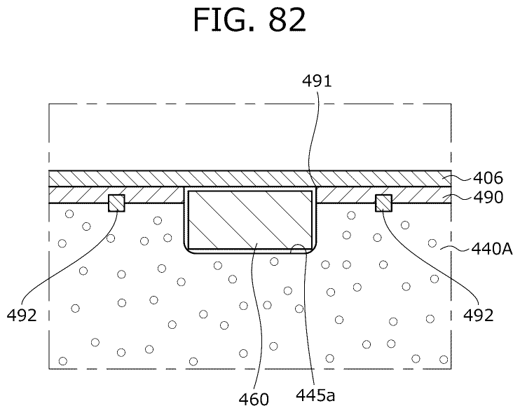

Further, as shown in FIG. 82, a suspension portion 490 for suspending is provided on the back surface of the skin 406, and the skin 406 is fixed by engaging the suspension portion 490 with a wire member such as a C-ring insert-molded in the pad or a clip member (engagement portion).

Furthermore, when the vibrator 460 is disposed in the vertical suspension groove 443, the suspension portion 490 interferes with the vibrator 460. Therefore, as shown in FIG. 82, a relief portion 491 is formed in the part that overlaps with the vibrator 460 in the suspension portion 490, and the interference between the vibrator 460 and the suspension portion 490 can be avoided when the skin 406 is suspended.

In the back pad 440A shown in FIGS. 81 and 82, the vibrator 460 is disposed in the vertical suspension groove 443, but the vibrator 460 may be disposed in the horizontal suspension groove 444. Further, the cushion pad 450 may also have the same configuration. That is, the vibrator 460 may be disposed in the vertical suspension groove 453 or the horizontal suspension groove 454 of the cushion pad 450.

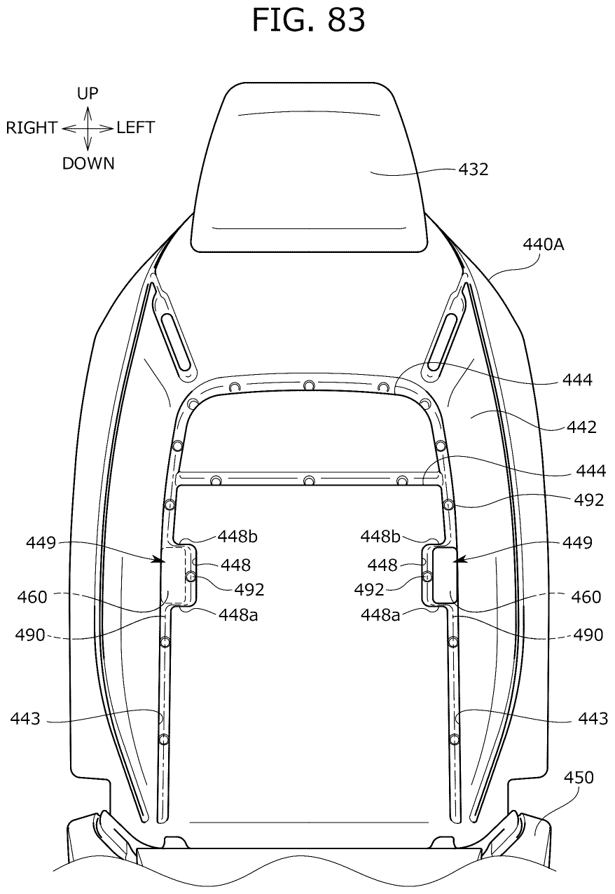

Further, as in the back pad 440A shown in FIG. 83, when the vibrator 460 (shown by a dotted line in FIG. 83) is disposed in the vertical suspension groove 443, the vertical suspension groove 443 may be formed to be bent and avoid the vibrator 460.

That is, an island 449 for disposing the vibrator 460 is disposed near the bank portion 442, and a bent portion 448 of the vertical suspension groove 443 is formed to avoid the island 449. The vibrator 460 is disposed inside the storage recess provided in the island 449. Accordingly, both the vertical suspension groove 443 and the vibrator 460 can be provided, and the influence on the appearance of the skin 406 can be suppressed.

As shown in FIG. 83, the vertical suspension groove 443 may be disposed to avoid the island 449 toward the inside of the seat. Further, the vertical suspension groove 443 may be disposed to avoid the island 449 toward the outside of the seat.

A skin fixing point 492 that fixes the skin 406 may be disposed on the bent portion 448 that avoids the island 449 of the vertical suspension groove 443. The lifting of the skin 406 at the bent portion 448 can be suppressed.

The skin fixing point 492 is, for example, a wire member insert-molded in the pad or a clip member such as a C-ring.

Further, in the suspension portion 490 of the skin 406, the relief portion 491 may be formed in the portion from a start point 448a to an end point 448b of the bent portion 448 of the vertical suspension groove 443. By forming the relief portion 491, it is easy to suspend the skin 406.

### Directivity Adjustment Portion 465

The eccentric motor built in the conventional vibrator generates a centrifugal force in all directions to be vibrated, so the vibration has no directionality and occurs even in directions that do not need to be transmitted. However, since the vibrator 460 used in this embodiment is fixed to the seat back 401 or the seat cushion 402, the direction of vibration that should be transmitted is limited to the occupant side. Therefore, it is more efficient if the vibration can be directed toward the occupant.

The vibrator 460 used in this embodiment is a vibrator in which the eccentric motor 462 is provided inside the case 461, and a directivity adjustment portion 465 is provided on an occupant side surface of the case 461 (a surface in the X direction of FIG. 80). The directivity adjustment portion 465 is a resinous plate member formed separately from the case 461.

By providing the directivity adjustment portion 465 on the occupant side surface, the vibration direction can be directed toward the occupant since the directivity adjustment portion 465 is vibrated in a predetermined direction toward the occupant (the direction of the arrow G of FIG. 84) when the eccentric motor 462 rotates.

The directivity adjustment portion 465 is preferably a separately formed plate member made of resin, but the directivity adjustment portion 465 may be a plate member made of metal.

Further, it is preferable that the directivity adjustment portion 465 is as large as the occupant side surface 461a of the case 461, but the directivity adjustment portion 465 may be smaller or larger than the occupant side surface 461a of the case 461. Since the directivity adjustment portion 465 is as large as the occupant side surface 461a of the case 461, a balance between the strength of the vibration and the ease of placement can be achieved.

The directivity adjustment portion 465 is fixed to the case 461 on the occupant side surface 461c of the case 461 by an adhesive means such as double-sided tape. The directivity adjustment portion 465 may be engaged and fixed to the case 461 by an engagement member such as a screw.

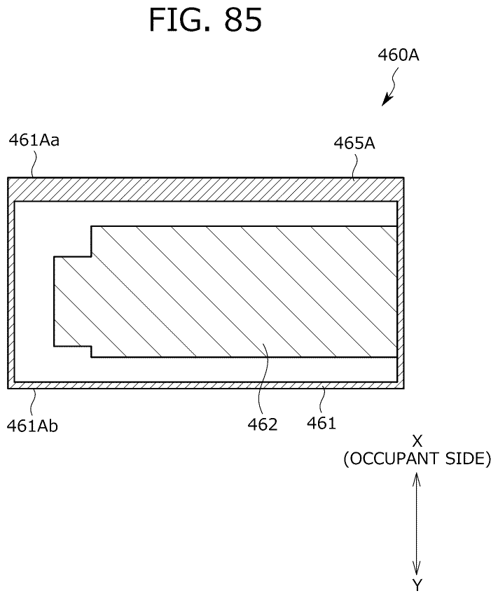

FIG. 85 shows another example (vibrator 460A) of the vibrator 460 with the directivity adjustment portion 465. The directivity adjustment portion 465A of the vibrator 460A is realized by forming a wall portion 461Aa disposed on the occupant side surface of the case 461A to be thicker than the other wall portions 461Ab. That is, the directivity adjustment portion 465 is formed integrally with the case 461A.

By forming a part of the case 461 thick and integrally forming the part with the directivity adjustment portion 465A, the number of components can be decreased compared to the case in which the directivity adjustment portion 465 is formed separately.

As described above, the conveyance seat according to this embodiment has been described with reference to the drawings. Furthermore, in this embodiment, the present invention is applied to the conveyance seat installed in the vehicle, but the seat provided with the vibrator is not limited to the conveyance seat. The present invention can be applied to any ordinary chair or sofa as long as it has a seating surface.

### REFERENCE SIGNS LIST

### First Embodiment

S: conveyance seat
F: seat frame
P: pad member
R: movable range (predetermined range)
1: seat back
   1a: main body
   1b: bank portion
2: seat cushion
3: headrest
4: rail device
   4a: lower rail
   4b: upper rail
5: reclining mechanism
6: skin
10, 10A to 10E′: seat back frame
11: back side frame (side frame)
12: upper frame
13: lower frame
14: headrest holder
15, 15A to 15E′: pressure receiving member (for back)
   151: wire member
   152: plate-shaped member
   153: first side portion
   154: second side portion
   155B: wire assist member
   156B, 156D: wire connection member
   15a: upper end
   15b: opening
   15c: opening
16: connection frame
   16a: upper attachment portion
17: overlapping portion
18: welding portion
20, 20A to 20D′: seat cushion frame
21: cushion side frame (side frame)
22: front connection frame
23: rear connection frame
24: pan frame
25, 25A to 25C′: pressure receiving member (for cushion)
   251: wire member
   252: plate-shaped member
   25a: inclined portion
   25b: opening
   251C: S-spring
26: seat switch unit
28: wire connection member
29: wire reinforcement member
30: headrest frame
31: headrest pillar
32: headrest pad
33: actuator
34: actuator attachment portion
35: blower
36: duct
37, 37′: blower attachment portion
38: duct through hole
40, 40A: back pad (pad member)
   40a, 40Aa: seating surface
   40b, 40Ab: back surface
41: first horizontal suspension groove
42: first vertical suspension groove
43: pad through hole (through hole)
44: storage recess
45: slab
46: fixing tape
47: harness hole
48: protrusion
49: bead (connection portion)
50, 50′, 50A to 50C: cushion pad (pad member)
   50a: seating surface
   50b: bottom surface
51: second horizontal suspension groove
52: second vertical suspension groove
54, 54′, 54A to 54C: storage recess
55: slab
56: fixing tape
57, 57′: harness hole
58: protrusion
60: vibrator (back side)
61: vibrator (cushion side)
63: waterproof cover
64: lid
65: harness

### Second Embodiment

V20: vehicle
D20: display device
S20: vehicle seat (conveyance seat)
F201: seat cushion frame
F202: seat back frame
F203: headrest frame
P201: pad material
P202: pad material
P203: pad material
P20s: slab
T20: skin material
B20: rotation axis
201: seat cushion (seat body)
202: seat back (seat body)
203: headrest (seat body)
204: rail device (slide mechanism)
205: rotation device (rotation mechanism)
206: reclining device (reclining mechanism)
220: vibrator
221: seat cushion vibrator
221R: right vibrator
221L: left vibrator
222: seat back vibrator
222RU: upper right vibrator
222RD: lower right vibrator
222LU: upper left vibrator
222LD: lower left vibrator
230: control device
231: acquisition unit
232: situation recognition unit
233: vibration pattern determination unit
234: vibration control unit
240: external sensor
240RF: right front sensor
240RR: right rear sensor
240LF: left front sensor
240LR: left rear sensor
241: slide position sensor
242: rotation angle sensor
243: reclining angle sensor
244: speaker (audio output device)
244R: right speaker
244L: left speaker
2107: armrest
2108: ottoman
2122C: center vibrator
2123: headrest vibrator
2123U: upper vibrator
2123D: lower vibrator
2124: armrest vibrator (arm vibrator)
2124R: right vibrator
2124L: left vibrator
2125: ottoman vibrator (leg vibrator)
2125R: right vibrator
2125L: left vibrator
2130: control device
2133: vibration pattern determination unit
2145: biological information sensor
2146: audiovisual device

### Third Embodiment

S30: conveyance seat
F30: seat frame
P30: pad member
R30: movable range (predetermined range)
301, 301A to 301C: seat back
   301a: main body
   301b: bank portion
302, 302A to 302L: seat cushion
303: headrest
304: rail device
   304a: lower rail
   304b: upper rail
305: reclining mechanism
306: skin
310: seat back frame
311: back side frame (side frame)
312: upper frame
313: lower frame
314: headrest holder
315: pressure receiving member (for back)
   3151: wire member
   3152: plate-shaped member
   3153: first side portion
   3154: second side portion
   315a: upper end
   315b: opening
   315c: opening
316: connection frame
   316a: upper attachment portion
317: overlapping portion
318: welding portion
320: seat cushion frame
321: cushion side frame (side frame)
322: front connection frame
323: rear connection frame
324: pan frame
325: pressure receiving member (for cushion)
   3251: wire member
   3252: plate-shaped member
   325a: inclined portion
   325b: opening
326: seat switch unit
330: headrest frame
331: headrest pillar
332: headrest pad
333: actuator
334: actuator attachment portion
335: blower
336: duct
337: blower attachment portion
338: duct through hole
340: back pad (pad member)
   340a: seating surface
   340b: back surface
341: first horizontal suspension groove
342: first vertical suspension groove
343: pad through hole (through hole)
344: storage recess
345: slab
346: fixing tape
347: harness hole
350, 350′, 350A to 350C: cushion pad (pad member)
   350a: seating surface
   350b: bottom surface
351: second horizontal suspension groove
352: second vertical suspension groove
354, 354′: storage recess
355: slab
356: fixing tape
357, 357′: harness hole
360: vibrator (back side)
361: vibrator (cushion side)
3611, 3611J to 3611L: first vibrator
3612, 3612J to 3612L: second vibrator
365: harness
370: sensor device
371: sensor unit
372: connection portion
373: harness
374: harness hole
380: heater device
381: heater wire portion
382: base fabric
383: lid
390, 391, 392: air cell
3100: side airbag module
3101: cushion airbag module
3102: tear line
3104: bag bulge area
3110: lighting
3111: low-hardness pad material
3112: high-hardness pad material
3120: side support portion
3121: variable bank portion
3122: movable mechanism
3123: front-rear adjustment mechanism
3124: fixing portion
3125: storage recess

### Fourth Embodiment

S40, SA40: conveyance seat
Sh40: seat body
F40: seat frame
P40: pad
401: seat back
402: seat cushion
403: headrest
404: rail device
   404a: lower rail
   404b: upper rail
405: reclining mechanism
406: skin
410: seat back frame
411: back side frame
412: upper frame
413: lower frame
414: headrest holder
420: seat cushion frame
421: cushion side frame
422: rear connection frame
430: headrest frame
431: headrest pillar
432: headrest pad
440: back pad
   440a: seating surface
   441: main body
   442: bank portion
   443: vertical suspension groove
   444: horizontal suspension groove
   445: storage recess (recess)
   446: harness hole
   447: through hole
   448: bent portion
      448a: start point of bent portion
      448b: end point of bent portion
   449: island
450: cushion pad
   451: main body
   452: bank portion
   453: vertical suspension groove
   454: horizontal suspension groove
   455: storage recess
   456: harness hole
460, 460A: vibrator
461: case
   461a: occupant side surface
462: eccentric motor
463: harness
465: directivity adjustment portion
463: heater
471: heater wire
   471a: bent portion
472: base fabric
473: adhesive (fixing member)
480: surface fastener
   481: skin side fastener member
   482: pad side fastener member
490: suspension portion
491: relief portion
492: skin fixing point

1. A conveyance seat, comprising:
a frame which forms a framework;
a pressure receiving member that is provided in the frame and receives a load of an occupant; and
a pad member that covers the pressure receiving member,
wherein the pad member is provided with at least one vibrator that generates a vibration, and
wherein the vibrator is disposed at a position in which at least a part of the vibrator does not overlap with the pressure receiving member in a front view of the conveyance seat or in a top view of the conveyance seat.

2. The conveyance seat according to claim 1,
wherein the pressure receiving member is provided to be movable within a predetermined range of the frame, and
wherein the vibrator is disposed outside the predetermined range.

3. The conveyance seat according to claim 1,
wherein the pressure receiving member is provided with an opening, and
wherein the vibrator is disposed at a position that overlaps with the opening in a front view of the conveyance seat or in a top view of the conveyance seat.

4. The conveyance seat according to claim 1,
wherein the pad member is provided with a through hole that absorbs the deformation of the pad member, and
wherein the vibrator is disposed at a position that overlaps with the through hole in a seat width direction.

5. The conveyance seat according to claim 1,
wherein the pad member is provided with a horizontal suspension groove which extends in a seat width direction, and
wherein the vibrator is disposed below or in front of the horizontal suspension groove.

6. The conveyance seat according to claim 1,
wherein the pad member is provided with a vertical suspension groove which extends in an up to down direction of the seat or a front to rear direction of the seat, and
wherein the vibrator is disposed inside the vertical suspension groove in a seat width direction.

7. The conveyance seat according to claim 1,
wherein the pad member is provided with a storage recess which is formed in a seating surface to store the vibrator and a protrusion which is formed at a position corresponding to the storage recess in a surface on the opposite side to the seating surface.

8. The conveyance seat according to claim 7,
wherein the pad member is provided with a plurality of the vibrators, and
wherein the pad member is provided with a connection portion which connects the protrusion formed for each of the plurality of vibrators.

9. The conveyance seat according to claim 1, further comprising:
a blower which blows air toward the occupant,
wherein the vibrator is disposed at a position that avoids an opening of the blower, a duct of the blower, or an attachment member of the blower.

10. The conveyance seat according to claim 1,
wherein the conveyance seat includes a seat back that supports a back of the occupant, a seat cushion that supports buttocks of the occupant, a headrest that supports a head of the occupant, and a skin that covers the pad member, and
wherein the frame includes a seat back frame which forms a framework of the seat back and a seat cushion frame which forms a framework of the seat cushion.
